(19) United States
(12) Patent Application Publication
(10) Pub. No.: US 2012/0062858 A1
(43) Pub. Date: Mar. 15, 2012

(54) CLEANING METHOD, DEVICE MANUFACTURING METHOD, EXPOSURE APPARATUS, AND DEVICE MANUFACTURING SYSTEM

(75) Inventors: Ryo TANAKA, Saitama-city (JP); Suguru KANAI, Kumagaya-city (JP); Kenichi SHIRAISHI, Saitama-city (JP); Shunji WATANABE, Tokyo (JP); Takashi SHIBUYA, Fujisawa-shi (JP)

(73) Assignee: NIKON CORPORATION, TOKYO (JP)

(21) Appl. No.: 13/078,544

(22) Filed: Apr. 1, 2011

Related U.S. Application Data
(60) Provisional application No. 61/320,469, filed on Apr. 2, 2010.
(60) Provisional application No. 61/320,451, filed on Apr. 2, 2010.

(51) Int. Cl. G03B 27/52

(52) U.S. Cl. 355/30; 355/77

(57) ABSTRACT

A cleaning method comprises: cleaning the liquid contact member by supplying a first liquid for cleaning to the liquid contact member; recovering the first liquid supplied to the liquid contact member; supplying a second liquid different from the first liquid to the liquid contact member after the liquid contact member is cleaned with the first liquid; recovering the second liquid supplied to the liquid contact member; and performing a process in which a concentration of the first liquid comprised in the recovered second liquid is set to a predetermined concentration or less.

### CROSS-REFERENCE TO RELATED APPLICATION

This application is a non-provisional application claiming priority to and the benefit of U.S. provisional application Nos. 61/320,451, and 61/320,469, filed on Apr. 2, 2010, and U.S. Patent Application filed on Apr. 1, 2011. The entire contents of which are incorporated herein by reference.

### BACKGROUND

1. Field of the Invention

The present invention relates to a cleaning method, a device manufacturing method, an exposure apparatus, and a device manufacturing system.

2. Description of Related Art

In a process of manufacturing micro devices such as semiconductor devices and electronic devices, liquid immersion exposure apparatuses that expose a substrate with exposure light through exposure liquid are used. In liquid immersion exposure apparatuses, there is a possibility that a liquid contact member which is in contact with exposure liquid may be contaminated. For this reason, for example, as disclosed in U.S. Patent Application Publication No. 2008/0273181 and U.S. Patent Application Publication No. 2009/0195761, techniques for cleaning a liquid contact member using cleaning liquid have been contrived.

### SUMMARY

For example, when time is required for processing of liquid (waste liquid) used in cleaning, or when the processing is complicated, there is a possibility that the operation rate of a device manufacturing system including an exposure apparatus may decrease, or the processing costs may increase. For this reason, a technique capable of smoothly performing the process is required to be contrived.

An object of the aspect of the present invention is to provide a cleaning method, a device manufacturing method, an exposure apparatus, and a device manufacturing system which are capable of satisfactorily cleaning a liquid contact member and smoothly performing a process of liquid used in cleaning.

According to a first aspect of the invention, there is provided a cleaning method of a liquid contact member, which is in contact with an exposure liquid, in an exposure apparatus that exposes a substrate with an exposure light through the exposure liquid, the cleaning method comprising: cleaning the liquid contact member by supplying a first liquid for cleaning to the liquid contact member; recovering the first liquid supplied to the liquid contact member; supplying a second liquid different from the first liquid to the liquid contact member after the liquid contact member is cleaned with the first liquid; recovering the second liquid supplied to the liquid contact member; and performing a process in which a concentration of the first liquid comprised in the recovered second liquid is set to a predetermined concentration or less.

According to a second aspect of the invention, there is provided a cleaning method of a liquid contact member, which is in contact with an exposure liquid, in an exposure apparatus that exposes a substrate with an exposure light through the exposure liquid, the cleaning method comprising: cleaning the liquid contact member by supplying a first liquid for cleaning to the liquid contact member; supplying and recovering a second liquid different from the first liquid to and from the liquid contact member after the liquid contact member is cleaned with the first liquid; and discharging the second liquid from a first discharge port during the recovery of the second liquid, and discharging the second liquid from a second discharge port different from the first discharge port subsequently to the discharge from the first discharge port.

According to a third aspect of the invention, there is provided a cleaning method of a liquid contact member, which is in contact with an exposure liquid, in an exposure apparatus that exposes a substrate with an exposure light through the exposure liquid, the cleaning method comprising: cleaning the liquid contact member by supplying a first liquid for cleaning to the liquid contact member; supplying and recovering a second liquid different from the first liquid to and from the liquid contact member after the liquid contact member is cleaned with the first liquid; performing a first process on the second liquid recovered in a first period of time of the operation of recovering the second liquid; and performing a second process different from the first process on the second liquid recovered in a second period of time of the operation of recovering the second liquid after the first period of time.

According to a fourth aspect of the invention, there is provided a cleaning method of a liquid contact member, which is in contact with an exposure liquid, in an exposure apparatus that exposes a substrate with an exposure light through the exposure liquid, the cleaning method comprising: cleaning the liquid contact member by supplying a first liquid for cleaning to the liquid contact member; recovering the first cleaning liquid supplied to the liquid contact member and discharges it from a first discharge port; cleaning the liquid contact member by supplying a second cleaning liquid different from the first cleaning liquid to the liquid contact member, after the liquid contact member is cleaned with the first cleaning liquid; recovering the second cleaning liquid supplied to the liquid contact member and discharge it from a second discharge port; and supplying a rinse liquid different from the first and second cleaning liquids to the liquid contact member and recovering the supplied rinse liquid, after the supply of the first cleaning liquid is stopped and before the supply of the second cleaning liquid is started, so that the discharge of the first cleaning liquid from the second discharge port is suppressed.

According to a fifth aspect of the invention, there is provided a device manufacturing method comprising: cleaning the liquid contact member using the cleaning method according to any one of the first to fourth aspects; exposing a substrate through the exposure liquid; and developing the exposed substrate.

According to a sixth aspect of the invention, there is provided an exposure apparatus that exposes a substrate with an exposure light through an exposure liquid, comprising: a liquid contact member which is in contact with the exposure liquid; a first supply port that supplies a first liquid for cleaning to the liquid contact member; a first recovery port that recovers the first liquid supplied to the liquid contact member; a second supply port that supplies a second liquid different from the first liquid to the liquid contact member, after the supply of the first liquid; and a second recovery port that recovers the second liquid supplied to the liquid contact member, wherein a process is performed in which the concentration of the first liquid comprised in the second liquid recovered from the second recovery port is set to a predetermined concentration or less.

According to a seventh aspect of the invention, there is provided an exposure apparatus that exposes a substrate with an exposure light through an exposure liquid, comprising: a liquid contact member which is in contact with the exposure liquid; a first supply port that supplies a first liquid for cleaning to the liquid contact member; a second supply port that supplies a second liquid different from the first liquid to the liquid contact member, after the supply of the first liquid; and a recovery port that recovers the second liquid during the supply of the second liquid from the second supply port, wherein the second liquid is discharged from a first discharge port during the recovery of the second liquid, and the second liquid is discharged from a second discharge port different from the first discharge port subsequently to the discharge from the first discharge port.

According to an eighth aspect of the invention, there is provided an exposure apparatus that exposes a substrate with an exposure light through an exposure liquid, comprising: a liquid contact member which is in contact with the exposure liquid; a first supply port that supplies a first liquid for cleaning to the liquid contact member; a second supply port that supplies a second liquid different from the first liquid to the liquid contact member after the supply of the first liquid; and a recovery port that recovers the second liquid with the supply of the second liquid from the second supply port, wherein a first process is performed on the second liquid recovered in a first period of time of the operation of recovering the second liquid, and a second process different from the first process is performed on the second liquid recovered in a second period of time of the operation of recovering the second liquid after the first period of time.

According to a ninth aspect of the invention, there is provided an exposure apparatus that exposes a substrate with an exposure light through an exposure liquid, comprising: a liquid contact member which is in contact with the exposure liquid; a first supply port that supplies a first cleaning liquid to the liquid contact member; a first recovery port that recovers the first cleaning liquid supplied to the liquid contact member; a second supply port that supplies a second cleaning liquid different from the first cleaning liquid to the liquid contact member, after the supply of the first cleaning liquid; a second recovery port that recovers the second cleaning liquid supplied to the liquid contact member; a third supply port that supplies a rinse liquid different from the first and second cleaning liquids to the liquid contact member, after the supply of the first cleaning liquid is stopped and before the supply of the second cleaning liquid is started, so that the discharge of the first cleaning liquid from a discharge port from which the second cleaning liquid recovered from the second recovery port is discharged is suppressed; and a third recovery port that recovers the rinse liquid supplied to the liquid contact member.

According to a tenth aspect of the invention, there is provided a device manufacturing method comprising: exposing a substrate using the exposure apparatus according to any one of the sixth to ninth aspects; and developing the exposed substrate.

According to an eleventh aspect of the invention, there is provided a device manufacturing system including an exposure apparatus that exposes a substrate with an exposure light through an exposure liquid, comprising: a first supply port that supplies a first liquid for cleaning to a liquid contact member within the exposure apparatus which is in contact with the exposure liquid; a first recovery port that recovers the first liquid supplied to the liquid contact member; a second supply port that supplies a second liquid different from the first liquid to the liquid contact member, after the supply of the first liquid; a second recovery port that recovers the second liquid supplied to the liquid contact member; and a processing apparatus that performs a process in which the concentration of the first liquid comprised in the second liquid recovered from the second recovery port is set to a predetermined concentration or less.

According to a twelfth aspect of the invention, there is provided a device manufacturing system including an exposure apparatus that exposes a substrate with an exposure light through an exposure liquid, comprising: a first supply port that supplies a first liquid for cleaning to a liquid contact member within the exposure apparatus which is in contact with the exposure liquid; a second supply port that supplies a second liquid different from the first liquid to the liquid contact member, after the supply of the first liquid; a recovery port that recovers the second liquid during the supply of the second liquid from the second supply port; a first discharge port which is capable of discharging the second liquid recovered from the recovery port; and a second discharge port, different from the first discharge port, which is capable of discharging the second liquid recovered from the recovery port, wherein the second liquid is discharged from the first discharge port during the recovery of the second liquid, and the second liquid is discharged from a second discharge port subsequently to the discharge from the first discharge port.

According to a thirteenth aspect of the invention, there is provided a device manufacturing system including an exposure apparatus that exposes a substrate with an exposure light through an exposure liquid, comprising: a first supply port that supplies a first liquid for cleaning to a liquid contact member within the exposure apparatus which is in contact with the exposure liquid; a second supply port that supplies a second liquid different from the first liquid to the liquid contact member, after the supply of the first liquid; a recovery port that recovers the second liquid during the supply of the second liquid from the second supply port; a first processing apparatus that performs a first process on the second liquid recovered in a first period of time of the operation of recovering the second liquid; and a second processing apparatus that performs a second process different from the first process on the second liquid recovered in a second period of time of the operation of recovering the second liquid after the first period of time.

According to a fourteenth aspect of the invention, there is provided a device manufacturing system including an exposure apparatus that exposes a substrate with an exposure light through an exposure liquid, comprising: a first supply port that supplies a first cleaning liquid to a liquid contact member within the exposure apparatus which is in contact with the exposure liquid; a first recovery port that recovers the first cleaning liquid supplied to the liquid contact member; a second supply port that supplies a second cleaning liquid different from the first cleaning liquid to the liquid contact member, after the supply of the first cleaning liquid; a second recovery port that recovers the second cleaning liquid supplied to the liquid contact member; a third supply port that supplies a rinse liquid different from the first and second cleaning liquids to the liquid contact member, after the supply of the first cleaning liquid is stopped and before the supply of the second cleaning liquid is started, so that the discharge of the first cleaning liquid from a discharge port from which the second cleaning liquid recovered from the second recovery port is discharged is suppressed; and a third recovery port that recovers the rinse liquid supplied to the liquid contact member.

According to a fifteenth aspect of the invention, there is provided a cleaning method of a liquid contact member, which is in contact with an exposure liquid, in an exposure apparatus that exposes a substrate with an exposure light through the exposure liquid, the cleaning method comprising: cleaning the liquid contact member by supplying a first liquid for cleaning to the liquid contact member; recovering the first liquid supplied to the liquid contact member; supplying a second liquid different from the first liquid to the liquid contact member after the liquid contact member is cleaned with the first liquid; recovering the second liquid supplied to the liquid contact member; and receiving the recovered second liquid in a first receiving member until the concentration of the first liquid becomes a predetermined concentration or less.

According to a sixteenth aspect of the invention, there is provided a device manufacturing method comprising: cleaning the liquid contact member using the cleaning method according to the first aspect; exposing a substrate through the exposure liquid; and developing the exposed substrate.

According to a seventeenth aspect of the invention, there is provided an exposure apparatus that exposes a substrate with an exposure light through an exposure liquid, comprising: a liquid contact member which is in contact with the exposure liquid; a first supply port that supplies a first liquid for cleaning to the liquid contact member; a first recovery port that recovers the first liquid supplied to the liquid contact member; a second supply port that supplies a second liquid different from the first liquid to the liquid contact member, after the supply of the first liquid; and

a second recovery port that recovers the second liquid supplied to the liquid contact member, wherein the second liquid recovered from the second recovery port is received in a first receiving member until the concentration of the first liquid becomes a predetermined concentration or less.

According to an eighteenth aspect of the invention, there is provided a device manufacturing method comprising: exposing a substrate using the exposure apparatus according to the third aspect; and developing the exposed substrate.

According to a nineteenth aspect of the invention, there is provided a device manufacturing system including an exposure apparatus that exposes a substrate with an exposure light through an exposure liquid, comprising: a first supply port that supplies a first liquid for cleaning to a liquid contact member within the exposure apparatus which is in contact with the exposure liquid; a first recovery port that recovers the first liquid supplied to the liquid contact member; a second supply port that supplies a second liquid different from the first liquid to the liquid contact member, after the supply of the first liquid; a second recovery port that recovers the second liquid supplied to the liquid contact member; a first receiving member that receives the second liquid recovered from the second recovery port; and a control apparatus that receives the second liquid in the first receiving member until the concentration of the first liquid comprised in the second liquid in the first receiving member becomes a predetermined concentration or less.

According to the aspects of the invention, it is possible to satisfactorily clean a liquid contact member, and to smoothly perform a process of liquid used in cleaning.

### BRIEF DESCRIPTION OF THE DRAWINGS

FIG. 1 is a diagram illustrating an example of a device manufacturing system according to a first embodiment.

FIG. 2 is a schematic configuration diagram illustrating an example of an exposure apparatus according to the first embodiment.

FIG. 3 is a diagram illustrating an example of a liquid immersion member according to the first embodiment.

FIG. 4 is a diagram illustrating an example of the liquid immersion member according to the first embodiment.

FIG. 5 is a diagram illustrating an example of the liquid immersion member according to the first embodiment.

FIG. 6 is a diagram illustrating an example of the liquid immersion member according to the first embodiment.

FIG. 7 is a diagram illustrating an example of a liquid system according to the first embodiment.

FIG. 8 is a diagram illustrating an example of an exposure process according to the first embodiment.

FIG. 9 is a diagram illustrating an example of a cleaning method according to the first embodiment.

FIG. 10 is a diagram illustrating an example of the cleaning method according to the first embodiment.

FIG. 11 is a diagram illustrating an example of the cleaning method according to the first embodiment.

FIG. 12 is a diagram illustrating an example of the cleaning method according to the first embodiment.

FIG. 13 is a diagram illustrating an example of the cleaning method according to the first embodiment.

FIG. 14 is a flow diagram illustrating an example of the cleaning method according to the first embodiment.

FIG. 15 is a diagram illustrating an example of the cleaning method according to the first embodiment.

FIG. 16 is a schematic diagram illustrating an example of the cleaning method according to a second embodiment.

FIG. 17 is a schematic diagram illustrating an example of the cleaning method according to a second embodiment.

FIG. 18 is a diagram illustrating an example of a cleaning apparatus according to a third embodiment.

FIG. 19 is a diagram illustrating an example of a cleaning apparatus according to a third embodiment.

FIG. 20 is a diagram illustrating an example of the liquid system according to the third embodiment.

FIG. 21 is a diagram illustrating an example of the cleaning method according to the third embodiment.

FIG. 22 is a diagram illustrating an example of the cleaning method according to the third embodiment.

FIG. 23 is a diagram illustrating an example of the cleaning method according to the third embodiment.

FIG. 24 is a diagram illustrating an example of the cleaning method according to the third embodiment.

FIG. 25 is a diagram illustrating an example of the cleaning method according to the third embodiment.

FIG. 26 is a diagram illustrating an example of the cleaning method according to the third embodiment.

FIG. 27 is a diagram illustrating an example of the cleaning method according to the third embodiment.

FIG. 28 is a flow diagram illustrating an example of the cleaning method according to the third embodiment.

FIG. 29 is a diagram illustrating an example of the cleaning method according to the third embodiment.

FIG. 30 is a diagram illustrating an example of the cleaning method according to the third embodiment.

FIG. 31 is a diagram illustrating an example of the cleaning method according to the third embodiment.

FIG. 32 is a flow diagram illustrating an example of a device manufacturing method.

### DESCRIPTION OF EMBODIMENTS

Hereinafter, embodiments of the present invention will be described with reference to the drawings, but the present invention is not limited thereto. In the following description, an XYZ orthogonal coordinate system is set, and a positional relationship of each part will be described with reference to the XYZ orthogonal coordinate system. A predetermined direction within the horizontal plane is set to an X axial direction, a direction orthogonal to the X axial direction within the horizontal plane is set to a Y axial direction, and a direction (that is, vertical direction) orthogonal to the X axial direction and the Y axial direction, respectively, is set to a Z axial direction. In addition, rotational (tilting) directions around the X-axis, the Y-axis, and the Z-axis are set to a θX direction, a θY direction, and a θZ direction, respectively.

### First Embodiment

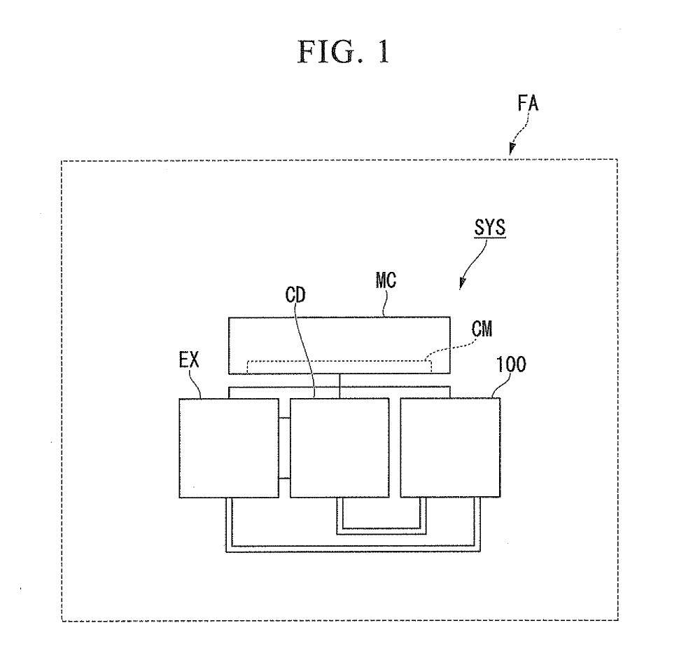

A first embodiment will be described. FIG. 1 is a schematic diagram illustrating an example of a device manufacturing system SYS according to a first embodiment. The device manufacturing system SYS includes a plurality of apparatuses. In the present embodiment, the device manufacturing system SYS includes an exposure apparatus EX that exposes a photosensitive substrate P with exposure light EL, a coater/developer apparatus CD including a film formation apparatus that forms a photosensitive film on the base material of the substrate P and a development apparatus that develops the substrate P after exposure, a liquid system 100 capable of supplying liquid used for manufacturing a device, a main controller MC that controls a plurality of these apparatuses, and a communication system CM capable of performing communication between a plurality of apparatuses. The communication system CM can perform communication of various types of information relating to the manufacture of a device. Furthermore, the device manufacturing system SYS may include an etching apparatus, a CMP apparatus and the like. The device manufacturing system SYS is installed in a factory FA. In addition, the device manufacturing system SYS may include a plurality of exposure apparatuses EX.

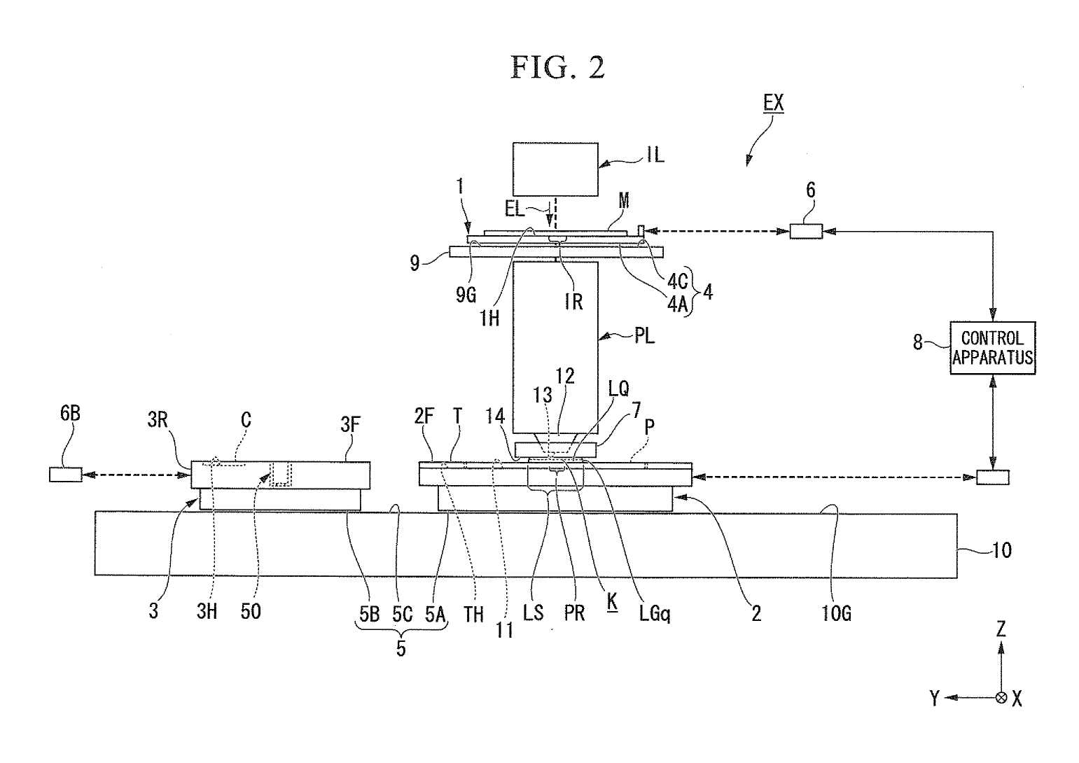

FIG. 2 is a schematic configuration diagram illustrating an example of the exposure apparatus EX according to the present embodiment. The exposure apparatus EX of the present embodiment is a liquid immersion exposure apparatus that exposes the substrate P with the exposure light EL through exposure liquid LQ. In the present embodiment, in at least a portion of the light path of the exposure light EL, a liquid immersion space LS is formed so as to be filled with the exposure liquid LQ. The liquid immersion space is a portion (a space or a region) which is filled with liquid. The substrate P is exposed with the exposure light EL through the exposure liquid LQ of the liquid immersion space LS. In the present embodiment, water (pure water) is used as the exposure liquid LQ.

In addition, the exposure apparatus EX of the present embodiment is, for example, an exposure apparatus including a substrate stage and a measurement stage as disclosed in the Specification of U.S. Pat. No. 6,897,963, the Specification of EP Patent Application Publication No. 1,713,113 and the like.

In FIG. 2, the exposure apparatus EX includes a movable mask stage 1 that holds a mask M, a movable substrate stage 2 that holds the substrate P, a movable measurement stage 3 that mounts a measurement member C (measuring instrument) measuring the exposure light EL without holding the substrate P, an illumination system IL that illuminates the mask M with the exposure light EL, a projection optical system PL that projects an image of a pattern of the mask M, illuminated with the exposure light EL, onto the substrate P, a liquid immersion member 7 that can form the liquid immersion space LS so that the light path K of the exposure light EL emitted from the projection optical system PL is filled with the exposure liquid LQ, and a control apparatus 8 that controls the operation of the entire exposure apparatus EX.

The mask M includes a reticle on which a device pattern projected onto the substrate P is formed. The mask M includes a transmissive mask having, for example, a transparent plate such as a glass plate, and a pattern formed on the transparent plate using a light-shielding material such as chrome. Furthermore, a reflective mask can be used as the mask M.

The substrate P is a substrate for manufacturing a device. The device pattern can be formed on the substrate P. The substrate P includes, for example, a base material such as a semiconductor wafer, and a photosensitive film formed on the base material. The photosensitive film is a film of a photosensitive material (photoresist). In addition, the substrate P may include another film in addition to the photosensitive film. For example, the substrate P may include an antireflection film, and may include a protective film (top-coat film) that protects the photosensitive film.

The illumination system IL irradiates a predetermined illumination region IR with the exposure light EL. The illumination region IR includes a position which can be irradiated with the exposure light EL emitted from the illumination system IL. In the present embodiment, ArF excimer laser light is used as the exposure light EL emitted from the illumination system IL. Furthermore, as the exposure light EL, for example, KrF excimer laser light may be used.

The mask stage 1 can move on a guide surface 9G of a base member 9. The mask stage 1 has a holding portion 1H that releasably holds the mask M. The mask stage 1 can move the mask M held in the holding portion 1H to the position which can be irradiated with the exposure light EL emitted from the illumination system IL.

The projection optical system PL irradiates a predetermined projection region PR with the exposure light EL. The projection optical system PL has an emission surface 13 for emitting the exposure light EL toward the image plane of the projection optical system PL. A last optical element 12 which is closest to the image plane of the projection optical system PL among a plurality of optical elements of the projection optical system PL has the emission surface 13. The projection region PR includes a position which can be irradiated with the exposure light EL emitted from the emission surface 13. The projection optical system PL projects an image of a pattern of the mask M, at a predetermined projection magnification, onto at least a portion of the substrate P disposed in the projection region PR. In the present embodiment, the exposure light EL emitted from the emission surface 13 travels in the −Z direction. In addition, in the present embodiment, the optical axis of the last optical element 12 is parallel to the Z-axis.

The substrate stage 2 and the measurement stage 3 can move on a guide surface 100 of a base member 10. The substrate stage 2 has a substrate holding portion 11 that releasably holds the substrate P. The substrate stage 2 can move the substrate P held in the substrate holding portion 11 to the position which can be irradiated with the exposure light EL emitted from the projection optical system PL. The measurement stage 3 has a holding portion 3H that releasably holds the measurement member C. The measurement stage 3 can move the measurement member C held in the holding portion 3H to the position which can be irradiated with the exposure light EL emitted from the projection optical system PL.

In the present embodiment, the substrate stage 2 is disposed at least at a portion of the periphery of the substrate holding portion 11 as disclosed in, for example, the Specification of U.S. Patent Application Publication No. 2007/0,177,125, the Specification of U.S. Patent Application Publication No. 2008/0,049,209 and the like, and has a holding portion TH that releasably holds a plate member T. The plate member T is disposed in the periphery of the substrate P held in the substrate holding portion 11.

In the present embodiment, the measurement member C mounted on the measurement stage 3 may be, for example, a member which constitutes a portion of a space image measurement system, as disclosed in the Specification of U.S. Patent Application Publication No. 2002/0,041,377 and the like, may be a member which constitutes a portion of an illuminance unevenness measurement system as disclosed in the Specification of U.S. Pat. No. 4,465,368 and the like, may be a reference member as disclosed in the Specification of U.S. Pat. No. 5,493,403 and the like, may be a member which constitutes a portion of an irradiance measurement system as disclosed in the Specification of U.S. Patent Application Publication No. 2002/0,061,469 and the like, and may be a member which constitutes a portion of a wavefront aberration measurement system as disclosed in the Specification of EP Patent No. 1,079,223 and the like.

The mask stage 1 can move by the operation of a drive system 4. The drive system 4 includes a planar motor having a slider 4A disposed in the mask stage 1 and a stator 4C disposed in the base member 9. The mask stage 1 can move on the guide surface 9G in the six directions of the X-axis, Y-axis, Z-axis, θX, θY, and θZ by the operation of the drive system 4. The substrate stage 2 and the measurement stage 3, respectively, can move by the operation of a drive system 5. The drive system 5 includes a planar motor having a slider 5A disposed in the substrate stage 2, a slider 5B disposed in the measurement stage 3, and a stator 5C disposed in the base member 10. The substrate stage 2 and the measurement stage 3, respectively, can move on the guide surface 100 in the six directions of the X-axis, Y-axis, Z-axis, θX, θY, and θZ by the operation of the drive system 5. Meanwhile, an example of the planar motor is disclosed in, for example, the Specification of U.S. Pat. No. 6,452,292.

The positions of the mask stage 1, the substrate stage 2, and the measurement stage 3 are measured by an interferometer system 6. When an exposure process of the substrate P is performed, or when a predetermined measurement process is performed, the control apparatus 8 brings the drive systems 4 and 5 into operation on the basis of the measurement result of the interferometer system 6, and controls the positions of the mask stage 1 (mask M), the substrate stage 2 (substrate P), and the measurement stage 3 (measurement member C).

In the present embodiment, an upper surface 2F of the substrate stage 2 and an upper surface 3F of the measurement stage 3, respectively, are liquid-repellent with respect to the exposure liquid LQ. In the present embodiment, the upper surface 2F includes an upper surface of the plate member T. Upper surfaces 2F and 3F are surfaces directed to the +Z direction, and can face the last optical element 12 and the liquid immersion member 7. In the present embodiment, the upper surfaces 2F and 3F are formed of a film of materials containing fluorine.

The liquid immersion member 7 can form the liquid immersion space LS so that the light path K of the exposure light EL emitted from the emission surface 13 is filled with the exposure liquid LQ. The liquid immersion member 7 is disposed in the vicinity of the last optical element 12. In the present embodiment, the liquid immersion member 7 is an annular member, and is provided around the last optical element 12.

The liquid immersion member 7 has a lower surface 14 capable of facing an object disposed in the position (projection region PR) which can be irradiated with the exposure light EL emitted from the last optical element 12. In the present embodiment, the object capable of being disposed in the projection region PR includes an object movable on the image plane side (the emission surface 13 side of the last optical element 12) of the projection optical system PL. In the present embodiment, the object includes at least one of the substrate stage 2, the substrate P held in the substrate stage 2, a dummy substrate DP described later, a measurement stage 3, and the measurement member C mounted on the measurement stage 3. For example, at the time of exposing the substrate P, at least a portion of the surface of the substrate P faces the emission surface 13 and the lower surface 14. The exposure liquid LQ can be held between the last optical element 12 and the liquid immersion member 7 and the object disposed in the projection region PR. At least a portion of the emission surface 13 and the lower surface 14 is in contact with the exposure liquid LQ. The exposure liquid LQ is held between the emission surface 13 and the lower surface 14 on one side and the surface (upper surface) of the object on the other side, whereby the liquid immersion space LS is formed so that the light path K of the exposure light EL between the last optical element 12 and the object is filled with the exposure liquid LQ.

In the present embodiment, when the substrate P is irradiated with the exposure light EL, the liquid immersion space LS is formed so that a region of a portion of the surface of the substrate P including the projection region PR is covered with the exposure liquid LQ. The liquid immersion member 7 holds the exposure liquid LQ within a local region smaller than the substrate P. At least a portion of an interface (a meniscus or an edge) LGq of the exposure liquid LQ is formed between the lower surface 14 of the liquid immersion member 7 and the surface of the substrate P. That is, in the exposure apparatus EX of the present embodiment, a local liquid immersion method is adopted.

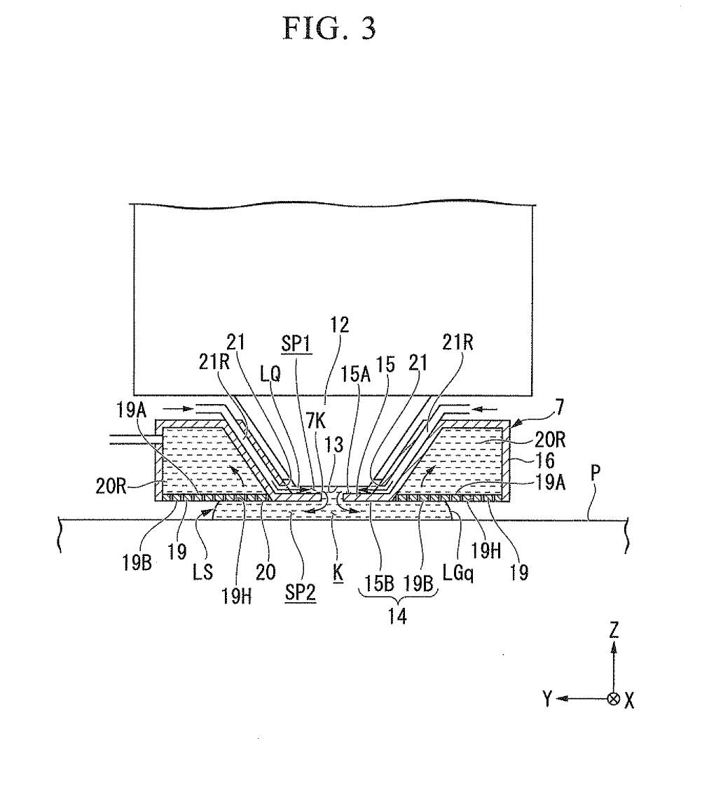

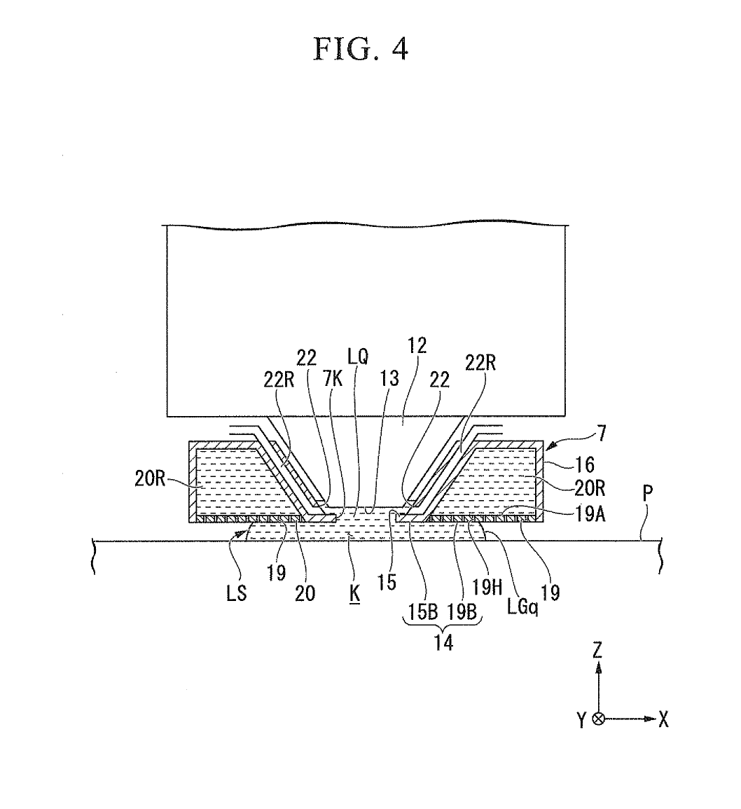

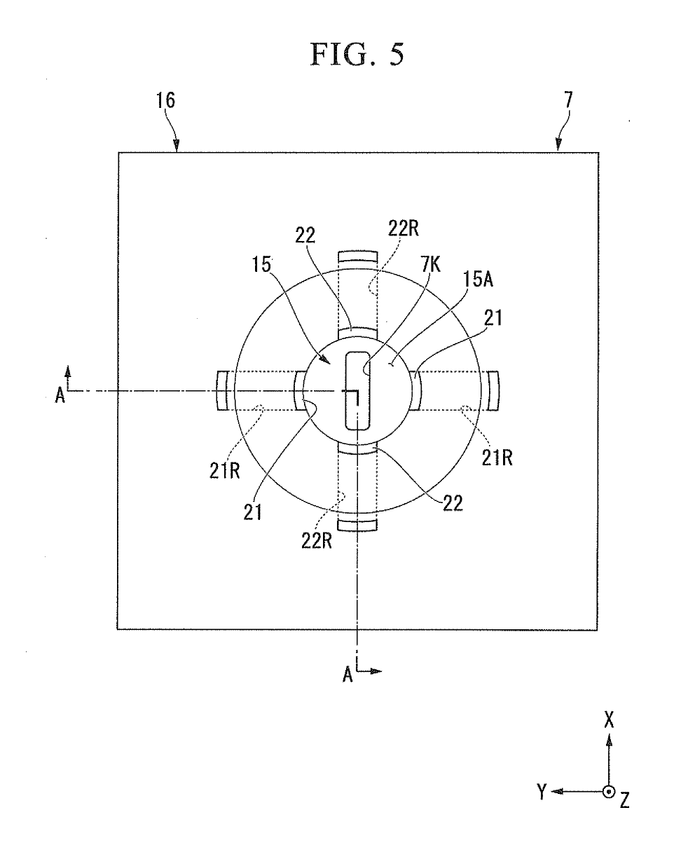

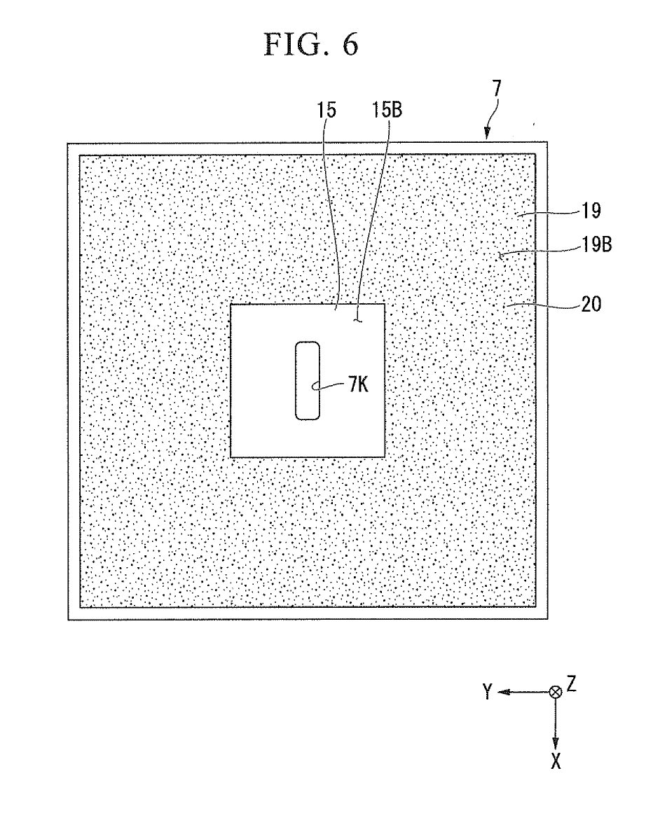

FIG. 3 is a cross-sectional view illustrating an example of the liquid immersion member 7 according to the present embodiment which is parallel to the YZ plane, and FIG. 4 is a cross-sectional view which is parallel to the XZ plane. FIG. 5 is a diagram which the liquid immersion member 7 according to the present embodiment is seen from the upper side (+Z side), and FIG. 6 is a diagram which is seen from the lower side (−Z side).

Furthermore, in FIGS. 3 and 4, although a case is shown in which the substrate P is disposed in a position facing the last optical element 12 and the liquid immersion member 7, as mentioned above, another object such as, for example, the substrate stage 2 and the measurement stage 3 may be disposed.

The liquid immersion member 7 has a plate portion 15 which is disposed in the periphery of the light path K of the exposure light EL emitted from the emission surface 13, and a main body portion 16 of which at least a portion is disposed in the periphery of the last optical element 12. The plate portion 15 has a lower surface 15B capable of facing the surface of the substrate P, and an upper surface 15A directed to the opposite direction of the lower surface 15B. At least a portion of the upper surface 15A faces the emission surface 13.

The liquid immersion member 7 has an opening (pathway) 7K through which the exposure light EL emitted from the emission surface 13 can pass. The opening 7K is formed in the plate portion 15. The opening 7K is formed so as to link the upper surface 15A and the lower surface 15B to each other. The lower surface 15B is disposed in the periphery of the lower end of the opening 7K. The upper surface 15A is disposed in the periphery of the upper end of the opening 7K. The substrate P can be irradiated with the exposure light EL emitted from the emission surface 13 through the opening 7K.

In addition, the liquid immersion member 7 includes a first supply port 21 capable of supplying the exposure liquid LQ and a recovery port 20 capable of recovering the exposure liquid LQ. At the time of exposing at least the substrate P, the first supply port 21 supplies the exposure liquid LQ, and the recovery port 20 recovers at least a portion of the exposure liquid LQ supplied from the first supply port 21. In the exposure of the substrate P, the exposure liquid LQ is supplied from the first supply port 21 in the state where the substrate P is disposed facing the liquid immersion member 7.

In addition, the liquid immersion member 7 has a second supply port 22 different from the first supply port 21. The second supply port 22 can supply liquid different from the exposure liquid LQ. As described later, in the present embodiment, the second supply port 22 can supply cleaning liquid LC for cleaning at least a portion of members within the exposure apparatus EX.

In addition, the liquid immersion member 7 includes a first interior channel 21R linked to the first supply port 21, a second interior channel 22R linked to the second supply port 22, and a third interior channel 20R linked to the recovery port 20. The first interior channel 21R, the second interior channel 22R, and the third interior channel 20R are respectively formed inside the liquid immersion member 7. The first supply port 21 is formed at one end of the first interior channel 21R. The second supply port 22 is formed at one end of the second interior channel 22R. The recovery port 20 is formed at one end of the third interior channel 20R.

In the present embodiment, the first supply port 21 is disposed in the vicinity of the light path K of the exposure light EL so as to face the light path K. In the present embodiment, a plurality of first supply ports 21 is disposed. In the present embodiment, two first supply ports 21 are disposed. In the present embodiment, the first supply ports 21 are disposed on the +Y side and the −Y side, respectively, with respect to the light path K. In the present embodiment, the first supply ports 21 supply the exposure liquid LQ to a space SP1 between the emission surface 13 and the upper surface 15A. The exposure liquid LQ supplied from the first supply ports 21 flows through the space SP1, and then flows through the opening 7K to a space SP2 between the lower surface 15B (lower surface 14) and the surface (upper surface of the object) of the substrate P.

The second supply port 22 is disposed in the vicinity of the light path K of the exposure light EL so as to face the light path K. In the present embodiment, a plurality of second supply ports 22 is disposed. In the present embodiment, two second supply ports 22 are disposed. In the present embodiment, the second supply ports 22 are disposed at the +X side and the −X side, respectively, with respect to the light path K. In the present embodiment, the second supply ports 22 can supply the cleaning liquid LC to the space SP1. The cleaning liquid LC supplied to the space SP1 flows through the opening 7K to the space SP2.

Furthermore, the number of first supply ports 21 can be arbitrarily set. In addition, the positions of the first supply ports 21 with respect to the light path K can be arbitrarily set. Similarly, the number of second supply ports 22, and the positions of the second supply ports 22 with respect to the light path K can be arbitrarily set. For example, at least one of the number of first supply ports 21 disposed and the number of second supply ports 22 disposed may be one or three or more. In addition, the first supply ports 21 may be disposed on at least one of the +X side and the −X side with respect to the light path K, and the second supply ports 22 may be disposed on at least one of the +Y side and the −Y side with respect to the light path K. In addition, the positions of the first supply ports 21 in the Z direction and the positions of the second supply ports 22 in the Z direction may be different from each other.

The recovery port 20 can recover at least a portion of the exposure liquid LQ on the substrate P (object). The recovery port 20 is disposed in a predetermined position of the liquid immersion member 7 capable of facing the surface of the substrate P. In the present embodiment, the recovery port 20 is disposed at least at a portion of the periphery of the lower surface 15B (opening 7K). In the present embodiment, the recovery port 20 is annular within the XY plane, and is disposed in the periphery of the lower surface 15B. Furthermore, a plurality of recovery ports 20 may be disposed at predetermined intervals so as to surround the lower surface 15B.

In the present embodiment, a porous member 19 is disposed in the recovery port 20. The porous member 19 has a plurality of holes (openings or pores). In the present embodiment, the porous member 19 is a plate-shaped member. In the present embodiment, the porous member 19 has a lower surface 19B capable of facing the surface of the substrate P and an upper surface 19A directed to the opposite direction of the lower surface 19B. Holes 19H of the porous member 19 are formed so as to link the upper surface 19A and the lower surface 19B. In the present embodiment, the lower surface 19B of the porous member 19 is disposed in the periphery of the lower surface 15B of the plate portion 15.

In the present embodiment, the lower surface 14 of the liquid immersion member 7 capable of facing the surface (upper surface of the object) of the substrate P includes the lower surface 15B of the plate portion 15 and the lower surface 19B of the porous member 19.

Furthermore, a mesh filter which is a porous member in which numerous small holes are formed in a mesh shape may be disposed in the recovery port 20. In addition, the porous member 19 may not be disposed in the recovery port 20.

In the present embodiment, the exposure liquid LQ (exposure liquid LQ on the object) of the space SP2 is recovered through the holes 19H of the porous member 19. When the exposure liquid LQ on the substrate P is recovered in the exposure of the substrate P, the control apparatus 8 performs adjustment so that the pressure of the space SP2 which the lower surface 19B faces and the pressure of the space (third interior channel 20R) which the upper surface 19A faces are different from each other (generation of the differential pressure). Thereby, the exposure liquid LQ on the substrate P is recovered through the holes 19H of the porous member 19.

In the present embodiment, the control apparatus 8 performs the operation of recovering the exposure liquid LQ from the recovery port 20 concurrently with the operation of supplying the exposure liquid LQ from the first supply port 21 in the exposure of the substrate P, whereby the liquid immersion space LS is formed by the exposure liquid LQ between the last optical element 12 and the liquid immersion member 7 on one side and the substrate P (object) on the other side.

At least a portion of the liquid immersion member 7 is formed of a material containing a metal. In the present embodiment, at least a portion of the liquid immersion member 7 is formed of a material containing titanium. The material containing titanium contains at least one of titanium and a titanium alloy. In the present embodiment, the plate portion 15 and the main body portion 16 is formed of a material containing titanium. In addition, in the present embodiment, the porous member 19 is also formed of a material containing titanium. Furthermore, at least a portion of the liquid immersion member 7 may contain materials such as, for example, stainless steel and magnesium which are different from titanium. In addition, at least a portion of the liquid immersion member 7 may be formed of a material containing ceramic.

Furthermore, at least a portion of the surface of the liquid immersion member 7 may be formed of amorphous carbon. The amorphous carbon contains tetrahedral amorphous carbon. For example, when at least a portion of the upper surface 15A and the lower surface 15B of the plate portion 15 is formed of the amorphous carbon, the plate portion 15 (base material) formed of a material containing titanium is formed, and an amorphous carbon film is formed so that at least a portion of the surface of the base material is covered with the amorphous carbon film. Thereby, at least a portion of the upper surface 15A and the lower surface 15B is formed of the amorphous carbon. In addition, at least a portion of the upper surface 19A and the lower surface 19B of the porous member 19, and the inner surface of the hole 19H may be formed of the amorphous carbon. An amorphous carbon film can be formed on the base material using a CVD method or a PVD method.

In addition, at least a portion of the surface of the liquid immersion member 7 may be formed of an oxide film. The oxide film may be titanium oxide. At least a portion of the upper surface 19A and the lower surface 19B of the porous member 19, and the inner surface of the holes 19H may be formed of the oxide film.

Furthermore, a liquid immersion member (nozzle member) as disclosed in, for example, the Specification of U.S. Patent Application Publication No, 2007/0,132,976 and the Specification of EP Patent Application Publication No. 1,768,170 can be used as the liquid immersion member 7.

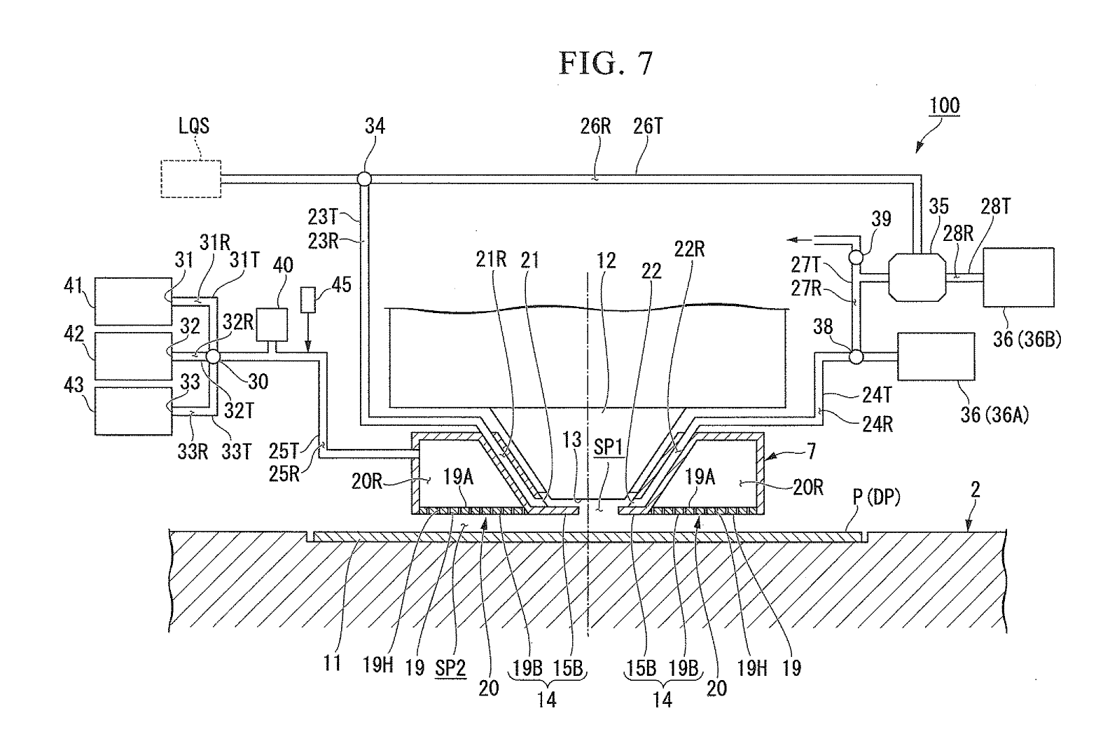

FIG. 7 is a diagram illustrating an example of the liquid system 100 according to the present embodiment. Furthermore, in FIGS. 7 to 13 referred to in the following description, for the purpose of simple description, a portion of the liquid immersion member 7 is shown as a cross-sectional view which is parallel to the YZ plane, and a portion thereof is shown as a cross-sectional view which is parallel to the XZ plane. Specifically, in FIGS. 7 to 13, the left side of the dashed line is a cross-sectional view which is parallel to the YZ plane, and the right side of the dashed line is a cross-sectional view which is parallel to the XZ plane. That is, the liquid immersion member 7 shown in FIGS. 7 to 13 is equivalent to a cross-sectional view taken along the A-A line of FIG. 5. In FIGS. 7 to 13, the first supply port 21 is shown at the left side of the dashed line, and the second supply port 22 is shown at the right side of the dashed line.

In the present embodiment, at least one of the first supply port 21, the second supply port 22, and the recovery port 20 is connected to the liquid system 100. In the present embodiment, the liquid system 100 can supply the exposure liquid LQ. The first supply port 21 can supply the exposure liquid LQ from the liquid system 100 to the space SP1. In addition, the liquid system 100 can supply the cleaning liquid LC. The second supply port 22 can supply the cleaning liquid LC from the liquid system 100 to the space SP1.

In addition, the liquid system 100 can recover the exposure liquid LQ recovered from the recovery port 20. For example, the exposure liquid LQ recovered from the recovery port 20 in the exposure of the substrate P is sent to the liquid system 100. In addition, in the present embodiment, the recovery port 20 can recover the cleaning liquid LC. The cleaning liquid LC recovered from the recovery port 20 is sent to the liquid system 100.

In the present embodiment, the liquid system 100 can supply the exposure liquid LQ to the first interior channel 21R of the liquid immersion member 7. The exposure liquid LQ supplied to the first interior channel 21R is sent to the first supply port 21 through the first interior channel 21R. The first supply port 21 supplies the exposure liquid LQ from the first interior channel 21R to the space SP1.

In addition, the liquid system 100 can supply the cleaning liquid LC to the second interior channel 22R of the liquid immersion member 7. The cleaning liquid LC supplied to the second interior channel 22R is sent to the second supply port 22 through the second interior channel 22R. The second supply port 22 supplies the cleaning liquid LC from the second interior channel 22R to the space SP1. In addition, the liquid (at least one of the exposure liquid LQ and the cleaning liquid LC) recovered from the recovery port 20 flows into the third interior channel 20R of the liquid immersion member 7. The liquid system 100 recovers the liquid recovered from the recovery port 20 through the third interior channel 20R.

Meanwhile, as described with reference to FIG. 1, in the present embodiment, the device manufacturing system SYS includes the liquid system 100. In addition, in the present embodiment, the liquid system 100 is an external apparatus (apparatus different from the exposure apparatus EX) for the exposure apparatus EX. Furthermore, at least a portion of the liquid system 100 may be an external apparatus for the device manufacturing system SYS. In addition, at least a portion of the liquid system 100 may be equipment of the factory FA, and the entirety of the liquid system 100 may be equipment of the factory FA. In addition, the exposure apparatus EX may include a portion of the liquid system 100, and may include the entirety of the liquid system 100. Furthermore, as mentioned above, when the device manufacturing system SYS includes a plurality of exposure apparatuses EX, the liquid system 100 may supply the liquid to a plurality of exposure apparatuses EX, and may recover the liquid from a plurality of exposure apparatuses EX.

In the present embodiment, the liquid system 100 includes a first channel forming member 23T having a first channel 23R through which the exposure liquid LQ supplied to the first supply port 21 flows, a second channel forming member 24T having a second channel 24R through the cleaning liquid LC supplied to the second supply port 22 flows, and a third channel forming member 25T having a third channel 25R through which the liquid (at least one of the exposure liquid LQ and the cleaning liquid LC) recovered from the recovery port 20 flows. In the present embodiment, each of the first, second, and third channel forming members 23T, 24T, and 25T is a pipe member.

In the present embodiment, one end of the first channel 23R is connected to the first interior channel 21R. One end of the second channel 24R is connected to the second interior channel 22R. One end of the third channel 25R is connected to the third interior channel 20R. The exposure liquid LQ flowing through the first channel 23R is sent to the first supply port 21 through the first interior channel 21R. The cleaning liquid LC flowing through the second channel 24R is sent through the second interior channel 22R to the second supply port 22. The liquid which is recovered from the recovery port 20 and flows through the third interior channel 20R is sent to the third channel 25R.

In the present embodiment, the liquid system 100 includes a first discharge port 31 that discharges the liquid recovered from the recovery port 20, a second discharge port 32 different from the first discharge port 31, and a third discharge port 33 different from the first and second discharge ports 31 and 32. In the present embodiment, the liquid which is recovered from the recovery port 20 and is sent through the third interior channel 20R to the third channel 25R flows through the third channel 25R, and then is sent to at least one of the first discharge port 31, the second discharge port 32, and the third discharge port 33.

Furthermore, in the present embodiment, although the liquid system 100 has the first discharge port 31, the second discharge port 32, and the third discharge port 33, the exposure apparatus EX may have at least one of the first discharge port 31, the second discharge port 32, and the third discharge port 33. In other words, at least one of the first discharge port 31, the second discharge port 32, and the third discharge port 33 may be a component of the exposure apparatus EX, and may be a component of an external apparatus for the exposure apparatus EX.

In the present embodiment, one end of the third channel 25R is connected to the third interior channel 20R, and the other end thereof is connected to a channel switching mechanism 30 including a valve mechanism. In addition, the liquid system 100 includes channel forming members 31T, 32T, and 33T which are connected to the channel switching mechanism 30. The channel forming member 31T has a first discharge channel 31R. The channel forming member 32T has a second discharge channel 32R. The channel forming member 33T has a third discharge channel 33R. One end of each of the first, second, and third discharge channels 31R, 32R, and 33R is connected to the channel switching mechanism 30. The first discharge port 31 is disposed at the other end of the first discharge channel 31R. The second discharge port 32 is disposed at the other end of the second discharge channel 32R. The third discharge port 33 is disposed at the other end of the third discharge channel 33R.

The channel switching mechanism 30 switches the channel so that the liquid which is recovered from the recovery port 20 and flows through the third channel 25R is sent to at least one of the first discharge channel 31R (first discharge port 31), the second discharge channel 32R (second discharge port 32), and the third discharge channel 33R (third discharge port 33). In the present embodiment, when the liquid from the third channel 25R is supplied to the first discharge port 31, the channel switching mechanism 30 can adjust the channel so that the liquid is not supplied to the second and third discharge ports 32 and 33. In addition, when the liquid from the third channel 25R is supplied to the second discharge port 32, the channel switching mechanism 30 can adjust the channel so that the liquid is not supplied to the first and third discharges ports 31 and 33. In addition, when the liquid from the third channel 25R is supplied to the third discharge port 33, the channel switching mechanism 30 can adjust the channel so that the liquid is not supplied to the first and second discharge ports 31 and 32.

In the present embodiment, the liquid system 100 includes a first receiving member 41 capable of receiving liquid discharged from the first discharge port 31, a second receiving member 42 capable of receiving liquid discharged from the second discharge port 32, and a third receiving member 43 capable of receiving liquid discharged from the third discharge port 33. In the present embodiment, each of the first, second, and third receiving members 41, 42, and 43 is a tank.

In the present embodiment, the other end of the first channel 23 is connected to a supply source LQS capable of supplying the exposure liquid LQ. The supply source LQS may be included in the liquid system 100, and may be equipment of the factory FA in which the exposure apparatus EX (device manufacturing system SYS) is installed. In addition, the exposure apparatus EX may include the supply source LQS.

In the present embodiment, a channel switching mechanism 34 including a valve mechanism is disposed in a portion of the first channel 23R. In addition, in the present embodiment, one end of a fourth channel 26R formed by a fourth channel forming member 26T is connected to the channel switching mechanism 34.

The exposure liquid LQ supplied from the supply source LQS flows through at least one of the first channel 23R and the fourth channel 26R. The channel switching mechanism 34 switches the channel so that the exposure liquid LQ flowing through the first channel 23R is sent to at least one of the first supply port 21 (first channel 23R) and the fourth channel 26R. In the present embodiment, when the exposure liquid LQ from the supply source LQS is supplied to the first supply port 21 (first channel 23R), the channel switching mechanism 34 can adjust the channel so that the exposure liquid LQ is not supplied to the fourth channel 26R. In addition, when the exposure liquid LQ from the supply source LQS is supplied to the fourth channel 26R, the channel switching mechanism 34 can adjust the channel so that the exposure liquid LQ is not supplied to the first supply port 21 (first channel 23R).

In addition, in the present embodiment, the liquid system 100 includes a diluter 35. The other end of the fourth channel 26R is connected to the diluter 35.

In addition, in the present embodiment, the liquid system 100 includes a cleaning liquid supply device 36 capable of supplying the cleaning liquid LC. In the present embodiment, first cleaning liquid LC1 and second cleaning liquid LC2 are used as the cleaning liquid LC. In the present embodiment, the liquid system 100 includes a first cleaning liquid supply device 36A capable of supplying the first cleaning liquid LC1, and a second cleaning liquid supply device 36B capable of supplying the second cleaning liquid LC2.

In the present embodiment, the other end of the second channel 24R is connected to the first cleaning liquid supply device 36A. In the present embodiment, a channel switching mechanism 38 including a valve mechanism is disposed in a portion of the second channel 24R. In addition, in the present embodiment, one end of a fifth channel 27R formed by a fifth channel forming member 27T is connected to the channel switching mechanism 38.

In the present embodiment, the other end of the fifth channel 27R is connected to the diluter 35. In addition, in the present embodiment, the diluter 35 and the second cleaning liquid supply device 36B are connected to each other through a sixth channel 28R formed by a sixth channel forming member 28T.

The second cleaning liquid supply device 36B can supply the second cleaning liquid LC2 through the sixth channel 28R to the diluter 35. In addition, the exposure liquid LQ flowing through the fourth channel 26R is sent to the diluter 35.

In the present embodiment, the diluter 35 dilutes the second cleaning liquid LC2 with the exposure liquid LQ. The second cleaning liquid LC2 which is diluted by the diluter 35 and is supplied from the diluter 35 flows through the fifth channel 27R. The second cleaning liquid LQ2 flowing through the fifth channel 27R is sent to the channel switching mechanism 38.

The channel switching mechanism 38 switches the channel so that at least one of the first cleaning liquid LC1 supplied from the first cleaning liquid supply device 36A and the second cleaning liquid LC2 supplied from the second cleaning liquid supply device 36B (diluter 35) is sent through the second channel 24R to the second supply port 22.

In the present embodiment, when the first cleaning liquid LC1 from the first cleaning liquid supply device 36A is supplied to the second supply port 22, the channel switching mechanism 38 can adjust the channel so that the second cleaning liquid LC2 is not supplied to the second supply port 22. In addition, when the second cleaning liquid LC2 from the second cleaning liquid supply device 36B (diluter 35) is supplied to the second supply port 22, the channel switching mechanism 38 can adjust the channel so that the first cleaning liquid LC1 is not supplied to the second supply port 22.

In the present embodiment, the fifth channel 27R can be connected to at least one of the first receiving member 41, the second receiving member 42, and the third receiving member 43. In the present embodiment, a channel switching mechanism 39 including a valve mechanism is disposed in a portion of the fifth channel 27R.

In addition, in the present embodiment, the liquid system 100 includes a detection apparatus 40 that detects the characteristics of the liquid (for example, at least one of properties and components thereof) recovered from the recovery port 20. In the present embodiment, the detection apparatus 40 measures liquid which is recovered from the recovery port 20 and which flows through the third channel 25R.

In the present embodiment, the characteristics of the liquid include conductivity of the liquid. In the present embodiment, the detection apparatus 40 includes a conductivity meter. The detection apparatus 40 detects the conductivity of the liquid. The detection result of the detection apparatus 40 may be output to, for example, the control apparatus 8. The control apparatus 8 can seek the characteristics of the liquid on the basis of the detection result of the detection apparatus 40. Furthermore, the detection result of the detection apparatus 40 may be output to the main controller MC, and the main controller MC may seek the characteristics of the liquid.

Furthermore, the characteristics of the liquid passing through the channel switching mechanism 38 may be detected. In this case, each of the first, second, and third discharge channels 31R, 32R, and 33R may be provided with the detection apparatus, or a portion of the first, second, and third discharge channels 31R, 32R, and 33R may be provided with the detection apparatus. In this case, they may be used in conjunction with the detection apparatus 40, and the detection apparatus 40 may be omitted.

In addition, in the present embodiment, the liquid system 100 includes a suction device 45 including a vacuum system and the like that reduces the pressure of the third interior channel 20R. The suction device 45 is connected to, for example, the third channel 25R. The suction device 45 reduces the pressure of the third channel 25R and the third interior channel 20R connected to the third channel 35R, and performs adjustment so that the pressure of the space SP2 which the lower surface 19B faces and the pressure of the space (third interior channel 20R) which the upper surface 19A faces are made different from each other (generation of the differential pressure), thereby allowing the liquid existing in the space SP2 to be recovered from the recovery port 20 (the hole 19H of the porous member 19). As mentioned above, the liquid recovered from the recovery port 20 is discharged from at least one of the first discharge port 31, the second discharge port 32, and the third discharge port 33. For example, the liquid flowing from the recovery port 20 into the third channel 25R is discharged from at least one of the first discharge port 31, the second discharge port 32, and the third discharge port 33 using gravity. Furthermore, the liquid flowing from the recovery port 20 into the third channel 25R may be received (suctioned) by connecting at least one of the first receiving member 41, the second receiving member 42, and the third receiving member 43 to the vacuum system.

Next, a description will be made of an example of a method of exposing the substrate P using the exposure apparatus EX according to the present embodiment.

The control apparatus 8 moves the substrate stage 2 to a substrate replacement position in order to load the substrate P onto the substrate stage 2 before the exposure. The substrate replacement position is a position which is away from the liquid immersion member 7 (projection region PR), and is a position at which a replacement process of the substrate P can be performed. The replacement process of the substrate P includes at least one of a process of unloading the substrate P after the exposure held in the substrate stage 2 (substrate holding portion 11) from the substrate stage 2 and a process of loading the substrate P before the exposure onto the substrate stage 2 (substrate holding portion 11), using a predetermined transport device (not shown). The control apparatus 8 moves the substrate stage 2 to the substrate replacement position, and performs the replacement process of the substrate P.

In at least a portion of the period of time in which the substrate stage 2 is away from the liquid immersion member 7, the control apparatus 8 disposes the measurement stage 3 in a position at which the measurement stage 3 faces the last optical element 12 and the liquid immersion member 7, and holds the exposure liquid LQ between the last optical element 12 and the liquid immersion member 7 and the measurement stage 3 to form the liquid immersion space LS.

In addition, in at least a portion of the period of time in which the substrate stage 2 is away from the liquid immersion member 7, a measurement process in which the measurement stage 3 is used may be performed as necessary. When performing the measurement process in which the measurement stage 3 is used, the control apparatus 8 causes the last optical element 12 and liquid immersion member 7 and the measurement stage 3 to face each other, and forms the liquid immersion space LS so that the light path K of the exposure light EL between the last optical element 12 and the measurement member C is filled with the exposure liquid LQ. The control apparatus 8 irradiates the measurement member C (measuring instrument) held in the measurement stage 3 with the exposure light EL through the projection optical system PL and the exposure liquid LQ, and performs the measurement process of the exposure light EL. The result of the measurement process may be reflected in the exposure process of the substrate P which is performed thereafter. Furthermore, the measurement process may not be performed.

After the substrate P before the exposure is loaded onto the substrate stage 2 and the measurement process in which the measurement stage 3 is used is terminated, the control apparatus 8 moves the substrate stage 2 to the projection region PR, and forms the liquid immersion space LS between the last optical element 12 and the liquid immersion member 7 and the substrate stage 2 (substrate P).

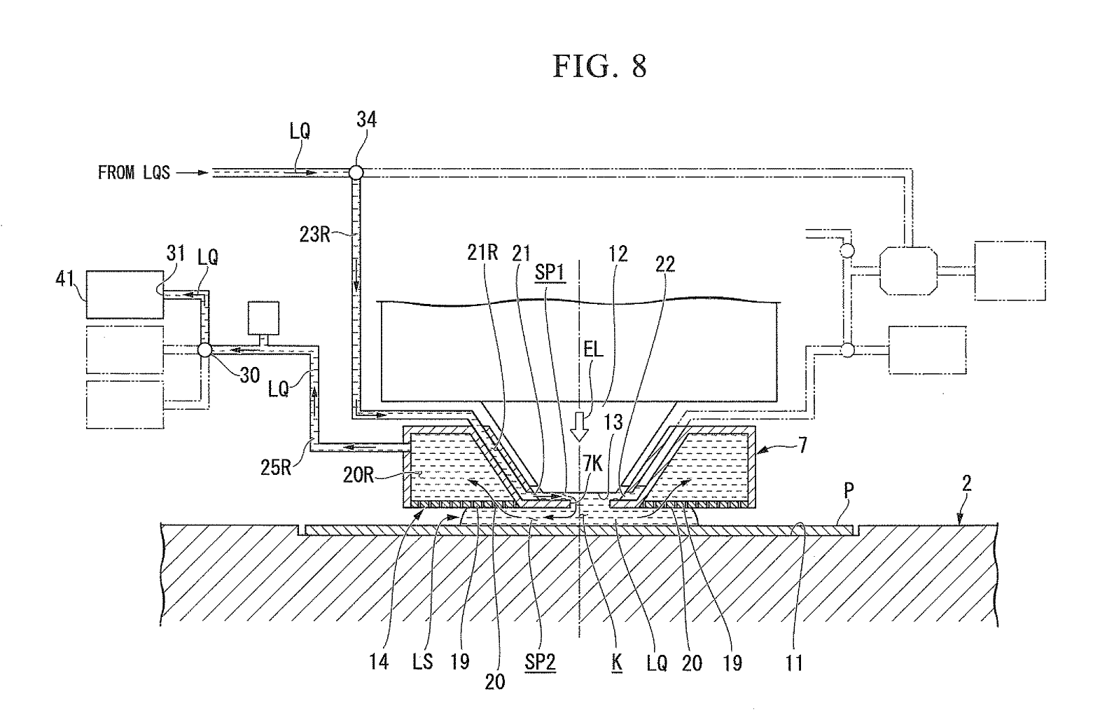

FIG. 8 is a diagram illustrating a state in which the liquid immersion space LS is formed by the exposure liquid LQ between the last optical element 12 and the liquid immersion member 7 and the substrate P. The exposure liquid LQ supplied from the supply source LQS is supplied to the first supply port 21 through the first channel 23R and the first interior channel 21R. The first supply port 21 supplies the exposure liquid LQ to the space SP1 (light path K). The exposure liquid LQ supplied to the space SP1 flows through the opening 7K into the space SP2. In addition, the operation of recovering the exposure liquid LQ from the recovery port 20 is performed concurrently with the operation of supplying the exposure liquid LQ from the first supply port 21. Thereby, the liquid immersion space LS is formed by the exposure liquid LQ between the last optical element 12 and the liquid immersion member 7 and the substrate P (substrate stage 2).

The recovery port 20 recovers the exposure liquid LQ of the space SP2. The exposure liquid LQ recovered from the recovery port 20 flows through the third interior channel 20R and the third channel 25R.

In the present embodiment, the channel is adjusted by the channel switching mechanism 30 so that the exposure liquid LQ recovered from the recovery port 20 is discharged from the first discharge port 31. The exposure liquid LQ discharged from the first discharge port 31 is supplied to the first receiving member 41.

After the liquid immersion space LS is formed between the last optical element 12 and the liquid immersion member 7 and the substrate stage 2 (substrate P), the control apparatus 8 starts the exposure process of the substrate P. When the exposure process of the substrate P is performed, the last optical element 12 and the liquid immersion member 7 face the substrate P, and the liquid immersion space LS is formed so that the light path K of the exposure light EL between the last optical element 12 and the substrate P is filled with the exposure liquid LQ.

The illumination system IL illuminates the mask M with the exposure light EL. The exposure light EL from the mask M is irradiated to the substrate P via the projection optical system PL and the exposure liquid LQ supplied from the first supply port 21. Thereby, the substrate P is exposed by the exposure light EL emitted from the last optical element 12. The image of the pattern of the mask M is projected onto the substrate P.

The exposure apparatus EX of the present embodiment is a scanning-type exposure apparatus (commonly called a scanning stepper) that projects the image of the pattern of the mask M onto the substrate P while synchronously moving the mask M and the substrate P in a predetermined scanning direction. In the present embodiment, the scanning direction (synchronous movement direction) of the substrate P is set to a Y axial direction, and the scanning direction (synchronous movement direction) of the mask M is also set to a Y axial direction. The control apparatus 8 irradiates the substrate P with the exposure light EL through the projection optical system PL and the exposure liquid LQ of the liquid immersion space LS on the substrate P, while moving the substrate P in the Y axial direction with respect to the projection region PR of the projection optical system PL, and moving the mask M in the Y axial direction with respect to the illumination region IR of the illumination system IL in synchronization with the movement of the substrate P in the Y axial direction.

After the exposure process of the substrate P is terminated, the control apparatus 8 moves the substrate stage 2 to the substrate replacement position. The measurement stage 3 is disposed, for example, so as to face the last optical element 12 and the liquid immersion member 7. The substrate P after the exposure is unloaded from the substrate stage 2 moved to the substrate replacement position, and the substrate P before the exposure is loaded into the substrate stage 2.

In the following, the control apparatus 8 repeats the above-mentioned processes, and sequentially exposes a plurality of substrates P.

Furthermore, in the present embodiment, in at least a portion of the period of time of the exposure sequence including the replacement process of the substrate P, the measurement process in which the measurement stage 3 is used, and the exposure process of the substrate P, the exposure liquid LQ is supplied from the first supply port 21 between the last optical element 12 and liquid immersion member 7 and the object (at least one of the substrate P, the substrate stage 2, and the measurement stage 3) disposed facing the last optical element 12 and the liquid immersion member 7, and at least a portion of the exposure liquid LQ supplied from the first supply port 21 is recovered from the recovery port 20. The exposure liquid LQ recovered from the recovery port 20 in the exposure sequence is discharged from the first discharge port 31.

In the present embodiment, in the period of time of the exposure sequence, the cleaning liquid LC is not supplied from the cleaning liquid supply device 36. That is, in the period of time of the exposure sequence, the liquid supply from the second supply port 22 is stopped. In the exposure sequence, the supply of the exposure liquid LQ from the first supply port 21 is performed, and the liquid supply from the second supply port 22 is stopped.

Incidentally, there is a possibility that substances (for example, organic substances such as a photosensitive material) generated (eluted) from the substrate P during the exposure of the substrate P may be mixed into the exposure liquid LQ of the liquid immersion space LS as foreign substances (contaminants or particles). In addition, there is a possibility that not only substances generated from the substrate P but also, for example, foreign substances floating through the air may be mixed into the exposure liquid LQ of the liquid immersion space LS. As mentioned above, in at least a portion of the period of time of the exposure sequence including the replacement process of the substrate P, the measurement process in which the measurement stage 3 is used, and the exposure process of the substrate P, the exposure liquid LQ of the liquid immersion space LS is in contact with at least a portion of the last optical element 12, the liquid immersion member 7, the substrate stage 2, and the measurement stage 3.

Therefore, when foreign substances are mixed into the exposure liquid LQ of the liquid immersion space LS, there is a possibility that foreign substances may be attached to at least a portion of the emission surface 13 of the last optical element 12, the lower surface 14 of the liquid immersion member 7, the porous member 19 disposed in the recovery port 20, the upper surface 2F of the substrate stage 2, and the upper surface 3F of the measurement stage 3. Although not limited thereto, when a state in which foreign substances are attached to the surface (liquid contact surface) of the liquid contact member within the exposure apparatus EX which is in contact with the exposure liquid LQ is left as it is, there is a possibility that the foreign substances may be attached to the substrate P during the exposure, or the exposure liquid LQ supplied from the first supply port 21 may be contaminated. In addition, when at least one of the emission surface 13 of the last optical element 12, the lower surface 14 of the liquid immersion member 7, the upper surface 2F of the substrate stage 2, and the upper surface 3F of the measurement stage 3 is contaminated, there is a possibility that, for example, the liquid immersion space LS cannot be satisfactorily formed. As a result, there is a possibility that the defective exposure may occur.

Consequently, in the present embodiment, the control apparatus 8 performs a cleaning process of the liquid contact member within the exposure apparatus EX which is in contact with the exposure liquid LQ of the liquid immersion space LS, in the period of time of the exposure sequence and/or the period of time other than the exposure sequence at a predetermined timing. Furthermore, the cleaning process may be performed on the member which is out of contact with the exposure liquid LQ, and/or the portion, which is out of contact with the exposure liquid LQ, of the member which is in contact with the exposure liquid LQ.

Hereinafter, a case in which, among the liquid contact members within the exposure apparatus EX which are in contact with the exposure liquid LQ, the liquid immersion member 7 is chiefly cleaned will be described by way of example.

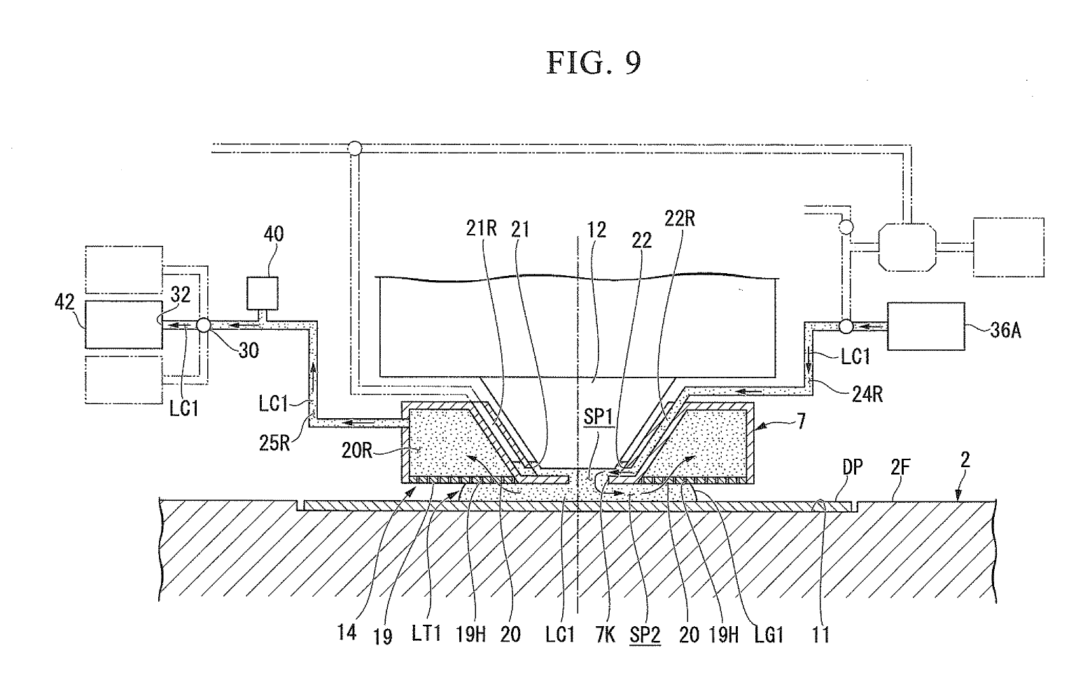

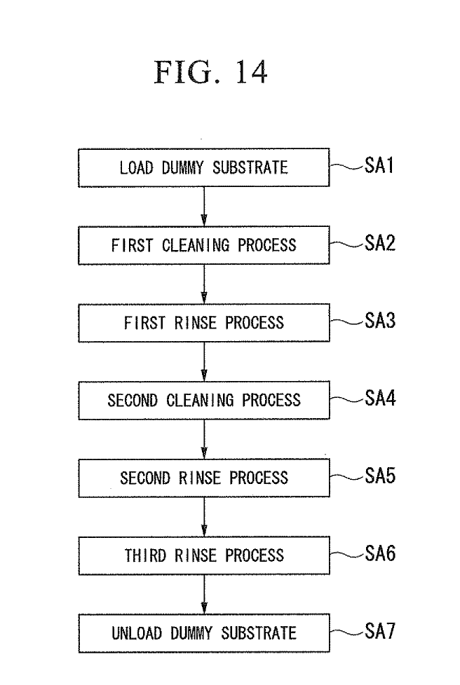

FIGS. 9 to 13 are schematic diagrams illustrating an example of the cleaning sequence according to the present embodiment. FIG. 14 is a flow diagram illustrating an example of the cleaning sequence according to the present embodiment. The cleaning sequence according to the present embodiment includes a step of loading the dummy substrate DP onto the substrate stage 2 (step SA1), a step of supplying the cleaning liquid LC1 to the first liquid immersion member 7 and cleaning the liquid immersion member 7 (step SA2), a step of supplying rinse liquid LH to the liquid immersion member 7 (step SA3), a step of supplying the second cleaning liquid LC2 to the liquid immersion member 7 and cleaning the liquid immersion member 7 (step SA4), a step of supplying the rinse liquid LH to the liquid immersion member 7 (step SA5), a step of further supplying the rinse liquid LH to the liquid immersion member 7 (step SA6), and a step of unloading the dummy substrate DP from the substrate stage 2 (step SA7).

In the following description, the cleaning step in which the first cleaning liquid LC1 is used (SA2) is appropriately referred to as a first cleaning process, and the cleaning step in which the second cleaning liquid LC2 is used (SA4) is appropriately referred to as a second cleaning process.

In addition, in the following description, the step of supplying the rinse liquid LH to the member such as the liquid immersion member 7 cleaned using the cleaning liquids LC (LC1 and LC2) is appropriately referred to as a rinse process. The rinse process includes a step of supplying the rinse liquid LH to the member to rinse the member and removing the cleaning liquids LC (LC1 and LC2) remaining in the member. In addition, in the following description, the rinse step (SA3) performed after the first cleaning process is appropriately referred to as a first rinse process, the rinse step (SA5) performed after the second cleaning process is appropriately referred to as a second rinse process, and the rinse step (SA6) performed after the second rinse process is appropriately referred to as a third rinse process.

Alkaline liquid may be used as the first cleaning liquid LC1. That is, an alkaline solution containing a predetermined substance may be used as the first cleaning liquid LC1. For example, the first cleaning liquid LC1 may contain tetramethyl ammonium hydroxide (TMAH) as the predetermined substance. In addition, an alkaline aqueous solution may be used as the first cleaning liquid LC1.

Acidic liquid may be used as the second cleaning liquid LC2. That is, an acidic solution containing a predetermined substance may be used as the second cleaning liquid LC2. For example, the second cleaning liquid LC2 may contain hydrogen peroxide as the predetermined substance. In addition, an acidic aqueous solution may be used as the second cleaning liquid LC2.

In addition, the first cleaning liquid LC1 and the rinse liquid LH may contain the same type of liquid. In addition, the second cleaning liquid LC2 and the rinse liquid LH may contain the same type of liquid.

In the present embodiment, an alkaline aqueous solution is used as the first cleaning liquid LC1. A hydrogen peroxide solution is used as the second cleaning liquid LC2. The exposure liquid LQ is used as the rinse liquid LH. That is, in the present embodiment, the rinse liquid LH is water (pure water). In the present embodiment, each of the first cleaning liquid LC1, the second cleaning liquid LC2, and the rinse liquid LH contains water as the same type of liquid.

In the present embodiment, a tetramethyl ammonium hydroxide (TMAH) aqueous solution is used as the first cleaning liquid LC1. A hydrogen peroxide solution (hydrogen peroxide water) is used as the second cleaning liquid LC2.

Furthermore, as the alkaline solutions used as the first cleaning liquid LC1, not only a tetramethyl ammonium hydroxide solution, but also inorganic alkali solutions such as sodium hydroxide and potassium hydroxide, and organic alkali solutions such as trimethyl hydroxide (2-hydroxyethyl) ammonium may be used. Furthermore, aqueous ammonia may be used as the first cleaning liquid LC1.

Furthermore, the second cleaning liquid LC2 may contain a buffered hydrofluoric acid solution. In addition, the second cleaning liquid LC2 may be a solution containing buffered hydrofluoric acid and hydrogen peroxide. The buffered hydrofluoric acid is a mixture with hydrofluoric acid and ammonium fluoride. The mixing ratio thereof may be 5 to 2,000 in terms of the volume ratio of a 40 wt % ammonium fluoride solution/50 wt % hydrofluoric acid. In addition, the mixing ratio of buffered hydrofluoric acid to hydrogen peroxide may be 0.8 to 55 in terms of the weight ratio of hydrogen peroxide/hydrofluoric acid. Ozone liquid containing ozone may be used as the second cleaning liquid LC2. Of course, a solution containing hydrogen peroxide and ozone may be used.

Furthermore, at least one of the first cleaning liquid LC1 and the second cleaning liquid LC2 may contain alcohol. For example, at least one of the first cleaning liquid LC1 and the second cleaning liquid LC2 may contain at least one of ethanol, isopropyl alcohol (IPA), and pentanol.

In addition, the same type of liquid contained in each of the first cleaning liquid LC1 and the second cleaning liquid LC2 may be, for example, alcohol.

In the present embodiment, in at least a portion of the cleaning sequence of the liquid immersion member 7, the dummy substrate DP is disposed in a position facing the liquid immersion member 7. In the present embodiment, a device pattern cannot be formed in the dummy substrate DP. That is, a photosensitive film is not formed in the dummy substrate DP. The dummy substrate DP is a substrate which releases foreign substances less easily than the substrate P. In addition, the dummy substrate DP may have a function of trapping foreign substances onto the surface of the dummy substrate DP. In this case, it is preferable that the dummy substrate DP does not easily release foreign substances trapped (attached) onto the surface of the dummy substrate DP. In addition, in the present embodiment, the outer shape and the size of the dummy substrate DP is about the same as the outer shape and the size of the substrate P. The substrate holding portion 11 can hold the dummy substrate DP. In the present embodiment, in the state where the dummy substrate DP held in the substrate stage 2 (substrate holding portion 11) and the liquid immersion member 7 face each other, at least a portion of the cleaning sequence of the liquid immersion member 7 is performed. That is, the first cleaning liquid LC1, the second cleaning liquid LC2, and the rinse liquid LH are respectively supplied in the state where the dummy substrate DP is disposed facing the liquid immersion member 7. At least one of the outer shape and the size of the dummy substrate DP may be different from those of the substrate P. For example, the size of the dummy substrate may be made smaller than that of the substrate P. Furthermore, in at least a portion of the cleaning sequence of the liquid immersion member 7, the dummy substrate DP may not be held in the substrate holding portion 11. For example, a state may be maintained in which the dummy substrate DP is released from the substrate holding portion 11, the dummy substrate DP is supported by a support mechanism different from the substrate holding portion 11, and the liquid immersion member 7 and the dummy substrate DP face each other. In this case, after the dummy substrate DP is released from the substrate holding portion 11, the substrate holding portion 11 (substrate stage 2) may be away from under the liquid immersion member 7.

Furthermore, at least one of the first cleaning liquid LC1, the second cleaning liquid LC2, and the rinse liquid LH may be supplied in the state where at least one of the upper surface 2F of the substrate stage 2 and the upper surface 3F of the measurement stage 3 is disposed facing the liquid immersion member 7, and may be supplied in the state where a separate object from the dummy substrate DP, the substrate stage 2, and the measurement stage 3 is disposed.

In the cleaning of the liquid immersion member 7, at least a portion of the surface of the dummy substrate DP faces the lower surface 14 of the liquid immersion member 7. In the cleaning of the liquid immersion member 7, the liquid (at least one of the first cleaning liquid LC1, the second cleaning liquid LC2, and the rinse liquid LH) is in contact with at least a portion of the surface of the dummy substrate DP.

In the present embodiment, the surface of the dummy substrate DP is liquid-repellent with respect to the rinse liquid LH. In addition, in the present embodiment, the surface of the dummy substrate DP is liquid-repellent with respect to the first and second cleaning liquids LC1 and LC2. In the present embodiment, the dummy substrate DP includes a base material including a semiconductor wafer such as a silicon wafer, and a liquid-repellent film formed on the base material. At least a portion of the surface of the dummy substrate DP includes the liquid-repellent film. In the following description, the liquid-repellent film in which at least a portion of the surface of the dummy substrate DP is formed is appropriately referred to as a liquid-repellent film.

The liquid-repellent film may be formed of a material containing fluorine. For example, the liquid-repellent film may be formed of a resin containing fluorine. For example, the liquid-repellent film may be formed of polytetrafluoroethylene (PFA), polytetrafluoroethylene (PTFE), Teflon (registered trademark) or the like. In addition, the liquid-repellent film may be, for example, a silicon carbonitride (SiCN) film formed by a CVD method.

Furthermore, the liquid-repellent film is not limited to a resin containing fluorine. The liquid-repellent film may have resistance properties with respect to the first and second cleaning liquids LC1 and LC2, and the rinse liquid LH, and may have a surface (liquid-repellent) capable of satisfactorily forming the liquid immersion space of these liquids between the surface and the liquid immersion member 7. In the present embodiment, the contact angle of the first liquid LC1 and the contact angle of the second liquid LC2 in the surface of the dummy substrate DP are 80 degrees or more, 90 degrees or more, 100 degrees or more, 110 degrees or more, or 120 degrees or more.

In addition, another film (for example, a film for enhancing the adhesion of the base material to the liquid-repellent film) may be formed between the base material and the liquid-repellent film.

The control apparatus 8 loads the dummy substrate DP onto the substrate stage 2 (step SA1). The control apparatus 8 moves the substrate stage 2 to the substrate replacement position in order to load the dummy substrate DP onto the substrate stage 2 (substrate holding portion 11). Furthermore, when the substrate P is held in the substrate holding portion 11, the substrate P is unloaded from the substrate stage 2, and then the dummy substrate DP is loaded onto the substrate holding portion 11.

After the dummy substrate DP is loaded onto the substrate stage 2, the control apparatus 8 moves the substrate stage 2 so that the dummy substrate DP held in the substrate stage 2 is disposed in a position facing the last optical element 12 and the liquid immersion member 7.

The control apparatus 8 starts the first cleaning process (step SA2). In the present embodiment, after the entirety of the exposure liquid LQ of the liquid immersion space LS between the last optical element 12 and the liquid immersion member 7 and the objects (the substrate stage 2, the measurement stage 3, the dummy substrate DP and the like) is recovered, the first cleaning process is started.

In the present embodiment, in the state where the substrate stage 2 is disposed in the substrate replacement position in order to load the dummy substrate DP, the measurement stage 3 is disposed in a position facing the last optical element 12 and the liquid immersion member 7. In order to recover the entirety of the exposure liquid LQ of the liquid immersion space LS formed between the last optical element 12 and the liquid immersion member 7 and the measurement stage 3, the control apparatus 8 recovers the exposure liquid LQ from the recovery port 20 (the hole 1911 of the porous member 19) for a predetermined time, in the state where the supply of the exposure liquid LQ from the first supply port 21 is stopped. Thereby, substantially the entirety of the exposure liquid LQ between the last optical element 12 and the liquid immersion member 7 and the measurement stage 3 is recovered. Furthermore, in a case when the entirety of the exposure liquid LQ of the liquid immersion space LS is recovered, the object different from the measurement stage 3 may be disposed in the position facing the last optical element 12 and the liquid immersion member 7. For example, in the state where the exposure liquid LQ is held between the last optical element 12 and the liquid immersion member 7 and the dummy substrate DP (or substrate stage 2) loaded onto the substrate stage 2, the supply of the exposure liquid LQ from the first supply port 21 may be stopped, and the recovery of the exposure liquid LQ from the recovery port 20 may be performed for a predetermined time.

Furthermore, in order to recover the entirety of the exposure liquid LQ, the exposure liquid LQ may be recovered from the second supply port 22 as well as from the recovery port 20. That is, the second supply port 22 may be caused to function as a recovery port of the exposure liquid LQ. It is possible to recover the exposure liquid LQ from the second supply port 22 by connecting the second supply port 22 to the vacuum system. Furthermore, in order to recover the entirety of the exposure liquid LQ, the recovery operation from the second supply port 22 may be performed and the recovery operation from the recovery port 20 may not be performed. In addition, the exposure liquid LQ may be recovered from the first supply port 21 by connecting the first supply port 21 to the vacuum system.

Furthermore, when the supply of the exposure liquid LQ from the first supply port 21 is stopped and then the first cleaning process are performed, the exposure liquid LQ remaining in the first interior channel 21R may be removed. For example, after the supply of the exposure liquid LQ is stopped, at least one of the first interior channel 21R and the first channel 23R may be depressurized, to thereby remove the exposure liquid LQ remaining in at least one of the first interior channel 21R and the first channel 23R. For example, in order to depressurize the first interior channel 21R, the vacuum system (suction device) may be connected to at least one of the first interior channel 21R and the first channel 23R, to thereby suction (depressurize) the first interior channel 21R. Thereby, the exposure liquid LQ remaining in the first interior channel 21R is suctioned into the vacuum system, and the exposure liquid LQ is discharged from the first interior channel 21R. In addition, at least one of the first interior channel 21R and the first channel 23R may be pressurized, to thereby remove the exposure liquid LQ remaining in at least one of the first interior channel 21R and the first channel 23R. For example, in order to pressurize the first interior channel 21R, a gas supply device is connected to at least one of the first interior channel 21R and the first channel 23R, and then gas may be supplied to the first interior channel 21R to thereby pressurize the first interior channel 21R. Thereby, the exposure liquid LQ remaining in the first interior channel 21R is discharged from the first supply port 21, and the exposure liquid LQ is discharged from the first interior channel 21R. In addition, for example, the first interior channel 21R and the first cleaning liquid supply device 36A are connected to each other in a predetermined channel, and then the first cleaning liquid LC1 sent out froth the first cleaning liquid supply device 36A may be supplied to the first interior channel 21R to thereby discharge the exposure liquid LQ from the first interior channel 21R. Furthermore, in the state where the exposure liquid LQ remains in at least one of the first interior channel 21R and the first channel 23R, the cleaning process may be started.

In the state where the entirety of the exposure liquid LQ is recovered and the last optical element 12 and the liquid immersion member 7 face the dummy substrate DP, the control apparatus 8 starts the first cleaning process. In order to clean the liquid immersion member 7 by the first cleaning liquid LC1, the control apparatus 8 starts the supply of the first cleaning liquid LC1.

FIG. 9 is a diagram illustrating an example of a state in which the first cleaning process is performed. The control apparatus 8 starts the supply of the first cleaning liquid LC1 from the second supply port 22. In the state where the supply of the exposure liquid. LQ from the first supply port 21 is stopped, the control apparatus 8 supplies the first cleaning liquid LC1 from the second supply port 22 to the space SP1.

In the first cleaning process, the recovery of the first cleaning liquid LC1 from the recovery port 20 is performed concurrently with the supply of the first cleaning liquid LC1 from the second supply port 22. Thereby, a liquid immersion space LT1 is formed by the first cleaning liquid LC1 between the last optical element 12 and the liquid immersion member 7 and the dummy substrate DP.

In the first cleaning process, the first cleaning liquid LC1 is sent out from the first cleaning liquid supply device 36A. Furthermore, the first cleaning liquid supply device 36A may be equipment of the factory FA. The first cleaning liquid LC1 supplied from the first cleaning liquid supply device 36A is supplied to the second supply port 22 through the second channel 24R and the second interior channel 22R. The second supply port 22 supplies the first cleaning liquid LC1 to the space SP1. The first cleaning liquid LC1 supplied to the space SP1 flows through the opening 7K into the space SP2. The first cleaning liquid LC1 is in contact with at least a portion of the surface of the liquid immersion member 7 including the lower surface 14. The surface of the liquid immersion member 7 is cleaned by the first cleaning liquid LC1.

The first cleaning liquid LC1 contains alkali, and can remove foreign substances containing organic substances existing in the surface (lower surface 14 and the like) of the liquid immersion member 7. Therefore, the first cleaning liquid LC1 is supplied so as to be in contact with the liquid immersion member 7, whereby the foreign substances attached to the liquid immersion member 7 are removed.

The recovery port 20 recovers the first cleaning liquid LC1 supplied from the second supply port 22 to at least a portion of the surface of the liquid immersion member 7. The recovery port 20 recovers the first cleaning liquid LC1 of the space SP2. The foreign substances removed from the surface of the liquid immersion member 7 are recovered from the recovery port 20 together with the first cleaning liquid LC1.

The first cleaning liquid LC1 recovered from the recovery port 20 flows through the third interior channel 20R and the third channel 25R. In the present embodiment, the channel is adjusted by the channel switching mechanism 30 so that the first cleaning liquid LC1 recovered from the recovery port 20 is discharged from the second discharge port 32. Thereby, the first cleaning liquid LC1 which is supplied to the liquid immersion member 7 and is recovered from the recovery port 20 is discharged from the second discharge port 32. The first cleaning liquid LC1 discharged from the second discharge port 32 is supplied to the second receiving member 42.

As mentioned above, in the present embodiment, after the entirety of the exposure liquid LQ is recovered, the liquid immersion space LT1 is formed by the first cleaning liquid LC1. Thereby, the first cleaning liquid LC1 is prevented from being diluted by the exposure liquid LQ between the last optical element 12 and the liquid immersion member 7 and the dummy substrate DP. The concentration of alkali contained in the first cleaning liquid LC1 which is sent out from the first cleaning liquid supply device 36A and is supplied from the second supply port 22 to the surface of the liquid immersion member (liquid contact member) 7 is adjusted to a concentration suitable for cleaning. The first cleaning liquid LC1 is prevented from being diluted by the exposure liquid LQ between the last optical element 12 and the liquid immersion member 7 and the dummy substrate DP, whereby it is possible to clean the liquid immersion member 7 by the first cleaning liquid LC1 containing alkali having a concentration suitable for cleaning.

In the present embodiment, the supply of the exposure liquid LQ from the first supply port 21 is stopped in the first cleaning process. In that case, the exposure liquid LQ may be filled into the first interior channel 21R. In the state where the exposure liquid LQ is filled into the first interior channel 21R, the liquid immersion space LT1 is formed by the first cleaning liquid LC1, whereby it is possible to prevent the first cleaning liquid LC1 from infiltrating into the first interior channel 21R, the first channel 23R and the like. Furthermore, the first cleaning liquid LC1 may flow from the first supply port 21 into the first interior channel 21R.

After the first cleaning liquid LC1 is supplied from the second supply port 22 for a predetermined time, the control apparatus 8 stops the supply of the first cleaning liquid LC1 from the second supply port 22. Thereby, the first cleaning process (step SA2) is terminated.

After the first cleaning process is terminated, the first rinse process is started (step SA3). In the present embodiment, after the entirety of the first cleaning liquid LC1 of the liquid immersion space LT1 is recovered, the first rinse process is started. In the state where the supply of the first cleaning liquid LC1 from the second supply port 22 is stopped, the control apparatus 8 performs the recovery of the first cleaning liquid LC1 from the recovery port 20 (the hole 19H of the porous member 19) for a predetermined time. Thereby, substantially the entirety of the first cleaning liquid LC1 between the last optical element 12 and the liquid immersion member 7 and the dummy substrate DP is recovered.

Furthermore, in order to recover the entirety of the first cleaning liquid LC1, the first cleaning liquid LC1 may be recovered from the second supply port 22 as well as from the recovery port 20. It is possible to recover the first cleaning liquid LC1 from the second supply port 22 by connecting the second supply port 22 to the vacuum system. Furthermore, in order to recover the entirety of the first cleaning liquid LC1, the recovery operation from the second supply port 22 may be performed, and the recovery operation from the recovery port 20 may not be performed. In addition, the first cleaning liquid LC1 may be recovered from the first supply port 21 by connecting the first supply port 21 to the vacuum system.

Furthermore, when the supply of the first cleaning liquid LC1 is stopped and before the first rinse process is performed, the first cleaning liquid LC1 remaining in the second interior channel 22R may be removed. For example, after the supply of the first cleaning liquid LC1 is stopped, at least one of the second interior channel 22R and the second channel 24R may be depressurized, to thereby remove the first cleaning liquid LC1 remaining in at least one of the second interior channel 22R and the second channel 24R. For example, in order to depressurize the second interior channel 22R, the vacuum system (suction device) may be connected to at least one of the second interior channel 22R and the second channel 24R, to thereby suction (depressurize) the second interior channel 22R. Thereby, the first cleaning liquid LC1 remaining in the second interior channel 22R is suctioned into the vacuum system, and the first cleaning liquid LC1 is discharged from the second interior channel 22R. In addition, at least one of the second interior channel 22R and the second channel 24R may be pressurized, to thereby remove the first cleaning liquid LC1 remaining in at least one of the second interior channel 22R and the second channel 24R. For example, in order to pressurize the second interior channel 22R, the gas supply device is connected to at least one of the second interior channel 22R and the second channel 24R, and then gas may be supplied to the second interior channel 22R to thereby pressurize the second interior channel 22R. Thereby, the first cleaning liquid LC1 remaining in the second interior channel 22R is discharged from the second supply port 22, and the first cleaning liquid LC1 is discharged from the second interior channel 22R. In addition, for example, the second interior channel 22R and the supply source LQS are connected to each other in a predetermined channel, and then the exposure liquid LQ sent out from the supply source LQS may be supplied to the second interior channel 22R to thereby discharge the first cleaning liquid LC1 from the second interior channel 22R. Furthermore, the first cleaning liquid LC1 may be removed (discharged) from at least one of the fifth channel 27R and the second channel 24R. For example, the exposure liquid LQ sent out from the supply source LQS may be supplied to at least one of the fifth channel 27R and the second channel 24R.

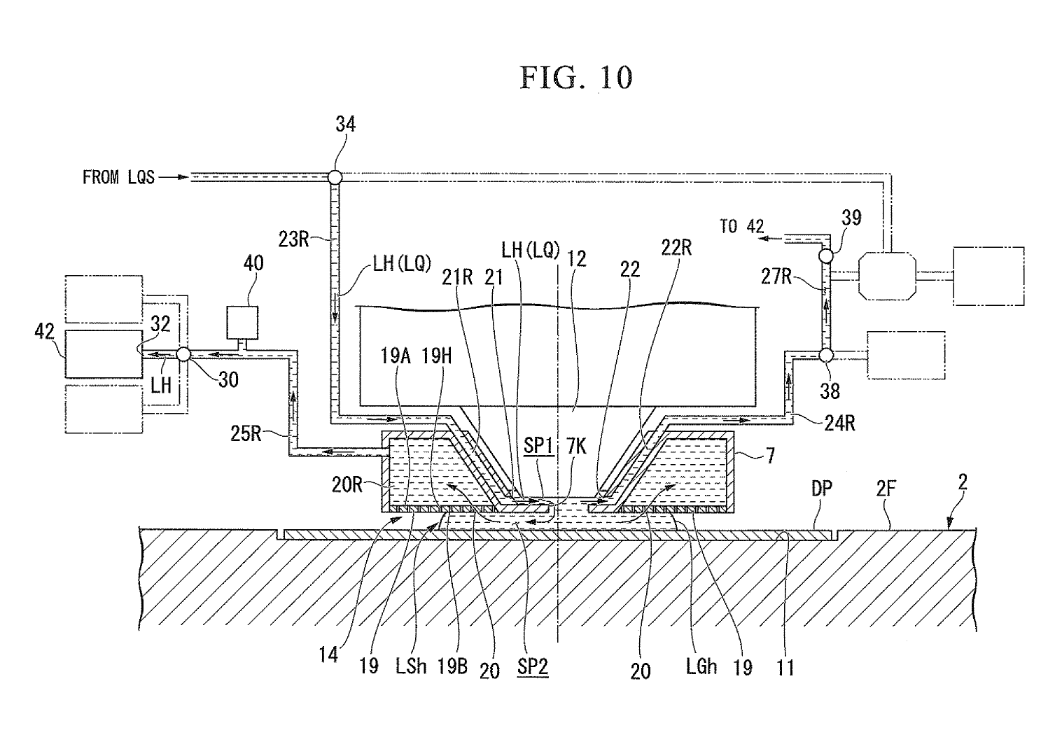

FIG. 10 is a diagram illustrating an example of a state in which the first rinse process is performed. Even in the first rinse process, the dummy substrate DP is disposed facing the liquid immersion member 7.

The control apparatus 8 starts the supply of the rinse liquid LH in order to rinse the liquid immersion member 7 with the rinse liquid LH. Furthermore, in the state where the liquid immersion space LT1 of the first cleaning liquid LC1 is formed, the supply of the rinse liquid LH may be started.

The control apparatus 8 starts the supply of the rinse liquid LH from the first supply port 21. In the state where the supply of the cleaning liquid LC from the second supply port 22 is stopped, the control apparatus 8 supplies the rinse liquid LH from the first supply port 21 to the space SP1. As mentioned above, in the present embodiment, the exposure liquid LQ is used as the rinse liquid LH.

In the first rinse process, the recovery of the liquid (including at least one of the first cleaning liquid LC1 and the rinse liquid LH) from the recovery port 20 is performed concurrently with the supply of the rinse liquid LH (exposure liquid LQ) from the first supply port 21. Thereby, a liquid immersion space LSh is formed by the rinse liquid LH between the last optical element 12 and the liquid immersion member 7 and the dummy substrate DP.

As shown in FIG. 10, in the rinse process, the rinse liquid LH (exposure liquid LQ) is sent out from the supply source LQS. The rinse liquid LH supplied from the supply source LQS is supplied to the first supply port 21 through the first channel 23R and the first interior channel 21R. The first supply port 21 supplies the rinse liquid LH to the space SP1. The rinse liquid LH supplied to the space SP1 flows through the opening 7K into the space SP2. The rinse liquid LH is in contact with at least a portion of the surface of the liquid immersion member 7 including the lower surface 14. The surface of the liquid immersion member 7 is rinsed with the rinse liquid LH.

The rinse liquid LH can remove the first cleaning liquid LC1 remaining in the surface of the liquid immersion member 7. The rinse liquid LH supplied from the first supply port 21 is in contact with the liquid immersion member 7, whereby it is possible to remove the first cleaning liquid LC1 remaining in the liquid immersion member 7. In the present embodiment, the rinse liquid LH is pure water and the first cleaning liquid LC1 is an alkali aqueous solution. Therefore, the rinse liquid LH can remove the first cleaning liquid LC1 remaining in the liquid immersion member 7. In addition, since the rinse liquid LH supplied from the first supply port 21 is in contact with the liquid immersion member 7, it is possible to remove foreign substances attached to the liquid immersion member 7 with the rinse liquid LH.

The recovery port 20 recovers the rinse liquid LH supplied from the first supply port 21 to at least a portion of the surface of the liquid immersion member 7. The recovery port 20 recovers the rinse liquid LH of the space SP2. The first cleaning liquid LC1 removed from the surface of the liquid immersion member 7 is recovered from the recovery port 20 together with the rinse liquid LH.

In the present embodiment, the recovery of the liquid from the second supply port 22 is also performed in the first rinse process. The second supply port 22 can be connected to the vacuum system, and can function as a recovery port of the liquid. That is, in the present embodiment, the recovery of the liquid from the recovery port 20 and the second supply port 22 is performed concurrently with the supply of the rinse liquid LH from the first supply port 21. The first cleaning liquid LC1 remaining in the second interior channel 22R, second channel 24R and the like is removed by recovering the liquid from the second supply port 22. The second interior channel 22R, the second channel 24R and the like are rinsed with the rinse liquid LH.

The rinse liquid LH recovered from the recovery port 20 flows through the third interior channel 20R and the third channel 25R. The rinse liquid LH recovered from the second supply port 22 flows through the second interior channel 22R and the second channel 24R.

In the present embodiment, the channel is adjusted by the channel switching mechanism 30 so that the rinse liquid LH recovered from the recovery port 20 is discharged from the second discharge port 32. Thereby, the rinse liquid LH which is supplied to the liquid immersion member 7 and is recovered from the recovery port 20 is discharged from the second discharge port 32. The rinse liquid LH discharged from the second discharge port 32 is supplied to the second receiving member 42.

In this manner, in the present embodiment, during the supply and the recovery of the rinse liquid LH, the rinse liquid LH recovered from the recovery port 20 is discharged from the second discharge port 32.

In addition, the rinse liquid LH recovered from the second supply port 22 is sent through the second interior channel 22R, the second channel 24R, and the fifth channel 27R to the channel switching mechanism 39. The channel is adjusted by the channel switching mechanism 39 so that the rinse liquid LH recovered from the second supply port 22 is sent to the second receiving member 42.

The control apparatus 8 performs the supply of the rinse liquid LH from the first supply port 21 and the recovery of the rinse liquid LH from the recovery port 20 and the second supply port 22 for a predetermined period of time.

Furthermore, in the first rinse process, the rinse liquid LH may be supplied from the first and second supply ports 21 and 22, and the supplied rinse liquid LH may be recovered from the recovery port 20.

Furthermore, in the first rinse process, after the supply of the rinse liquid LH from the first supply port 21 is performed and the recovery thereof from the recovery port 20 and the second supply port 22 is performed, the recovery thereof from the second supply port 22 is stopped, and then the supply of the rinse liquid LH from the first supply port 21 may be performed, and the recovery thereof from the recovery port 20 may be performed. Furthermore, in the first rinse process, the recovery thereof from the second supply port 22 may not be performed.

In the present embodiment, in the first rinse process, the characteristics of the rinse liquid LH recovered from the recovery port 20 are detected by the detection apparatus 40. The detection apparatus 40 detects the characteristics of the rinse liquid LH which is recovered from the recovery port 20 and flows through the third channel 25R. In the present embodiment, the detection apparatus 40 detects the conductivity of the rinse liquid LH recovered from the recovery port 20. The detection result of the detection apparatus 40 is output to the control apparatus 8. The control apparatus 8 seeks the concentration of alkali (tetramethyl ammonium hydroxide) contained in the recovered rinse liquid LH from the detection result of the detection apparatus 40, and continues the first rinse process (the supply and the recovery of the rinse liquid LH) until the concentration becomes a previously determined acceptable value or less. For example, until the concentration of the alkali contained in the rinse liquid LH recovered from the recovery port 20 becomes 1% or less, the first rinse process is continued.

After it is confirmed that the concentration of the alkali contained in the rinse liquid LH recovered from the recovery port 20 becomes an acceptable value or less on the basis of the detection result of the detection apparatus 40, the first rinse process (step SA3) is terminated.

After the first rinse process is terminated, the control apparatus 8 starts the second cleaning process (step SA4). The control apparatus 8 starts the supply of the second cleaning liquid LC2 in order to clean the liquid immersion member 7 by the second cleaning liquid LC2.

Furthermore, in the present embodiment, until the supply of the second cleaning liquid LC2 to the liquid immersion member 7 is started, the concurrent operation of the supply of the rinse liquid LH from the first supply port 21 and the recovery of the rinse liquid LH from the recovery port 20 is performed. That is, in the state where the supply of the rinse liquid LH is stopped and then the liquid immersion space LSh of the rinse liquid LH is formed, the supply of the second cleaning liquid LC2 is started.

Furthermore, after the supply of the rinse liquid LH is stopped and then the entirety of the rinse liquid LH of the liquid immersion space LSh between the last optical element 12 and the liquid immersion member 7 and the dummy substrate DP is recovered, the second cleaning process (supply of the second cleaning liquid LC2) may be started.

Furthermore, when the supply of the rinse liquid LH is stopped and then the second cleaning process are performed, the rinse liquid LH remaining in the first interior channel 21R may be removed. For example, after the supply of the rinse liquid LH is stopped, at least one of the first interior channel 21R and the first channel 23R may be depressurized or pressurized, to thereby remove the rinse liquid LH remaining in at least one of the first interior channel 21R and the first channel 23R.

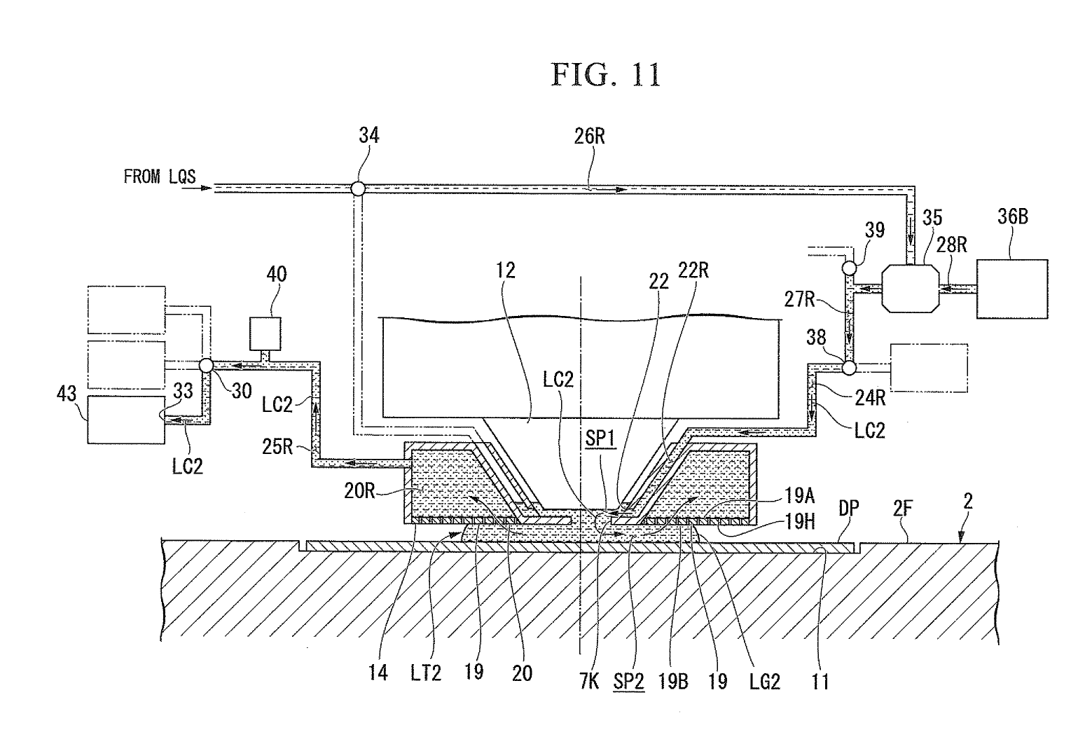

FIG. 11 is a diagram illustrating an example of a state in which the second cleaning process is performed. The control apparatus 8 starts the supply of the second cleaning liquid LC2 from the second supply port 22. In the state where the supply of the rinse liquid LH from the first supply port 21 is stopped, the control apparatus 8 supplies the second cleaning liquid LC2 from the second supply port 22 to the space SP1. The second cleaning liquid LC2 is supplied in the state where the dummy substrate DP is disposed facing the liquid immersion member 7.

In the second cleaning process, the recovery of the second cleaning liquid LC2 from the recovery port 20 is performed concurrently with the supply of the second cleaning liquid LC2 from the second supply port 22. Thereby, a liquid immersion space LT2 is formed by the second cleaning liquid LC2 between the last optical element 12 and the liquid immersion member 7 and the dummy substrate DP.

In the second cleaning process, the second cleaning liquid LC2 is sent out from the second cleaning liquid supply device 36B. Furthermore, the second cleaning liquid supply device 36B may be equipment of the factory FA. The second cleaning liquid LC2 supplied from the second cleaning liquid supply device 36B is supplied through the sixth channel 28R to the diluter 35.

In the present embodiment, the channel is adjusted by the channel switching mechanism 34 so that the exposure liquid LQ from the supply source LQS is supplied through the fourth channel 26R to the diluter 35. The diluter 35 dilutes the second cleaning liquid LC2 supplied from the second cleaning liquid supply device 36B by the exposure liquid LQ supplied from the fourth channel 26R.

As an example, in the present embodiment, the second cleaning liquid LC2 sent out from the second cleaning liquid supply device 36B is an aqueous solution of which the concentration of hydrogen peroxide is 30%. The diluter 35 dilutes the second cleaning liquid LC2 with the exposure liquid (water) LQ, and creates an aqueous solution of which the concentration of the hydrogen peroxide is 5%. The concentration of the hydrogen peroxide contained in the second cleaning liquid LC2 is adjusted to a predetermined concentration suitable for cleaning. The diluter 35 sends out the aqueous solution of which the concentration of the hydrogen peroxide is 5% to the fifth channel 27R as the second cleaning liquid LC2. Furthermore, the concentration of the hydrogen peroxide contained in the second cleaning liquid LC2 sent out to the fifth channel 27R may not be 5%, and may be, for example, 10% or more, 15% or more, or 20% or more.

Furthermore, the concentration of the hydrogen peroxide contained in the second cleaning liquid LC2 may be appropriately adjusted, for example, depending on the states of the inner surface of the fifth channel 27R (fifth channel forming member 27T), the inner surface of the second channel 24R (second channel forming member 24T), and the inner surface of the second interior channel 22R (liquid immersion member 7) through which the second cleaning liquid LC2 flows. For example, the concentration of the hydrogen peroxide may be adjusted depending on the resistance properties of the inner surfaces of these channels with respect to the hydrogen peroxide. In addition, the concentration of the hydrogen peroxide may be adjusted depending on the resistance properties of the surface of the dummy substrate DP with respect to the hydrogen peroxide. In addition, when the second cleaning liquid LC2 is supplied to the substrate stage 2, the concentration of the hydrogen peroxide may be adjusted depending on the resistance properties of the upper surface 2F of the substrate stage 2 with respect to the hydrogen peroxide. In addition, when the second cleaning liquid LC2 is supplied to the measurement stage 3, the concentration of the hydrogen peroxide may be adjusted depending on the resistance properties of the upper surface 3F of the measurement stage 3 with respect to the hydrogen peroxide.

Furthermore, a back-flow prevention device may be provided between the diluter 35 and the supply source LQS so that the second cleaning liquid LC2 is not sent out from the diluter 35 to the supply source LQS. For example, the fourth channel 26R may be provided with the back-flow prevention device.

Furthermore, as the liquid used in dilution of the second cleaning liquid LC2, liquid (pure water) supplied from a supply device different from the supply source LQS may be used. That is, as the liquid used in dilution of the second cleaning liquid LC2, liquid different from the exposure liquid LQ may be used. In addition, as the liquid used in dilution of the second cleaning liquid LC2, liquid other than water may be used.

Furthermore, the second cleaning liquid LC2 sent out from the second cleaning liquid supply device 36B may not be diluted. In addition, the diluter 35 may be omitted.

Furthermore, in the present embodiment, although the second cleaning liquid LC2 is diluted using the diluter 35, the diluted liquid is not limited thereto. For example, the diluter 35 may be provided between the first cleaning supply device36A and the channel switching mechanism 38, to thereby dilute the first cleaning liquid LC1 supplied from the first cleaning supply device36A with the exposure liquid LQ.

The second cleaning liquid LC2 from the diluter 35 is supplied to the second supply port 22 through the fifth channel 27R, the second channel 24R, and the second interior channel 22R. The second supply port 22 supplies the second cleaning liquid LC2 to the space SP1. The second cleaning liquid LC2 supplied to the space SP1 flows through the opening 7K into the space SP2. The second cleaning liquid LC2 is in contact with at least a portion of the surface of the liquid immersion member 7 including the lower surface 14. The surface of the liquid immersion member 7 is cleaned by the second cleaning liquid LC2.

The second cleaning liquid LC2 includes hydrogen peroxide, and can remove foreign substances which are not completely removed from the surface of the liquid immersion member 7 and the like by the first cleaning process. In addition, the second cleaning liquid LC2 can remove the first cleaning liquid LC1 remaining in the surface of the liquid immersion member 7 and the like. For example, the second cleaning liquid LC2 can remove the first cleaning liquid LC1 which is not completely removed from the surface of the liquid immersion member 7 by the first rinse process. Therefore, the second cleaning liquid LC2 is supplied so as to be in contact with the liquid immersion member 7, whereby the foreign substances attached to the liquid immersion member 7 and the first cleaning liquid LC1 are removed. Furthermore, the second cleaning liquid LC2 can remove the foreign substances which are not completely removed from the surface of the liquid immersion member 7 and the like by the first rinse process.

The recovery port 20 recovers the second cleaning liquid LC2 supplied from the second supply port 22 to at least a portion of the surface of the liquid immersion member 7. The recovery port 20 recovers the second cleaning liquid LC2 of the space SP2. The foreign substances and the like removed from the surface of the liquid immersion member 7 are recovered from the recovery port 20 together with the second cleaning liquid LC2.

The second cleaning liquid LC2 recovered from the recovery port 20 flows through the third interior channel 20R and the third channel 25R. In the present embodiment, the channel is adjusted by the channel switching mechanism 30 so that the second cleaning liquid LC2 recovered from the recovery port 20 is discharged from the third discharge port 33. Thereby, the second cleaning liquid LC2 which is supplied to the liquid immersion member 7 and is recovered from the recovery port 20 is discharged from the third discharge port 33. The second cleaning liquid LC2 discharged from the third discharge port 33 is supplied to the third receiving member 43.

In the present embodiment, the supply of the rinse liquid LH from the first supply port 21 is stopped in the second cleaning process. In that case, the rinse liquid LH may be filled into the first interior channel 21R. In the state where the rinse liquid LH is filled into the first interior channel 21R, the liquid immersion space LT2 is formed by the second cleaning liquid LC2, whereby it is possible to prevent the second cleaning liquid LC2 from infiltrating into the first interior channel 21R, the first channel 23R and the like. Furthermore, the second cleaning liquid LC2 may flow from the first supply port 21 to the first interior channel 21R and the like.

After the second cleaning liquid LC2 is supplied from the second supply port 22 for a predetermined time, the control apparatus 8 stops the supply of the second cleaning liquid LC2 from the second supply port 22. Thereby, the second cleaning process (step SA4) is terminated.

As mentioned above, in the present embodiment, after the supply of the first cleaning liquid LC1 is stopped in the first cleaning process and before the supply of the second cleaning liquid LC2 is started in the second cleaning process, the rinse liquid LH is supplied to the liquid immersion member 7 in the first rinse process and the supplied rinse liquid LH is recovered from the recovery port 20. Therefore, it is possible to reduce the concentration of the first cleaning liquid LC1 contained in the second cleaning liquid LC2 recovered from the recovery port 20 in the second cleaning process.

In addition, in the present embodiment, the first cleaning liquid LC1 recovered from the recovery port 20 in the first cleaning process is discharged from the second discharge port 32, and the second cleaning liquid LC2 recovered from the recovery port 20 in the second cleaning process is discharged from the third discharge port 33. The first rinse process is performed between the first cleaning process and the second cleaning process, whereby the discharge of the first cleaning liquid LC1 from the third discharge port 33 is suppressed in the second cleaning process. Since the first rinse process is performed so that the discharge of the first cleaning liquid LC1 from the third discharge port 33 is suppressed in the second cleaning process, it is possible to reduce the concentration of the first cleaning liquid LC1 contained in the second cleaning liquid LC2 discharged from, for example, the third discharge port 33.

When the concentration of the first cleaning liquid LC1 contained in the second cleaning liquid LC2 discharged from the third discharge port 33 is high, there is a possibility that time may be required for the process (waste liquid process) of the second cleaning liquid LC2, or the process thereof may become complicated. In the present embodiment, since the first rinse process is performed so that the concentration of the first cleaning liquid LC1 contained in the second cleaning liquid LC2 recovered from the recovery port 20 in the second cleaning process becomes a predetermined concentration or less which does not influence the waste liquid process, it is possible to smoothly perform the waste liquid process. That is, it is possible to relatively easily perform the discard process of the liquid received in the third receiving member 43.

Furthermore, as mentioned above, in the present embodiment, the first cleaning liquid LC1 sent out from the first cleaning liquid supply device 36A and the second cleaning liquid LC2 sent out from the second cleaning liquid supply device 36B are supplied to the liquid immersion member 7 through the supply channel of which at least a portion is the same. That is, as shown in FIGS. 9 and 11, in the present embodiment, each of the first cleaning liquid LC1 and the second cleaning liquid LC2 is supplied to the liquid immersion member 7 through at least the second channel 24R and the second interior channel 22R. In addition, the supply of each of the first cleaning liquid LC1 and the second cleaning liquid LC2 is performed through the second supply port 22.

After the supply of the second cleaning liquid LC2 from the second supply port 22 is stopped and the second cleaning process is terminated, the second rinse process is started (step SA5). In the present embodiment, after the entirety of the second cleaning liquid LC2 of the liquid immersion space LT2 is recovered, the second rinse process is started. In the state where the supply of the second cleaning liquid LC2 from the second supply port 22 is stopped, the control apparatus 8 performs the recovery of the second cleaning liquid LC2 from the recovery port 20 (the hole 19H of the porous member 19) for a predetermined time. Thereby, the entirety of the second cleaning liquid LC2 between the last optical element 12 and the liquid immersion member 7 and the dummy substrate DP is recovered.

Furthermore, in order to recover substantially the entirety of the second cleaning liquid LC2, the second cleaning liquid LC2 may be recovered from the second supply port 22 as well as from the recovery port 20. In addition, the recovery operation from the second supply port 22 may be performed instead of the recovery operation from the recovery port 20. In addition, the second cleaning liquid LC2 may be recovered from the first supply port 21.

Furthermore, when the supply of the second cleaning liquid LC2 is stopped and before the second rinse process is performed, the second cleaning liquid LC2 remaining in the second interior channel 22R may be removed. For example, after the supply of the second cleaning liquid LC2 is stopped, at least one of the second interior channel 22R and the second channel 24R may be depressurized, to thereby remove the second cleaning liquid LC2 remaining in at least one of the second interior channel 22R and the second channel 24R. For example, in order to depressurize the second interior channel 22R, the vacuum system (suction device) may be connected to at least one of the second interior channel 22R and the second channel 24R, to thereby suction (depressurize) the second interior channel 22R. Thereby, the second cleaning liquid LC2 remaining in the second interior channel 22R is suctioned into the vacuum system, and the second cleaning liquid LC2 is discharged from the second interior channel 22R. In addition, at least one of the second interior channel 22R and the second channel 24R may be pressurized, to thereby remove the second cleaning liquid LC2 remaining in at least one of the second interior channel 22R and the second channel 24R. For example, in order to pressurize the second interior channel 22R, the gas supply device is connected to at least one of the second interior channel 22R and the second channel 24R, and then gas may be supplied to the second interior channel 22R to thereby pressurize the second interior channel 22R. Thereby, the second cleaning liquid LC2 remaining in the second interior channel 22R is discharged from the second supply port 22, and the second cleaning liquid LC2 is discharged from the second interior channel 22R. In addition, for example, the second interior channel 22R and the supply source LQS are connected to each other in a predetermined channel, and then the exposure liquid LQ sent out from the supply source LQS may be supplied to the second interior channel 22R, to thereby discharge the second cleaning liquid LC2 from the second interior channel 22R. Furthermore, the second cleaning liquid LC2 may be removed (discharged) from at least one of the fifth channel 27R and the second channel 24R. For example, the exposure liquid LQ sent out from the supply source LQS may be supplied to at least one of the fifth channel 27R and the second channel 24R.

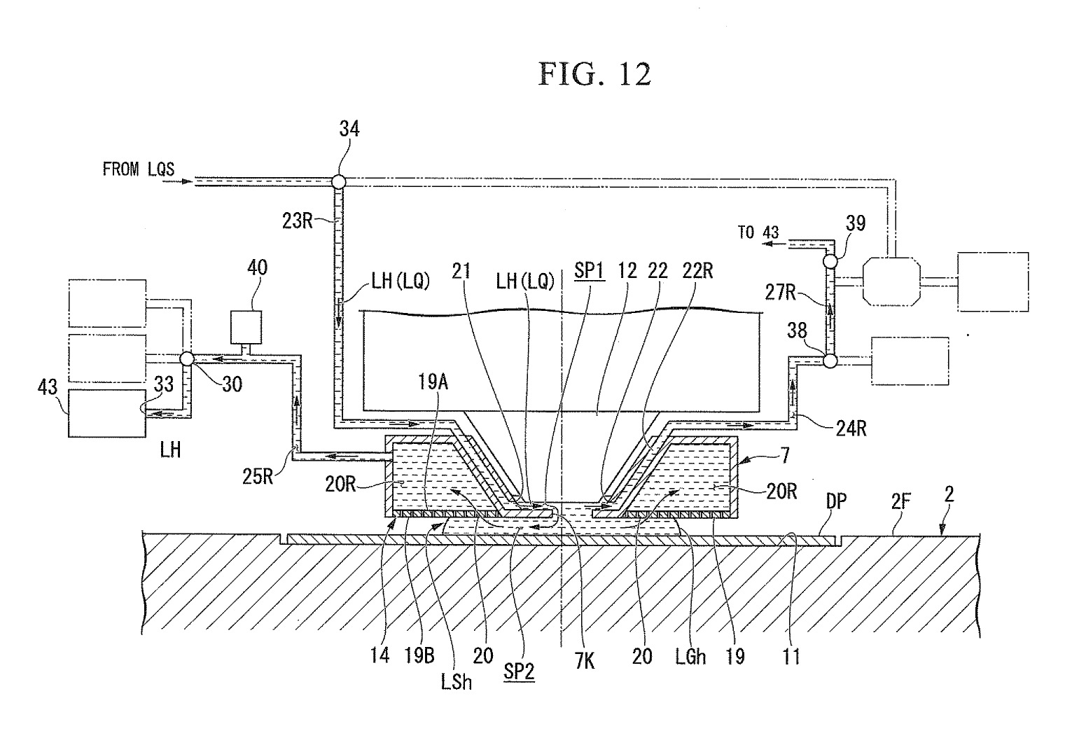

FIG. 12 is a diagram illustrating an example of a state in which the second rinse process is performed. Even in the second rinse process, the dummy substrate DP is disposed facing the liquid immersion member 7.

The control apparatus 8 starts the supply of the rinse liquid LH in order to rinse the liquid immersion member 7 with the rinse liquid LH. Furthermore, in the state where the liquid immersion space LT2 of the second cleaning liquid LC2 is formed, the supply of the rinse liquid LH may be started.

The control apparatus 8 starts the supply of the rinse liquid LH from the first supply port 21. In the state where the supply of the cleaning liquid LC from the second supply port 22 is stopped, the control apparatus 8 supplies the rinse liquid LH from the first supply port 21 to the space SP1. As mentioned above, in the present embodiment, the exposure liquid LQ is used as the rinse liquid LH.

In the second rinse process, the recovery of the liquid (including at least one of the second cleaning liquid LC2 and the rinse liquid LH) from the recovery port 20 is performed concurrently with the supply of the rinse liquid LH (exposure liquid LQ) from the first supply port 21. Thereby, the liquid immersion space LSh is formed by the rinse liquid LH between the last optical element 12 and the liquid immersion member 7 and the dummy substrate DP.

As shown in FIG. 12, in the rinse process, the rinse liquid LH (exposure liquid LQ) is sent out from the supply source LQS. The rinse liquid LH supplied from the supply source LQS is supplied to the first supply port 21 through the first channel 23R and the first interior channel 21R. The first supply port 21 supplies the rinse liquid LH to the space SP1. The rinse liquid LH supplied to the space SP1 flows through the opening 7K into the space SP2. The rinse liquid LH is in contact with at least a portion of the surface of the liquid immersion member 7 including the lower surface 14. The surface of the liquid immersion member 7 is rinsed by the rinse liquid LH.

The rinse liquid LH can remove the second cleaning liquid LC2 remaining in the surface of the liquid immersion member 7. The rinse liquid LH supplied from the first supply port 21 is in contact with the liquid immersion member 7, whereby it is possible to remove the second cleaning liquid LC2 remaining in the liquid immersion member 7. In the present embodiment, the rinse liquid LH is pure water and the second cleaning liquid LC2 is a hydrogen peroxide solution. Therefore, the rinse liquid LH can remove the second cleaning liquid LC2 remaining in the liquid immersion member 7.

The recovery port 20 recovers the rinse liquid LH supplied from the first supply port 21 to at least a portion of the surface of the liquid immersion member 7. The recovery port 20 recovers the rinse liquid LH of the space SP2. The second cleaning liquid LC2 removed from the surface of the liquid immersion member 7 is recovered from the recovery port 20 together with the rinse liquid LH.

In the present embodiment, the recovery of the liquid from the second supply port 22 is also performed in the second rinse process. The second supply port 22 can be connected to the vacuum system, and can function as a recovery port of the liquid. That is, in the present embodiment, the recovery of the liquid from the recovery port 20 and the second supply port 22 is performed concurrently with the supply of the rinse liquid LH from the first supply port 21. The second cleaning liquid LC2 remaining in the second interior channel 22R, second channel 24R and the like is removed by recovering the liquid from the second supply port 22. The second interior channel 22R, the second channel 24R and the like are rinsed with the rinse liquid LH.

The rinse liquid LH recovered from the recovery port 20 flows through the third interior channel 20R and the third channel 25R. The rinse liquid LH recovered from the second supply port 22 flows through the second interior channel 22R and the second channel 24R.

In the present embodiment, the channel is adjusted by the channel switching mechanism 30 so that the rinse liquid LH recovered from the recovery port 20 is discharged from the third discharge port 33. Thereby, the rinse liquid LH which is supplied to the liquid immersion member 7 and is recovered from the recovery port 20 is discharged from the third discharge port 33. The rinse liquid LH discharged from the third discharge port 33 is supplied to the third receiving member 43.

In this manner, in the present embodiment, during the supply and the recovery of the rinse liquid LH, the rinse liquid LH recovered from the recovery port 20 is discharged from the third discharge port 33.

In addition, the rinse liquid LH recovered from the second supply port 22 is sent through the second interior channel 22R, the second channel 24R, and the fifth channel 27R to the channel switching mechanism 39. The channel is adjusted by the channel switching mechanism 39 so that the rinse liquid LH recovered from the second supply port 22 is sent to the third receiving member 43.

The control apparatus 8 performs the supply of the rinse liquid LH from the first supply port 21 and the recovery of the rinse liquid LH from the recovery port 20 and the second supply port 22 for a predetermined period of time.

Furthermore, in the second rinse process, the rinse liquid LH may be supplied from the first and second supply ports 21 and 22, and the supplied rinse liquid LH may be recovered from the recovery port 20.

Furthermore, in the second rinse process, after the supply of the rinse liquid LH from the first supply port 21 is performed and the recovery thereof from the recovery port 20 and the second supply port 22 is performed, the recovery thereof from the second supply port 22 is stopped, and then the supply of the rinse liquid LH from the first supply port 21 may be performed, and the recovery thereof from the recovery port 20 may be performed. Furthermore, in the second rinse process, the recovery thereof from the second supply port 22 may not be performed.

In the present embodiment, the concurrent operation of the supply of the rinse liquid LH from the first supply port 21 and the recovery of the rinse liquid LH from the recovery port 20 is performed so that the concentration of the second cleaning liquid LC2 contained in the rinse liquid LH recovered from the recovery port 20 becomes a previously determined predetermined concentration or less.

In the present embodiment, in the second rinse process, the characteristics of the rinse liquid LH recovered from the recovery port 20 are detected by the detection apparatus 40. In the present embodiment, the detection apparatus 40 detects the conductivity of the rinse liquid LH which is recovered from the recovery port 20 and flows through the third channel 25R. The detection result of the detection apparatus 40 is output to the control apparatus 8. In the present embodiment, the control apparatus 8 seeks the concentration of the second cleaning liquid LC2 contained in the rinse liquid LH recovered from the recovery port 20 and further the concentration of the hydrogen peroxide contained in the rinse liquid LH, on the basis of the detection result of the detection apparatus 40. Until the concentration of the second cleaning liquid LC2 contained in the rinse liquid LH recovered from at least the recovery port 20 becomes a predetermined concentration or less, the control apparatus 8 performs the concurrent operation of the supply of the rinse liquid LH from the first supply port 21 and the recovery of the rinse liquid LH from the recovery port 20 for a predetermined period of time. In the present embodiment, at least until the concentration of the hydrogen peroxide contained in the recovered rinse liquid LH becomes a previously determined acceptable value or less, the second rinse process (the supply and the recovery of the rinse liquid LH) is continued. For example, until the concentration of the hydrogen peroxide contained in the rinse liquid LH recovered from the recovery port 20 becomes 1% or less, the second rinse process is continued. During the recovery of the rinse liquid LH from the recovery port 20, the recovered rinse liquid LH is discharged from the third discharge port 33.

As mentioned above, in the present embodiment, the second rinse process includes a process of discharging the rinse liquid LH, recovered from the recovery port 20, from the third discharge port 33. In the present embodiment, after the second rinse process, the third rinse process is performed (step SA6).

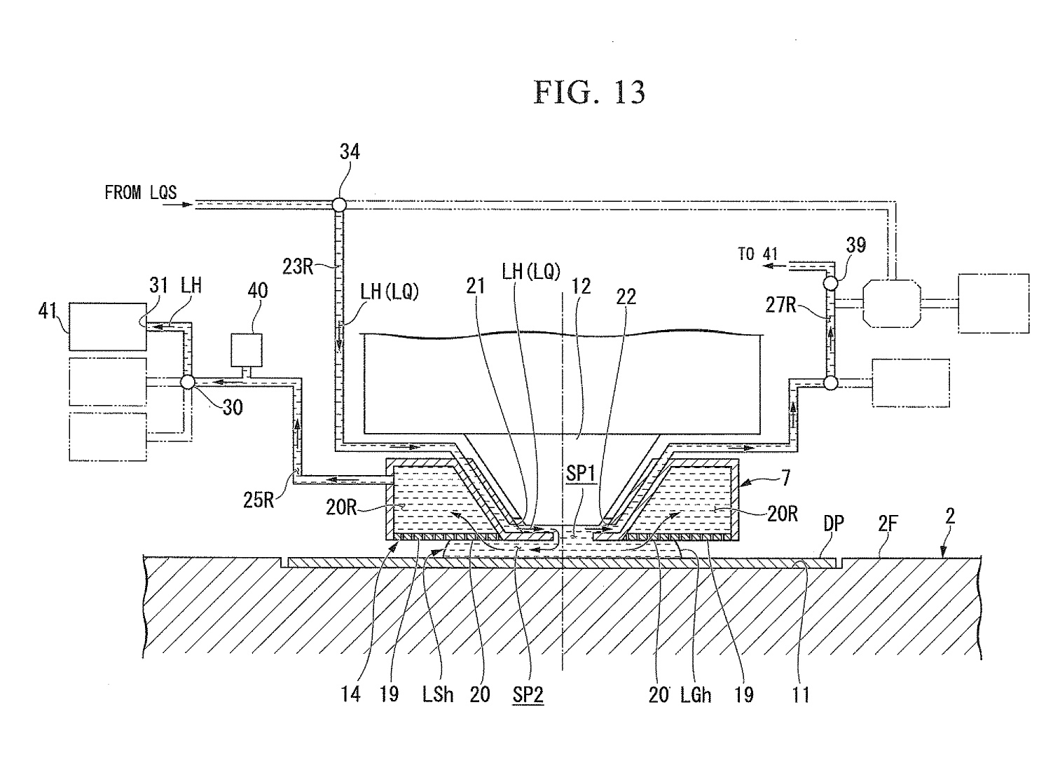

FIG. 13 is a diagram illustrating an example of a state in which the third rinse process is performed. As shown in FIG. 13, in the present embodiment, the third rinse process includes a process of discharging the rinse liquid LH, recovered from the recovery port 20, from the first discharge port 31.

In the present embodiment, the second rinse process including the operation of supplying the rinse liquid LH from the first supply port 21, the operation of recovering the rinse liquid LH from the recovery port 20, and the operation of discharging the recovered rinse liquid LH from the third discharge port 33 is performed at least until the concentration of the second cleaning liquid LC2 contained in the rinse liquid LH reaches a predetermined concentration. That is, until the concentration of the second cleaning liquid LC2 contained in the recovered rinse liquid LH reaches a predetermined concentration, the process of discharging the rinse liquid LH from the third discharge port 33 is performed on the recovered rinse liquid LH. The rinse liquid LH discharged from the third discharge port 33 is received in the third receiving member 43. In the present embodiment, the rinse liquid LH recovered from the recovery port 20 is received in the third receiving member 43 until the concentration of the second cleaning liquid LC2 contained in the rinse liquid LH becomes a predetermined concentration or less.

After the concentration of the second cleaning liquid LC2 contained in the recovered rinse liquid LH becomes a predetermined concentration or less, the control apparatus 8 controls the channel switching mechanism 30 while performing the concurrent operation of the supply of the rinse liquid LH from the first supply port 21 and the recovery of the rinse liquid LH from the recovery port 20, and adjusts the channel so that the rinse liquid LH recovered from the recovery port 20 is discharged from the first discharge port 31. That is, the control apparatus 8 seeks the concentration of the second cleaning liquid LC2 contained in the recovered rinse liquid LH from the detection result of the detection apparatus 40, and controls the channel switching mechanism 30 on the basis of the concentration thereof, to thereby perform switching from the discharge operation of the third discharge port 33 to the discharge operation of the first discharge port 31.

In the present embodiment, the control apparatus 8 discharges the recovered rinse liquid LH from the third discharge port 33 until the concentration of the second cleaning liquid LC2 contained in the recovered rinse liquid LH reaches a predetermined concentration, and discharges the recovered rinse liquid LH from the first discharge port 31 after the concentration of the second cleaning liquid LC2 becomes a predetermined concentration or less.

Even after the concentration of the second cleaning liquid LC2 contained in the recovered rinse liquid LH becomes a predetermined concentration or less, the control apparatus 8 performs the concurrent operation of the supply of the rinse liquid LH from the first supply port 21 and the recovery of the rinse liquid LH from the recovery port 20 (second supply port 22). After the concentration of the second cleaning liquid LC2 contained in the recovered rinse liquid LH becomes a predetermined concentration, the process of discharging the rinse liquid LH from the first discharge port 31 is performed on the recovered rinse liquid LH.

In this manner, in the present embodiment, the second rinse process and the third rinse process are continuously performed. In the second rinse process, the rinse liquid LH is discharged from the third discharge port 33 during the recovery of the rinse liquid LH from the recovery port 20, and the channel switching mechanism 30 is controlled during the recovery thereof. Subsequent to the discharge thereof from the third discharge port 33, in the third rinse process, the rinse liquid LH is discharged from the first discharge port 31. The concentration of the second cleaning liquid LC2 contained in the rinse liquid LH discharged from the first discharge port 31 is a predetermined concentration or less. Furthermore, after at least one of the supply of the rinse liquid LH from the first supply port 21 and the recovery of the rinse liquid LH from the recovery port 20 is stopped and then switching from the discharge thereof from the third discharge port 33 to the discharge thereof from the first discharge port 31 is performed by the channel switching mechanism 30, the concurrent operation of the supply of the rinse liquid LH from the first supply port 21 and the recovery of the rinse liquid LH from the recovery port 20 may be resumed as the third rinse process.

During the recovery of the rinse liquid LH, the concentration of the hydrogen peroxide contained in the rinse liquid LH discharged from the first discharge port 31 is lower than the concentration of the hydrogen peroxide contained in the rinse liquid LH discharged from the third discharge port 33. In addition, the concentration of the hydrogen peroxide contained in the rinse liquid LH discharged from the first discharge port 31 is lower than the concentration of the hydrogen peroxide contained in the second cleaning liquid LC2 supplied from the second supply port 22 to the liquid immersion member 7.

In the present embodiment, the rinse liquid LH recovered from the recovery port 20 in the first period of time in which the second rinse process after the second cleaning process is performed is discharged from the third discharge port 33, and the rinse liquid LH recovered from the recovery port 20 in the second period of time in which the third rinse process after the second rinse process is performed is discharged from the first discharge port 31. The hydrogen peroxide contained in the recovered rinse liquid LH has a lower concentration at the time of the recovery thereof in the third rinse process (second period of time) than that at the time of the recovery thereof in the second rinse process (first period of time). Thereby, the discharge of the second cleaning liquid LC2 from the first discharge port 31 is suppressed in the third rinse process. Since the second rinse process is performed so that the discharge of the second cleaning liquid LC2 from the first discharge port 31 is suppressed in the third rinse process, it is possible to reduce the concentration of the second cleaning liquid LC2 (hydrogen peroxide) contained in the rinse liquid LH discharged from, for example, the first discharge port 31. In addition, it is possible to reduce the concentration of the second cleaning liquid LC2 contained in the rinse liquid LH (exposure liquid LQ) of, for example, the first receiving member 41.

When the concentration of the second cleaning liquid LC2 contained in the rinse liquid LH discharged from the first discharge port 31 is high, there is a possibility that time may be required for the process (waste liquid process) of the rinse liquid LH, or the process thereof may become complicated. In the present embodiment, since the second rinse process is performed so that the concentration of the second cleaning liquid LC2 contained in the rinse liquid LH recovered from the recovery port 20 in the third rinse process becomes a predetermined concentration or less which does not influence the waste liquid process, it is possible to smoothly perform the waste liquid process.

In the present embodiment, a first process is performed on the rinse liquid LH discharged from the third discharge port 33 in the second rinse process, and a second process different from the first process is performed on the rinse liquid LH discharged from the first discharge port 31 in the third rinse process. As mentioned above, the concentration of the hydrogen peroxide contained in the rinse liquid LH discharged from the third discharge port 33 is high, and the concentration of the hydrogen peroxide contained in the rinse liquid LH discharged from the first discharge port 31 is low.

In the present embodiment, the process (first process) for the rinse liquid LH discharged from the third discharge port 33 in the second rinse process is the same as the process for the second cleaning liquid LC2 discharged from the third discharge port 33 in the second cleaning process.

In the present embodiment, the second cleaning liquid LC2 discharged from the third discharge port 33 in the second cleaning process is discarded, and the rinse liquid LH discharged from the third discharge port 33 is also discarded. That is, in the present embodiment, the first process includes a process of discarding the rinse liquid LH discharged from the third discharge port 33.

On the other hand, the rinse liquid LH discharged from the first discharge port 31 in the third rinse process may be reused without being discarded. That is, the second process includes a reusing process. For example, the rinse liquid LH discharged from the first discharge port 31 in the third rinse process may be reused as the exposure liquid LQ, and may be used in order to adjust the temperature of the drive systems 4 and 5.

Furthermore, the second process may be a process of discarding the rinse liquid LH discharged from the first discharge port 31. When each of the first and second processes is a process of discarding the discharged rinse liquid LH, the processes until the discharged rinse liquid LH is discarded in the first process and the second process may be different from each other. For example, the number of second processes may be smaller than the number of first processes.

For example, after the rinse liquid LH having a low concentration of the hydrogen peroxide is discharged from the first discharge port 31, it may be discarded as it is. On the other hand, after the rinse liquid LH having a high concentration of the hydrogen peroxide is discharged from the third discharge port 33, there is a possibility that it cannot be discarded as it is. Similarly, there is a possibility that the second cleaning liquid LC2 discharged from the third discharge port 33 in the second cleaning process cannot also be discarded as it is. There is a possibility that at the time of the discarding, for example, a process of diluting the rinse liquid LH having a high concentration of the hydrogen peroxide with predetermined liquid (for example, water), a process of reducing the concentration of the hydrogen peroxide using a catalyst, and the like may be required. Similarly, there is a possibility that even in the discarding of the second cleaning liquid LC2, the predetermined number of processes may be required. In addition, even when the process for the rinse liquid LH discharged from the first discharge port 31 at the time of the discarding is required, there is a high possibility that the process for the rinse liquid LH discharged from the first discharge port 31 may have a number of steps smaller than that of the process for the rinse liquid LH discharged from the third discharge port 33.

In addition, in the present embodiment, the rinse liquid LH discharged from the first discharge port 31 is received in the first receiving member 41, and the rinse liquid LH discharged from the third discharge port 33 is received in the third receiving member 43. In the present embodiment, the rinse liquid LH discharged from the third discharge port 33 in the third rinse process and the second cleaning liquid LC2 discharged from the third discharge port 33 in the second cleaning process are received in the third receiving member 43. The exposure liquid LQ discharged from the first discharge port 31 in the exposure process and the rinse liquid LH discharged from the first discharge port 31 in the third rinse process are received in the first receiving member 41. In the present embodiment, the concentration of the hydrogen peroxide contained in the liquid received in the first receiving member 41 is low. Therefore, at the time of the discard, the process for the liquid received in the first receiving member 41 is simplified.

In the present embodiment, since the discharge ports that discharge the recovered rinse liquid LH are separated from each other in the second rinse process and the third rinse process, it is possible to sufficiently reduce the concentration of the second cleaning liquid LC2 contained in the rinse liquid LH discharged from the first discharge port 31 in the third rinse process. Therefore, it is possible to smoothly perform the process of the rinse liquid LH.

Furthermore, in the present embodiment, the first period of time in which the second rinse process is performed may be made shorter than the second period of time in which the third rinse process is performed. Even when the first period of time is made shorter, it is possible to sufficiently remove the second cleaning liquid LC2 remaining in the liquid immersion member 7 in the second cleaning process. In addition, the second period of time is made longer, whereby it is possible to increase, for example, the amount of the rinse liquid LH which is discharged from the first discharge port 31 and is received in the first receiving member 41. Thereby, the concentration of the hydrogen peroxide contained in the liquid received in the first receiving member 41 is reduced.

After the third rinse process is terminated, the control apparatus 8 performs a process of unloading the dummy substrate DP from the substrate stage 2 (step SA7). The control apparatus 8 moves the substrate stage 2 to the substrate replacement position in order to unload the dummy substrate DP from the substrate stage 2 (substrate holding portion 11).

After the dummy substrate DP is unloaded from the substrate stage 2, the control apparatus 8 may perform the exposure sequence including the exposure process of the substrate P.

Furthermore, as mentioned above, in the first cleaning process (SA2), the liquid immersion space LT1 is formed by the first cleaning liquid LC1. Thereby, it is possible to satisfactorily bring the first cleaning liquid LC1 into contact with the surface of the liquid immersion member 7 which is in contact with the exposure liquid LQ of the liquid immersion space LS in the exposure of the substrate P. Similarly, in the second cleaning process (SA4), when the liquid immersion space LT2 is formed by the second cleaning liquid LC2, it is possible to bring the second cleaning liquid LC2 into contact with the surface of the liquid immersion member 7. In addition, in the rinse processes (SA3, SA5, and SA6), since the liquid immersion space LSh is formed by the rinse liquid LH, it is possible to bring the rinse liquid LH into contact with the surface of the liquid immersion member 7.

In addition, in the first cleaning process (SA2), since the first cleaning liquid LC1 is supplied from the second supply port 22 to the surface of the liquid immersion member 7 and the first cleaning liquid LC1 is recovered from the recovery port 20, it is possible to continue to bring the first cleaning liquid LC1, which is clean, supplied from the second supply port 22 into contact with the surface of the liquid immersion member 7. Similarly, it is possible to continue to bring the second cleaning liquid LC2, which is clean, supplied from the second supply port 22 into contact with the surface of the liquid immersion member 7 in the second cleaning process (SA4), and to continue to bring the rinse liquid LH, which is clean, supplied from the first supply port 21 into contact with to the surface of the liquid immersion member 7 in the rinse processes (SA3, SA5, and SA6).

Furthermore, in the above-mentioned steps SA2 to SA6, the supply and the recovery of the liquid (at least one of the first cleaning liquid LC1, the second cleaning liquid LC2, and the rinse liquid LH) are performed during the same time, the foreign substances and the like removed from the surface of the liquid immersion member 7 are prevented from being attached to the surface of the dummy substrate DP.

In addition, the cleaning liquids LC (LC1 and LC2) is recovered from the recovery port 20 (hole 19H), whereby it is possible to bring the cleaning liquids LC into contact with not only the lower surface 19B but also the inner surface of the hole 19H and the upper surface 19A, and to satisfactorily clean the lower surface 19B, the inner surface of the hole 19H, and upper surface 19A with the cleaning liquids LC. In addition, the rinse liquid LH is recovered from the recovery port 20 (hole 19H), whereby it is possible to bring the rinse liquid LH into contact with not only the lower surface 19B but also the inner surface of the hole 19H and the upper surface 19A, and to satisfactorily rinse the lower surface 19B, the inner surface of the hole 19H, and the upper surface 19A with the rinse liquid LH.

Furthermore, in at least a portion of the above-mentioned steps SA2 to SA6, in the state where the liquid immersion spaces (LT1, LT2, and LSh) are formed between the last optical element 12 and the liquid immersion member 7 and the dummy substrate DP, the control apparatus 8 may control the substrate stage 2 to move the dummy substrate DP within the XY plane. Thereby, the interfaces (LG1, LG2, and LGh) of the liquid of the liquid immersion spaces are moved, whereby it is possible to bring the liquids (LC1, LC2, and LH) into contact with the wide region of the lower surface 14 of the liquid immersion member 7. In addition, since the interface of the liquid moves with respect to the lower surface 14, it is possible to enhance the cleaning effect or the rinse effect. In addition, since a flow is generated in the liquid in the liquid immersion space by moving the dummy substrate DP, it is possible to enhance the cleaning effect or the rinse effect. Furthermore, the dummy substrate DP may not be moved.

Furthermore, in the present embodiment, the movement range of the dummy substrate DP (substrate stage 2) with respect to the liquid immersion member 7 may be controlled so that the liquid immersion spaces (LT1, LT2, and LSh) do not come out to the outside of the dummy substrate DP, in other words, the liquid immersion spaces are formed only on the dummy substrate DP, and the liquids (LC1, LC2, and LH) of the liquid immersion spaces are not in contact with the upper surface 2F of the outside of the dummy substrate DP.

Furthermore, the liquid immersion spaces (LT1, LT2, and LSh) may come out to the outside of the dummy substrate DP. For example, the liquids (LC1, LC2, and LH) may be brought into contact with the upper surface 2F. In addition, the liquids may be brought into contact with the measurement stage 3, and the liquids may be brought into contact with an object other than the dummy substrate DP, the substrate stage 2, and the measurement stage 3.

In at least a portion of the above-mentioned steps SA2 to SA6, when the dummy substrate DP is moved, the ranges (movement paths of the substrate stage 2), in which the dummy substrate DP is moved, with respect to the liquid immersion member 7 may be made different from each other for each of the above-mentioned steps SA2 to SA6. In addition, in at least one step of the above-mentioned steps SA2 to SA6, the ranges (movement paths of the substrate stage 2), in which the dummy substrate DP is moved, with respect to the liquid immersion member 7 may be made different from each other. For example, in step 6, a period of time in which the liquid immersion space is formed only on the dummy substrate DP and a period of time in which the liquid immersion space is formed to extend over the surface of the dummy substrate DP and the upper surface 2F may be provided. In this case, after the period of time in which the liquid immersion space is formed only on the dummy substrate DP, the period of time in which the liquid immersion space is formed to extend over the surface of the dummy substrate DP and the upper surface 2F may be provided.

Furthermore, in the present embodiment, the cleaning sequence is performed using the dummy substrate DP, but in at least a portion of the above-mentioned steps SA2 to SA6, the dummy substrate DP may not be used. For example, at least one step of the above-mentioned steps SA2 to SA6 may be performed in the state where the liquid immersion space is formed between the last optical element 12 and the liquid immersion member 7 and the measurement stage 3.

As described above, according to the present embodiment, since the concentration of the second cleaning liquid LC2 contained in the recovered rinse liquid LH is reduced to a predetermined concentration or less, it is possible to smoothly perform the process of the rinse liquid LH. Therefore, it is possible to suppress, for example, a decrease in the operation rate of the device manufacturing system SYS including the exposure apparatus EX, an increase in the process costs and the like.

Furthermore, in the present embodiment, as an example of a process in which the concentration of the second cleaning liquid LC2 contained in the recovered rinse liquid LH is set to a predetermined concentration or less, the concurrent operation of the supply and the recovery of the rinse liquid LH is performed. However, for example, after the second cleaning process is terminated (after the supply of the second cleaning liquid LC2 is stopped) and before the second rinse process is started (before the supply of the rinse liquid LH is started), a process may be performed in which the stop period where the supply of the rinse liquid LH to the liquid immersion member 7 is stopped is set. For example, the supply of the second cleaning liquid LC2 is stopped, and the second cleaning liquid LC2 is recovered, to thereby perform a process of eliminating the liquid immersion space LT2. The stop period is set to be longer than the time taken until the second cleaning liquid LC2 starts to evaporate. Thereby, for example, the second cleaning liquid LC2 remaining in the liquid immersion member 7 evaporates, and is removed from the liquid immersion member 7.

The supply of the rinse liquid LH for performing the second rinse process is started after the stop period. At least a portion of the second cleaning liquid LC2 remaining in the liquid immersion member 7 is evaporated and is removed from the liquid immersion member 7, the concentration of the second cleaning liquid LC2 in the rinse liquid LH recovered from the recovery port 20 immediately after the start of the supply of the rinse liquid LH is reduced.

Furthermore, the stop period may continue until the concentration of the second cleaning liquid LC2 in the rinse liquid LH recovered from the recovery port 20 immediately after the start of the supply of the rinse liquid LH becomes a predetermined concentration or less. Thereby, the concentration of the second cleaning liquid LC2 contained in the rinse liquid LH which is recovered from the recovery port 20 in the second rinse process and is discharged from the third discharge port 33 becomes a predetermined concentration or less. The rinse liquid LH discharged from the third discharge port 33 is, for example, reused, or is discarded as it is. In this case, the third rinse process may or may not be omitted.

Furthermore, the stop period may be shorter than the time taken until the second cleaning liquid LC2 starts to evaporate. The supply of the second cleaning liquid LC2 is stopped, and the second cleaning liquid LC2 is recovered, to perform a process of eliminating the liquid immersion space LT2, thereby it is possible to reduce the concentration of the second cleaning liquid LC2 contained in the rinse liquid LH which is supplied after the stop period and is recovered.

Furthermore, in the present embodiment, the first cleaning liquid LC1, the second cleaning liquid LC2, and the rinse liquid LH are supplied in the state where the dummy substrate DP is disposed facing the liquid immersion member 7. However, for example, at least one of the first cleaning liquid LC1, the second cleaning liquid LC2, and the rinse liquid LH may be supplied in the state where the substrate stage 2 is disposed facing the liquid immersion member 7, may be supplied in the state where the measurement stage 3 is disposed, and may be supplied in the state where an object other than the dummy substrate DP, the substrate stage 2, and the measurement stage 3 is disposed.

Furthermore, as a process in which the concentration of the second cleaning liquid LC2 contained in the recovered rinse liquid LH is set to a predetermined concentration or less, for example, a process in which a catalyst capable of reducing hydrogen peroxide is added to the rinse liquid LH may be performed. For example, a catalyst may be added to the rinse liquid LH concurrently with the supply and the recovery of the rinse liquid LH. The catalyst may be added to the rinse liquid LH recovered from the recovery port 20, and may be added to the rinse liquid LH supplied from the first supply port 21. In this case, the third rinse process may or may not be omitted.

In addition, for example, a process in which a catalyst is added may be performed on the recovered rinse liquid LH until the concentration of the second cleaning liquid LC2 reaches a predetermined concentration, and a process in which a catalyst is not added may be performed thereon after the concentration of the second cleaning liquid LC2 becomes a predetermined concentration or less by the above-mentioned process. In addition, a process of discharging the recovered rinse liquid LH from the third discharge port 33 may be performed in the period of time in which a catalyst is added, and a process of discharging the recovered rinse liquid LH from the first discharge port 31 may be performed in the period of time a catalyst is not added. These processes may be performed concurrently with the supply and the recovery of the rinse liquid LH.

Furthermore, in the present embodiment, the rinse liquid LH recovered from the recovery port 20 in the first period of time in which the second rinse process is performed is discharged from the third discharge port 33, the rinse liquid LH recovered from the recovery port 20 in the second period of time in which the third rinse process is performed is discharged from the first discharge port 31, the first process is performed on the rinse liquid LH discharged from the third discharge port 33, and the second process is performed on the rinse liquid LH discharged from the first discharge port 31. Furthermore, for example, the first process may be performed on the rinse liquid LH which is recovered from the recovery port 20 in a predetermined period of time (hereinafter, referred to as the third period of time) in the second rinse process and is discharged from the third discharge port 33, and the second process may be performed on the rinse liquid LH which is recovered from the recovery port 20 in a fourth period of time after the third period of time and is discharged from the third discharge port 33. In that case, the concentration of the hydrogen peroxide contained in the rinse liquid LH recovered in the fourth period of time is lower than the concentration of the hydrogen peroxide contained in the rinse liquid LH recovered in the third period of time.

Furthermore, after the first cleaning process, during the recovery of the rinse liquid LH in the first rinse process, the rinse liquid LH recovered from the recovery port 20 is discharged from, for example, the second discharge port 32, and the rinse liquid LH may be discharged from the discharge port (for example, first discharge port 31) different from the second discharge port 32, subsequently to the discharge thereof from the second discharge port 32. In addition, for example, a third process may be performed on the rinse liquid LH which is recovered from the recovery port 20 in a predetermined period of time (hereinafter, referred to as the fifth period of time) in the first rinse process and is discharged from the second discharge port 32, and a fourth process different from the third process may be performed on the rinse liquid LH which is recovered from the recovery port 20 in a sixth period of time after the fifth period of time and is discharged from the second discharge port 32. In that case, the concentration of the hydrogen peroxide contained in the rinse liquid LH recovered in the sixth period of time is lower than the concentration of the hydrogen peroxide contained in the rinse liquid LH recovered in the fifth period of time. Furthermore, the same process as the above-mentioned first process may be performed as the third process, and the same process as the above-mentioned second process may be performed as the fourth process.

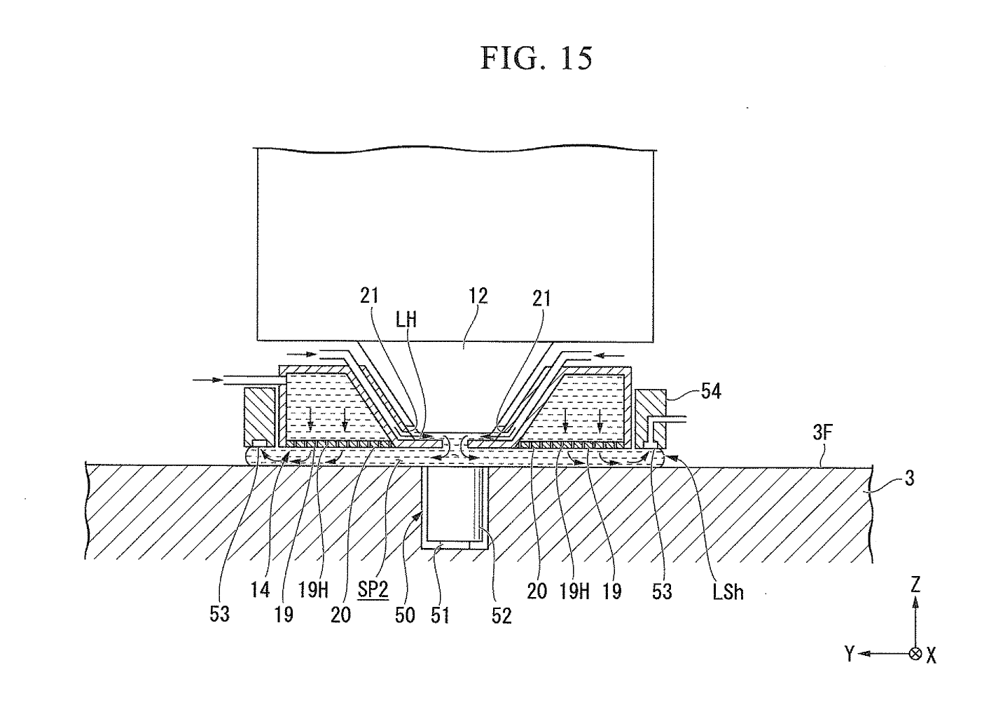

Furthermore, in at least the first period of time of the above-mentioned first period of time and second period of time, vibration may be given to the rinse liquid LH supplied to the liquid immersion member 7. FIG. 15 is a diagram illustrating an example of a state in which vibration is given to the rinse liquid LH. In the present embodiment, the measurement stage 3 includes an ultrasonic generator 50 capable of generating an ultrasonic vibration. The ultrasonic generator 50 includes a driving device 51 and a vibratory member 52 connected to the driving device 51.

In the present embodiment, the vibratory member 52 is a rod-shaped member mounted in the measurement stage 3. The vibratory member 52 is formed, for example, of quartz. The driving device 51 includes a piezoelectric element such as a crystal vibrator or PZT (lead zirconate titanate), and a circuit that drives the piezoelectric element. The measurement stage 3 has a concave portion on the upper surface 3F, and the vibratory member 52 is disposed in the concave portion. The upper surface 3F of the measurement stage 3 is disposed in the periphery of the upper end of the concave portion. The upper surface 3F of the measurement stage 3 and the upper surface of the vibratory member 52 are disposed in substantially the same plane (coplanar). A predetermined gap is formed between the upper surface of the vibratory member 52 and the upper surface 3F of the measurement stage 3.

The driving device 51 is connected to the vibratory member 52. In the present embodiment, the driving device 51 is connected to the lower surface of the vibratory member 52 in the inside of the concave portion. The driving device 51 ultrasonically vibrates the vibratory member 52. The driving device 51 is controlled by the control apparatus 8. The control apparatus 8 ultrasonically vibrates the vibratory member 52 using the driving device 51.

In the state where the liquid immersion space LSh is formed by the rinse liquid LH between the lower surface 14 of the liquid immersion member 7, and the upper surface of the vibratory member 52 and the upper surface 3F of the measurement stage 3, the control apparatus 8 vibrates (ultrasonically vibrates) the vibratory member 52 which is in contact with the rinse liquid LH using the driving device 51, thereby allowing the vibration (ultrasonic vibration) to be given to the rinse liquid LH. Thereby, the rinse effect can be enhanced.

Furthermore, in the example shown in FIG. 15, a suction port 53 capable of suctioning fluids is disposed at the outside of the recovery port 20 in the radiation direction with respect to the light path K. The suction port 53 is provided in a suction member 54 disposed at least at a portion of the periphery of the liquid immersion member 7. For example, at the time of the exposure of the substrate P, the suction port 53 can suction gas at the outside of the interface LGq. In addition, when the exposure liquid LQ flows out to the outside of the recovery port 20, or even when a portion of the exposure liquid LQ of the liquid immersion space LS is separated and comes out to the outside of the liquid immersion space LS, the suction port 53 can suction the exposure liquid LQ. Thereby, at the time of exposure of the substrate P, it is possible to prevent the exposure liquid LQ from coming out to the outside of the suction port 53. Furthermore, the suction port 53 may be provided in the liquid immersion member 7.

As shown in FIG. 15, in the cleaning sequence, the suction port 53 can recover the liquid (at least one of the first cleaning liquid LC1, the second cleaning liquid LC2, and the rinse liquid LH). In the example shown in FIG. 15, the rinse liquid LH is supplied from the first supply port 21 to the space SP2, and the rinse liquid LH is supplied even from the recovery port 20 (hole 19H of the porous member 19) thereto. In FIG. 15, the size of the liquid immersion space LSh in the rinse process is larger than the size of the liquid immersion space LS in the exposure process. Additionally, the size of the liquid immersion space means a size in the XY plane which is substantially parallel to the lower surface 14. The rinse liquid LH supplied from the first supply port 21 and the recovery port 20 is recovered from the suction port 53.

In the example shown in FIG. 15, although the vibration is given to the rinse liquid LH supplied from the first supply port 21 (recovery port 20) to the space SP2, for example, a vibrator may be disposed in at least one of the first interior channel 21R and the first channel 23R, to thereby give vibration to the rinse liquid LH before being supplied to the first supply port 21. Similarly, a vibrator may be disposed in the third interior channel 23R, to thereby give vibration to the rinse liquid LH before being supplied from the recovery port 20.

Furthermore, in the second period of time, the vibration (ultrasonic vibration) may be given to the rinse liquid LH.

Furthermore, when the rinse liquid LH is vibrated in the first period of time and the second period of time, in the second period of time, the rinse liquid LH supplied to the liquid immersion member 7 may be vibrated in the vibration conditions different from those in the first period of time. The vibration conditions include, for example, at least one of the vibration frequency, the amplitude of vibration, and the vibration time. For example, the rinse liquid LH may be vibrated at the vibration of a first vibration frequency in the first period of time, and may be vibrated at the vibration of a second vibration frequency different from the first vibration frequency in the second period of time. The first vibration frequency may be larger or smaller than the second vibration frequency. In addition, the rinse liquid LH may be vibrated at a first amplitude of vibration in the first period of time, and may be vibrated at a second amplitude of vibration different from the first amplitude of vibration in the second period of time. The first amplitude of vibration may be larger or smaller than the second amplitude of vibration. In addition, the rinse liquid LH may be vibrated at the vibration of a first time in the first period of time, and may be vibrated at the vibration of a second time different from the first time in the second period of time. The first time may be larger or smaller than the second time.

In addition, for example, in the second period of time, the rinse liquid LH supplied to the liquid immersion member 7 may be vibrated, and the vibration conditions may be changed in the middle of the second period of time. Of course, the vibration conditions may be changed in the middle of the first period of time.

In addition, the first cleaning liquid LC1 in the first cleaning process may be vibrated, the rinse liquid LH in the first rinse process may be vibrated, and the second cleaning liquid LC2 in the second cleaning process may be vibrated. In addition, the vibration conditions given to the liquid (at least one of the first cleaning liquid LC1, the second cleaning liquid LC2, and the rinse liquid LH) may be changed in the middle of the operation of supplying the liquid.

Furthermore, an ultrasonic generator may be disposed in the dummy substrate DP and the ultrasonic generator may be brought into operation, to thereby vibrate the liquid between the liquid immersion member 7 and the dummy substrate DP at ultrasonic vibration. In addition, an ultrasonic generator may be disposed in the substrate stage 2 and the ultrasonic generator may be brought into operation, to thereby vibrate the liquid between the liquid immersion member 7 and the substrate stage 2 at ultrasonic vibration.

Furthermore, in the embodiment of FIG. 15, the rinse liquid LH is supplied even from the recovery port 20 (hole 19H of the porous member 19). However, as described in the embodiments of FIGS. 1 to 14 mentioned above, when the rinse liquid LH is supplied, the rinse liquid LH may be vibrated at ultrasonic vibration. In this case, as shown in FIG. 15, the rinse liquid LH may be vibrated at ultrasonic vibration without providing the suction port 53.

Furthermore, in the present embodiment, the size of the liquid immersion spaces (LT1, LT2, LSh and the like) formed between the liquid immersion member 7 and the object (at least one of the dummy substrate DP, the substrate stage 2, and the measurement stage 3) may be adjusted. That is, the contact area of the liquid, by which the liquid immersion space is formed, in the lower surface 14 may be changed. In the present embodiment, the size of the liquid immersion space is the size within the XY plane which is substantially parallel to the lower surface 14, between the lower surface 14 and the upper surface of the object facing the lower surface 14. For example, while not changing the recovery amount (difference between the pressure of the space SP2 and the pressure of the third interior channel 20R) of the rinse liquid LH per unit time from the recovery port 20, it is possible to enlarge the liquid immersion space LSh by increasing the supply amount of the rinse liquid LH per unit time from the first supply port 21, and it is possible to reduce the liquid immersion space LSh by decreasing the supply amount thereof. In addition, for example, while not changing the supply amount of the rinse liquid LH per unit time from the first supply port 21, it is possible to enlarge the liquid immersion space LSh by decreasing the recovery amount of the rinse liquid LH per unit time from the recovery port 20, and it is possible to reduce the liquid immersion space LSh by increasing the recovery amount thereof. Of course, both of the supply amount of the rinse liquid LH and the recovery amount thereof may be adjusted. The position of the interface LGh (position in the radiation direction with respect to the light path of the exposure light EL) is changed between the lower surface 14 and the upper surface of the object by changing the size of the liquid immersion space LSh. Thereby, it is possible to enhance the rinse effect.

Similarly, at least one of the supply amount and the recovery amount of the first cleaning liquid LC1 may be adjusted to thereby adjust the size of the liquid immersion space LT1 formed by the first cleaning liquid LC1 between the liquid immersion member 7 and the object (for example, the dummy substrate DP), and at least one of the supply amount and the recovery amount of the second cleaning liquid LC2 may be adjusted to thereby adjust the size of the liquid immersion space LT2 formed by the second cleaning liquid LC2 between the liquid immersion member 7 and the object.

Furthermore, in the above-mentioned embodiment, although the case in which the liquid immersion member 7 is cleaned has been described by way of example, it is possible to clean the substrate stage 2, for example, by supplying the cleaning liquid LC (LC1, LC2) to the substrate stage 2 (including the plate member T). In addition, it is possible to rinse the substrate stage 2 by supplying the rinse liquid LH to the substrate stage 2. In addition, it is possible to clean the measurement stage 3 by supplying the cleaning liquid LC (LC1, LC2) to the measurement stage 3 (including the measurement member C). In addition, it is possible to rinse the measurement stage 3 by supplying the rinse liquid LH to the measurement stage 3.

In addition, when the substrate stage 2 includes a scale member capable of facing an encoder head as disclosed in, for example, the Specification of U.S. Patent Application Publication No. 2007/0,288,121 and the like, the cleaning liquid LC may be supplied to the scale member, and the rinse liquid LH may be supplied thereto.

Furthermore, in the present embodiment, although the cleaning liquid LC is supplied through the second supply port 22 of the liquid immersion member 7, the supply place of the cleaning liquid LC is not limited thereto. For example, the cleaning liquid LC may be supplied through the first supply port 21 of the liquid immersion member 7. For example, the second channel 24R may be connected to a portion of the first channel 23R through a switching mechanism, thereby allowing the cleaning liquid LC flowing through the second channel 24R to be supplied through the first supply port 21. In this case, a back-flow prevention device may be provided so that the cleaning liquid LC is not sent out from the switching mechanism to the supply source LQS. In addition, for example, the cleaning liquid LC may be supplied through the recovery port 20 of the liquid immersion member 7. In this case, the suction port 53 capable of suctioning fluids may be provided at the outside of the recovery port 20 in the radiation direction with respect to the light path K as shown in FIG. 15, to thereby recover the cleaning liquid LC supplied through the recovery port 20.

Furthermore, in the present embodiment, although the liquids (first and second cleaning liquids LC1 and LC2, and rinse liquid LH) are supplied through the supply ports (21 and 22) of the liquid immersion member 7 and the liquids are recovered through the recovery port (20) of the liquid immersion member 7, the liquids may be supplied from the supply ports provided in the objects (substrate stage 2, measurement stage 3, dummy substrate DP, and the like) facing the liquid immersion member 7, and the liquids may be recovered from the recovery ports provided in the objects.

Furthermore, in the present embodiment, in each of the steps SA2, SA3, SA4, SA5, and SA6 of the cleaning sequence, although the same dummy substrate DP is used, the dummy substrate DP may be replaced for each step, and the dummy substrate DP may be replaced for each liquid used. For example, when at least one of the first and second cleaning liquids LC1 and LC2 is supplied onto the dummy substrate DP, the dummy substrate DP, the surface of which is formed with a clear coat, may be used, and when the rinse liquid LH is supplied thereto, the dummy substrate DP, the surface of which is formed of HMDS, may be used.

### Second Embodiment

Next, a second embodiment will be described. In the following description, the same reference signs and numerals are given to the same components as those of the above-mentioned embodiment, and a description thereof will be simplified or omitted here.

In the present embodiment, for example, in the second rinse process, until the concentration of the second cleaning liquid LC2 contained in the rinse liquid LH received in the third receiving member 43 becomes a predetermined concentration or less which does not influence the waste liquid process, the rinse liquid LH recovered from the recovery port 20 is continuously sent out to the third receiving member 43.

Since the rinse liquid LH recovered from the recovery port 20 is sent out to the third receiving member 43 during the supply of the rinse liquid LH from the first supply port 21 and the recovery thereof from the recovery port 20, the concentration of the second cleaning liquid LC2 contained in the rinse liquid LH received in the third receiving member 43 is gradually lowered. That is, since the rinse liquid LH recovered by the recovery operation of the recovery port 20 which is performed concurrently with the operation of the supply of the rinse liquid LH from the first supply port 21 is continuously supplied from the third discharge port 33 to the third receiving member 43, the concentration of the second cleaning liquid LC2 contained in the rinse liquid LH received in the third receiving member 43 is gradually lowered, and becomes a predetermined concentration or less with time. Thereby, it is possible to smoothly perform the waste liquid process of the rinse liquid LH received in the third receiving member 43. Furthermore, in this case, the operation of switching the discharge of the rinse liquid LH from the third discharge port 33 to the first discharge port 31 (operation of transition from the second rinse process to the third rinse process) may be omitted.

For example, the rinse liquid LH received in the third receiving member 43 may be discarded as it is, or may be reused without being discarded. That is, the second process described in the above-mentioned first embodiment can be performed on the rinse liquid LH received in the third receiving member 43. In addition, for example, even when a predetermined process is required to be performed at the time of the discarding and the like of the rinse liquid LH including the second cleaning liquid LC2 of a predetermined concentration or less is performed, the number of steps of the process is smaller than the number of steps of the process performed at the time of the discarding and the like of the rinse liquid LH including the second cleaning liquid LC2 of more than a predetermined concentration.

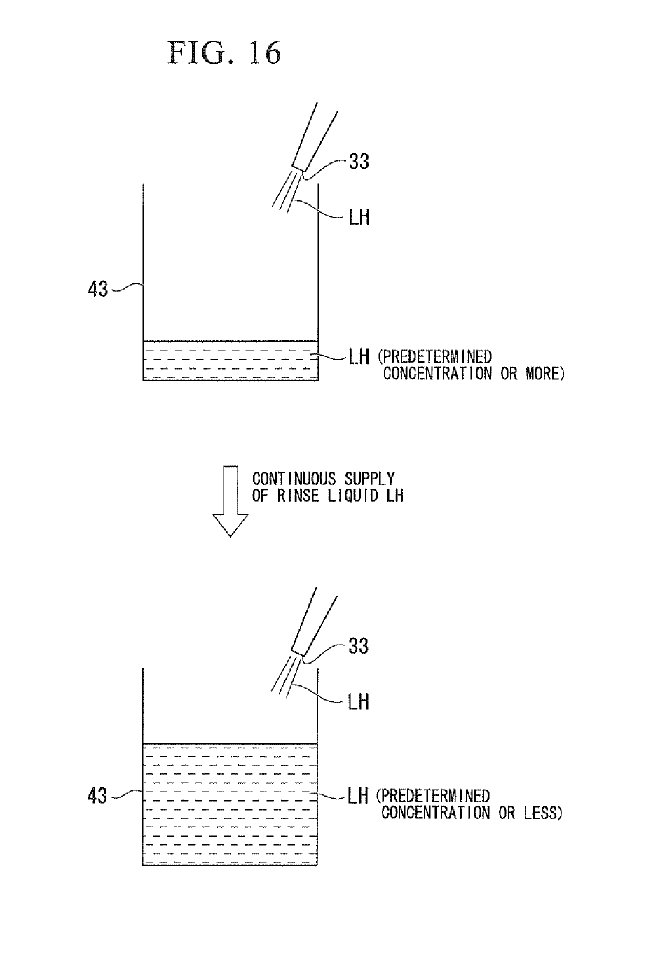

In addition, as shown in a schematic diagram of FIG. 16, even after the concentration of the second cleaning liquid LC2 contained in the rinse liquid LH received in the third receiving member 43 reaches a predetermined concentration, the rinse liquid LH recovered from the recovery port 20 may be continuously sent out to the third receiving member 43. Thereby, it is possible to further lower the concentration of the second cleaning liquid LC2 contained in the rinse liquid LH received in the third receiving member 43. In this case, the operation of switching the discharge of the rinse liquid LH from the third discharge port 33 to the first discharge port 31 (operation of transition from the second rinse process to the third rinse process) may be omitted.

Furthermore, before the rinse liquid LH recovered from the recovery port 20 is received in the third receiving member 43, the rinse liquid LH may be received in the third receiving member 43. Thereby, the concentration of the second cleaning liquid LC2 contained in the rinse liquid LH received in the third receiving member 43 can also be set to a predetermined concentration or less. The second process may be performed on the rinse liquid LH, the concentration of the second cleaning liquid LC2 of which is set to a predetermined concentration or less.

Furthermore, the concentration of the second cleaning liquid LC2 contained in the rinse liquid LH which is recovered from the recovery port 20 and is supplied to the third receiving member 43 may be high with respect to the concentration of the second cleaning liquid LC2 contained in the rinse liquid LH received in the third receiving member 43.

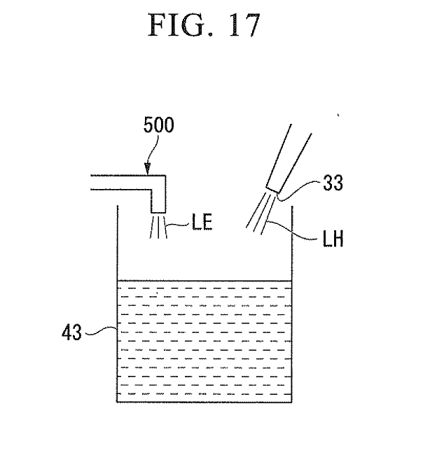

Furthermore, as shown in a schematic diagram of FIG. 17, in order to set the concentration of the second cleaning liquid LC2 contained in the rinse liquid LH received in the third receiving member 43 to a predetermined concentration or less, predetermined liquid LE different from the second cleaning liquid LC2 may be sent out to the third receiving member 43. The predetermined liquid LE may be supplied to the third receiving member 43 without going through the liquid immersion member 7, or may be supplied through the liquid immersion member 7. For example, the predetermined liquid LE may be supplied from a predetermined liquid supply device 500 to the third receiving member 43 without going through the liquid immersion member 7, or may be supplied by an operator. In addition, sending out of the predetermined liquid LE to the third receiving member 43 may be performed in the state where sending out of the rinse liquid LH recovered from the recovery port 20 to the third receiving member 43 is stopped, or may be performed in the state where sending out of the rinse liquid LH recovered from the recovery port 20 to the third receiving member 43 is performed.

Furthermore, the predetermined liquid LE may be, for example, the rinse liquid LH. That is, the predetermined liquid LE may be water. In addition, the cleanness level of the predetermined liquid LE supplied to the third receiving member 43 may be lower than the cleanness level of the rinse liquid LH (exposure liquid LQ). That is, though the predetermined liquid LE has the same ingredient as that of the rinse liquid LH, the cleanness level thereof may be different from that of the rinse liquid LH. In addition, the temperatures of the predetermined liquid LE and the rinse liquid LH may be different from each other. In addition, the predetermined liquid LE may be a liquid other than water, such as alcohol like, for example, ethanol.

Furthermore, before the concentration of the second cleaning liquid LC2 contained in the rinse liquid LH received in the third receiving member 43 reaches a predetermined concentration, sending out of the rinse liquid LH recovered from the recovery port 20 to the third receiving member 43 may be stopped. For example, sending out of the rinse liquid LH to the third receiving member 43 may be stopped by stopping the supply of the rinse liquid LH from the first supply port 21 and the recovery of the rinse liquid LH from the recovery port 20.

The concentration of the second cleaning liquid LC2 contained in the rinse liquid LH received in the third receiving member 43 becomes a predetermined concentration or less after the stopping of the sending out thereof, the rinse liquid LH recovered from the recovery port 20 may be continuously sent out to the third receiving member 43. That is, the rinse liquid LH may be continuously supplied from the third discharge port 33 to the third receiving member 43, and may be intermittently supplied.

Furthermore, whether the concentration of the second cleaning liquid LC2 contained in the rinse liquid LH received in the third receiving member 43 becomes a predetermined concentration or less may be determined by the detection result of the above-mentioned detection apparatus 40, and whether the concentration of the second cleaning liquid LC2 contained in the rinse liquid LH received in the third receiving member 43 is a predetermined concentration or less may be determined by providing the same detection apparatus as the above-mentioned detection apparatus 40 in the third receiving member 43 and detecting the characteristics of the rinse liquid LH received in the third receiving member 43.

Furthermore, whether the concentration of the second cleaning liquid LC2 contained in the rinse liquid LH received in the second receiving member 43 is a predetermined concentration or less may be determined by providing the same detection apparatus as the above-mentioned detection apparatus 40 in the second receiving member 42 and detecting the characteristics of the rinse liquid LH received in the second receiving member 42. When the detection apparatus that detects the characteristics of the rinse liquid LH is provided in the second receiving member 42 and the third receiving member 43, the above-mentioned detection apparatus 40 may be omitted.

Furthermore, when the rinse liquid LH recovered from the recovery port 20 is supplied to the third receiving member 43 through the third channel 25R, sending out of the recovered rinse liquid LH to the third receiving member 43 may be stopped after the concentration of the second cleaning liquid LC2 contained in the rinse liquid LH within the third channel 25R reaches a predetermined value or less. The concentration of the second cleaning liquid LC2 contained in the rinse liquid LH within the third channel 25R can be sought from the detection result of the detection apparatus 40. The predetermined value may be lower than the predetermined concentration. That is, when the concentration of the second cleaning liquid LC2 contained in the recovered rinse liquid LH is determined to be lower than the predetermined concentration on the basis of the detection result of the detection apparatus 40, the control apparatus 8 may stop sending out of the recovered rinse liquid LH to the third receiving member 43. After the stopping of the sending out thereof, the rinse liquid LH of which the concentration of the second cleaning liquid LC2 is a predetermined value or less may be supplied to the member (for example, first receiving member 41) different from the third receiving member 43, may be reused, and may be discarded.

In addition, even after sending out of the recovered rinse liquid LH to the third receiving member 43 is stopped, the supply of the rinse liquid LH from the first supply port 21 and the recovery of the rinse liquid LH from the recovery port 20 may be continued. After the stopping of the sending out thereof, for example, a process of switching the discharge of the rinse liquid LH from the third discharge port 33 to the first discharge port 31 is performed, whereby the recovered rinse liquid LH may be received in the first receiving member 41. In addition, the recovered rinse liquid LIT may be discarded.

In the present embodiment, the recovery operation of the recovery port 20 is performed concurrently with the operation of the supply of the rinse liquid LH from the first supply port 21, and the rinse liquid LH recovered from the recovery port 20 is supplied from the third discharge port 33 to the third receiving member 43 through the third channel 25R. After the concentration of the second cleaning liquid LC2 contained in the rinse liquid LH received in the third receiving member 43 reaches a predetermined concentration, the concentration of the second cleaning liquid LC2 contained in the rinse liquid LH recovered from the recovery port 20 within the third channel 25R is lower than the predetermined concentration. Therefore, even when the supply of the rinse liquid LH to the third receiving member 43 is continued, it is possible to suppress a rise in the concentration of the second cleaning liquid LC2 contained in the rinse liquid LH received in the third receiving member 43.

Furthermore, here, in the second rinse process after the second cleaning process, the case has been described, by way of example, in which the recovered rinse liquid LH is received in the third receiving member 43 until the concentration of the second cleaning liquid LC2 contained in the rinse liquid LH becomes a predetermined concentration or less. However, for example, in the first rinse process after the first cleaning process, the above-mentioned sequence may also be applied to a case in which the recovered rinse liquid LH is received in the second receiving member 42 until the concentration of the first cleaning liquid LC1 contained in the rinse liquid LH becomes a predetermined concentration or less.

### Third Embodiment

Next, a second embodiment will be described. In the following description, the same reference signs and numerals are given to the same components as those of the above-mentioned embodiment, and a description thereof will be simplified or omitted here.

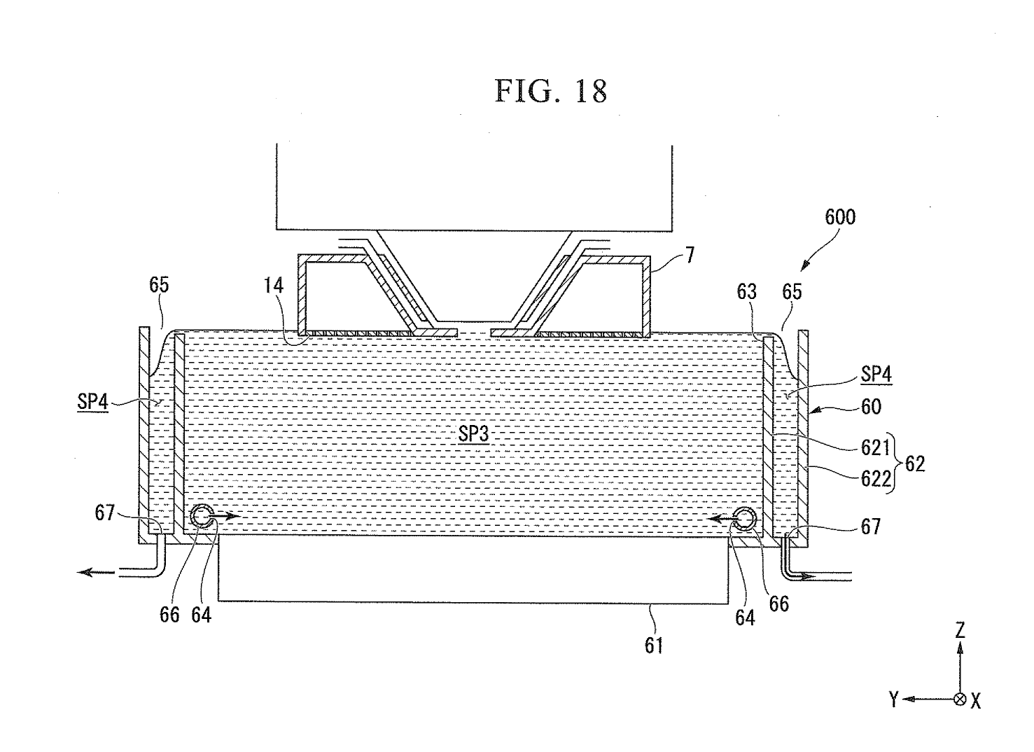

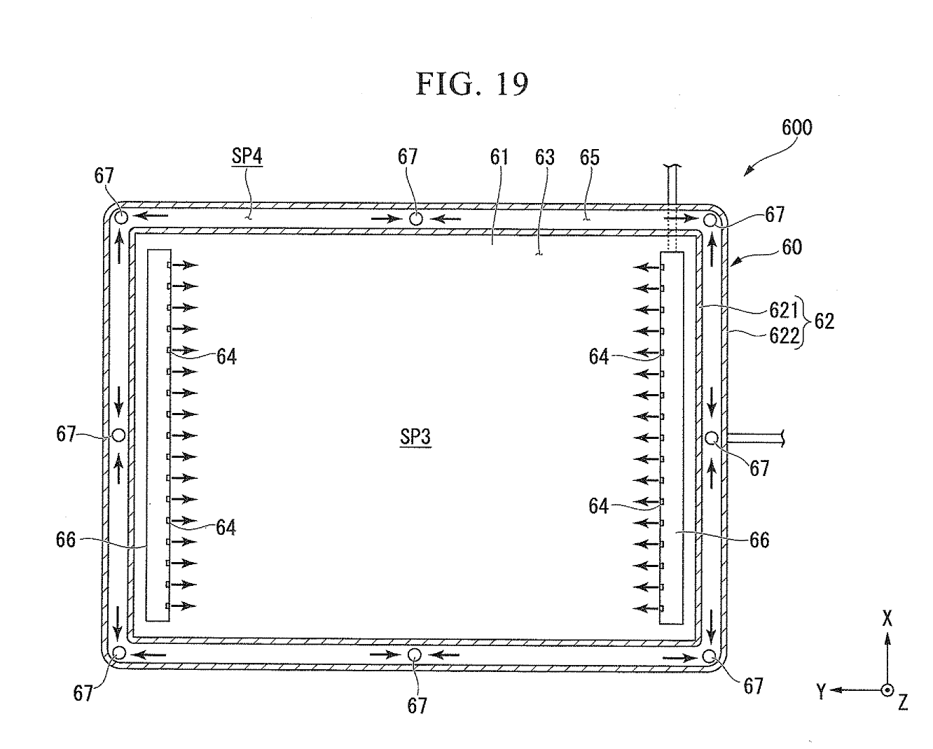

FIG. 18 is a side cross-sectional view illustrating an example of a cleaning apparatus 600 according to the second embodiment, and FIG. 19 is a plan view when the cleaning apparatus 600 is seen from the upper side. In the present embodiment, a case in which the liquid immersion member 7 is cleaned using the cleaning apparatus 600 capable of facing the liquid immersion member 7 will be described by way of example.

In FIGS. 18 and 19, the cleaning apparatus 600 includes a holding member 60 which is capable of holding the liquid (at least one of the first cleaning liquid LC1, the second cleaning liquid LC2, and the rinse liquid LH). The holding member 60 has a plate-shaped base member 61 and a sidewall member 62, connected to the lateral side of the base member 61, that extends upward from the base member 61.

In the present embodiment, the sidewall member 62 has a first sidewall portion 621 that forms a space SP3 capable of holding the liquid, and a second sidewall portion 622, disposed in the periphery of the first sidewall portion 621, that forms a space SP4 capable of holding the liquid between the first sidewall portion 621 and the second sidewall portion. The space SP3 is defined by the base member 61 and the first sidewall portion 621.

In addition, the holding member 60 has an opening 63 defined by the upper end of the first sidewall portion 621. The opening 63 is larger than the liquid immersion member 7. At the time of cleaning the liquid immersion member 7, the liquid immersion member 7 is disposed at the inside of the opening 63.

In addition, the cleaning apparatus 600 has a supply port 64 that supplies the liquid between the liquid immersion member 7 and the holding member 60, and a recovery port 65 that recovers the liquid.

In the present embodiment, the cleaning apparatus 600 has a pipe member 66 disposed in the space SP3. The supply port 64 is formed in the pipe member 66. In the present embodiment, the pipe member 66 is disposed at the outside of the +Y side edge and the outside of the −Y side edge of the upper surface of the base member 61, respectively. The pipe member 66 is long in the X axial direction.

The pipe member 66 has a plurality of holes that link the internal space and the external space (space SP3) of the pipe member 66. In the pipe member 66, a plurality of holes is formed in the X axial direction. The supply port 64 is disposed at one end of the hole facing the space SP3. The supply port 64 supplies the liquid toward the center of the space SP3.

The recovery port 65 is defined by the upper end of the first sidewall portion 621 and the upper end of the second sidewall portion 622. In the present embodiment, the recovery port 65 is annularly provided so as to surround the upper end of the first sidewall portion 621. The recovery port 65 recovers the liquid overflowing from the upper end of the first sidewall portion 621. The liquid of the space SP3 overflowing from the upper end of the first sidewall portion 621 is recovered in the recovery port 65 and flows through the recovery port 65 into the space SP4.

A suction port 67 is formed at the bottom of the space SP4. In the present embodiment, the suction port 67 is smaller than the recovery port 65. A plurality of suction ports 67 is disposed at the bottom of the space SP4. The suction port 67 suctions and recovers the liquid which is recovered from the recovery port 65 and is present in the space SP4.

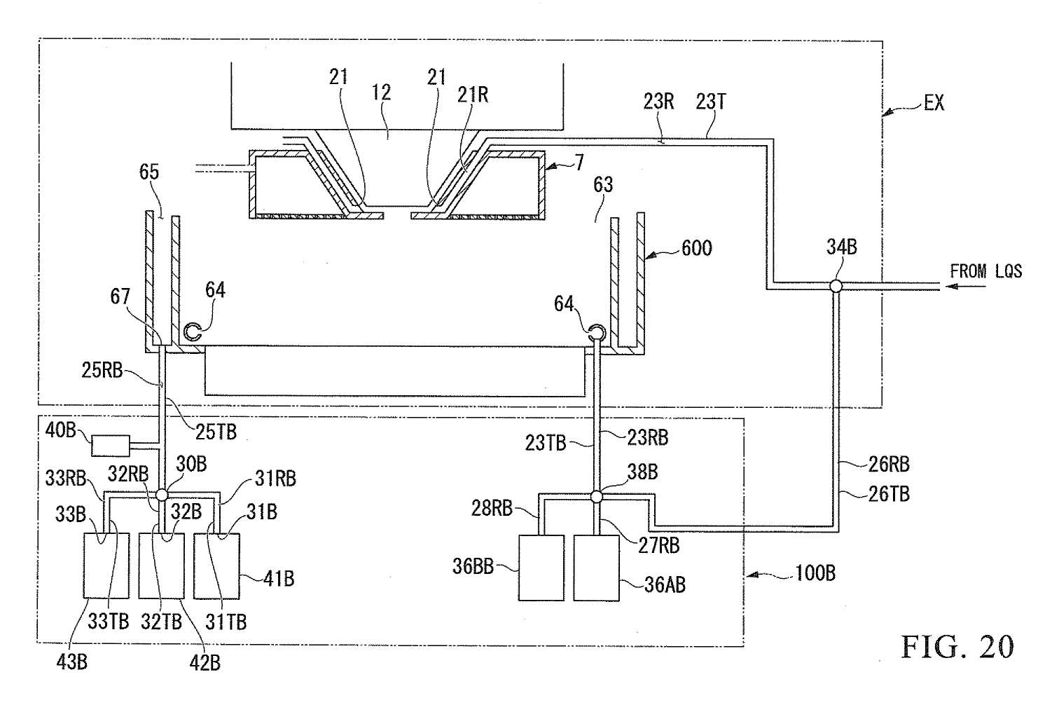

FIG. 20 is a diagram illustrating an example of a liquid system 1008 which is capable of supplying and recovering the liquid to and from the cleaning apparatus 600 according to the present embodiment. Furthermore, in the present embodiment, the cleaning apparatus 600 may be an external apparatus for the exposure apparatus EX, and may be a portion of the exposure apparatus EX. In addition, the liquid system 100B may be an external apparatus for the exposure apparatus EX, and may be a portion of the exposure apparatus EX. In addition, the liquid system 100B may be an external apparatus for the cleaning apparatus 600, and may be a portion of the cleaning apparatus 600. In the present embodiment, as an example, a case will be described, by way of example, in which the exposure apparatus EX includes the cleaning apparatus 600 and the liquid system 100B is an external apparatus for the exposure apparatus EX.

In the present embodiment, the liquid system 100B includes a channel forming member 23TB having a channel 23RB through which the liquid supplied to the supply port 64 flows, and a channel forming member 25TB having a channel 25RB through the liquid recovered from the recovery port 65 (suction port 67) flows.

In the present embodiment, the liquid system 100B includes a first discharge port 31B that discharges the liquid recovered from the suction port 67, a second discharge port 32B different from the first discharge port 31B, and a third discharge port 33B different from the first and second discharge ports 31B and 32B. In the present embodiment, the liquid which is recovered from the suction port 67 and is sent to the channel 25RB is sent to at least one of the first discharge port 31B, the second discharge port 32B, and the third discharge port 33B.

Furthermore, in the present embodiment, although the liquid system 100B includes the first discharge port 31B, the second discharge port 32B, and the third discharge port 33B, the exposure apparatus EX may include at least one of the first discharge port 31B, the second discharge port 32B, and the third discharge port 33B, and the cleaning apparatus 600 may include at least one of the first discharge port 31B, the second discharge port 32B, and the third discharge port 33B.

In the present embodiment, one end of the channel 25RB is connected to the suction port 67, and the other end thereof is connected to a channel switching mechanism 30B including a valve mechanism. In addition, the liquid system 100B includes channel forming members 31TB, 32TB, and 33TB which are connected to the channel switching mechanism 30B. The channel forming member 31TB has a first discharge channel 31RB. The channel forming member 32TB has a second discharge channel 32RB. The channel forming member 33TB has a third discharge channel 33RB. One end of each of the first, second, and third discharge channels 31RB, 32RB, and 33RB is connected to the channel switching mechanism 30B. The first discharge port 31B is disposed at the other end of the first discharge channel 31RB. The second discharge port 32B is disposed at the other end of the second discharge channel 32RB. The third discharge port 33B is disposed at the other end of the third discharge channel 33RB.

The channel switching mechanism 30B switches the channel so that the liquid which is recovered from the suction port 67 and flows through the channel 25RB is sent to at least one of the first discharge channel 31RB (first discharge port 31B), the second discharge channel 32RB (second discharge port 32B), and the third discharge channel 33RB (third discharge port 33B). In the present embodiment, the channel switching mechanism 30B can adjust the channel so that when the liquid from the channel 25RB is supplied to the first discharge port 31B, the liquid is not supplied to the second and third discharge ports 32B and 33B. In addition, the channel switching mechanism 30B can adjust the channel so that when the liquid from the channel 25RB is supplied to the second discharge port 32B, the liquid is not supplied to the first and third discharge ports 31B and 33B. In addition, the channel switching mechanism 30B can adjust the channel so that when the liquid from the channel 25RB is supplied to the third discharge port 33B, the liquid is not supplied to the first and second discharge ports 31B and 32B.

In the present embodiment, the liquid system 100B includes a first receiving member 41B capable of receiving the liquid discharged from the first discharge port 31B, a second receiving member 42B capable of receiving the liquid discharged from the second discharge port 32B, and a third receiving member 43B capable of receiving the liquid discharged from the third discharge port 33B. The first, second, and third receiving members 41B, 428, and 43B include a tank.

In the present embodiment, the other end of the channel 23B is connected to the supply source LQS capable of supplying the exposure liquid LQ. The supply source LQS may be included in the liquid system 100B, and may be equipment of the factory FA in which the exposure apparatus EX (device manufacturing system SYS) is installed. In addition, the exposure apparatus EX may include the supply source LQS.

In the present embodiment, one end of the channel 23RB is connected to the supply port 64, and the other end thereof is connected to a channel switching mechanism 38B including a valve mechanism. In addition, one end of a channel 26RT formed by a channel forming member 26TB is connected to the channel switching mechanism 38B. The other end of a channel 26RB is connected to a channel switching mechanism 34B including a valve mechanism.

The channel switching mechanism 34B is disposed at a portion of the first channel 23R formed by the first channel forming member 23T. The first channel 23R is connected to the first supply port 21 of the liquid immersion member 7 through the first interior channel 21R.

The exposure liquid LQ supplied from the supply source LQS flows through the first channel 23R. The channel switching mechanism 34B switches the channel so that the exposure liquid LQ flowing through the first channel 23R is sent to at least one of the first supply port 21 and the channel 26RB. In the present embodiment, the channel switching mechanism 34B can adjust the channel so that when the exposure liquid LQ from the supply source LQS is supplied to the first supply port 21, the exposure liquid LQ is not supplied to the channel 26RB. In addition, the channel switching mechanism 34B can adjust the channel so that when the exposure liquid LQ from the supply source LQS is supplied to the channel 26RB, the exposure liquid LQ is not supplied to the first supply port 21.

In addition, in the present embodiment, the liquid system 100B includes a first cleaning liquid supply device 36AB capable of supplying the first cleaning liquid LC1, and a second cleaning liquid supply device 36BB capable of supplying the second cleaning liquid LC2.

In the present embodiment, the first cleaning liquid supply device 36AB is connected to the channel switching mechanism 38B through a channel 27RB. The second cleaning liquid supply device 36BB is connected to the channel switching mechanism 38B through a channel 28RB.

The channel switching mechanism 38B switches the channel so that at least one of the exposure liquid LQ from the supply source LQS (channel 26RB), the first cleaning liquid LC1 from the first cleaning liquid supply device 36AB, and the second cleaning liquid LC2 from the second cleaning liquid supply device 36BB is sent through the channel 23RB to the supply port 64.

In the present embodiment, the channel switching mechanism 38B can adjust the channel so that when the first cleaning liquid LC1 from the first cleaning liquid supply device 36AB is supplied to the supply port 64, the exposure liquid LQ and the second cleaning liquid LC2 are not supplied thereto. In addition, the channel switching mechanism 38B can adjust the channel so that when the second cleaning liquid LC2 from the second cleaning liquid supply device 36BB is supplied to the supply port 64, the exposure liquid LQ and the first cleaning liquid LC1 are not supplied thereto. In addition, the channel switching mechanism 38B can adjust the channel so that when the exposure liquid LQ from the supply source LQS is supplied to the supply port 64, the first cleaning liquid LC1 and the second cleaning liquid LC2 are not supplied thereto.

In addition, in the present embodiment, the liquid system 100B includes a detection apparatus 40B that detects the characteristics (at least one of properties and components) of the liquid recovered from the suction port 67. In the present embodiment, the detection apparatus 40B measures the conductivity of the liquid which is recovered from the suction port 67 and flows through the channel 25RB.

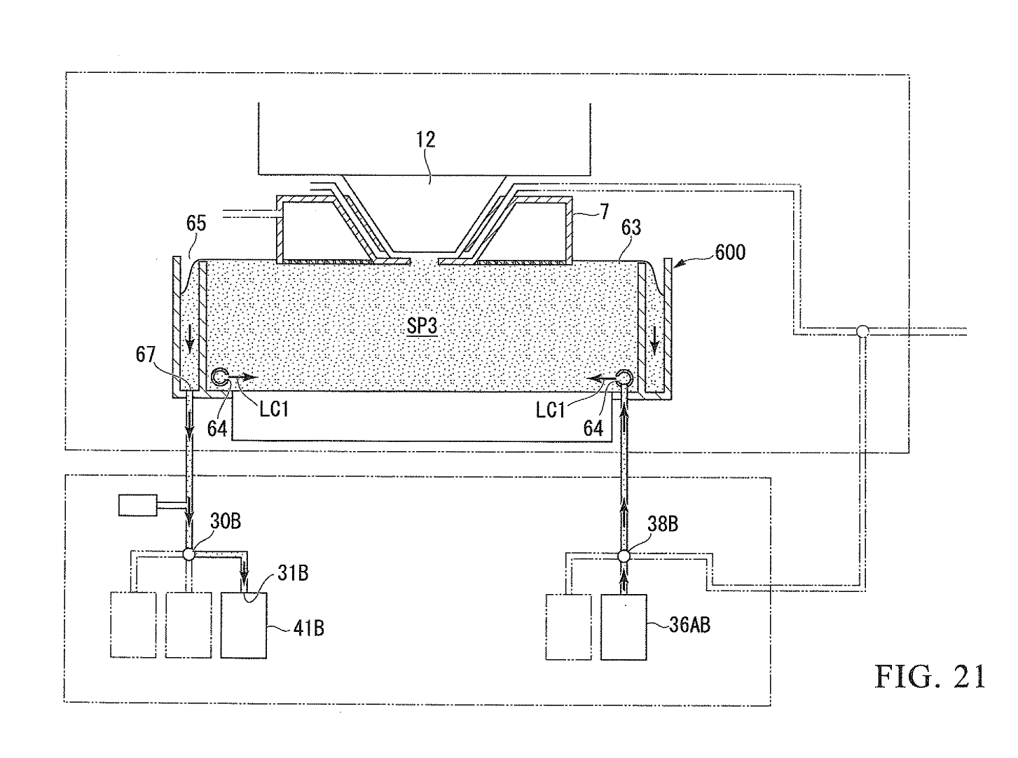

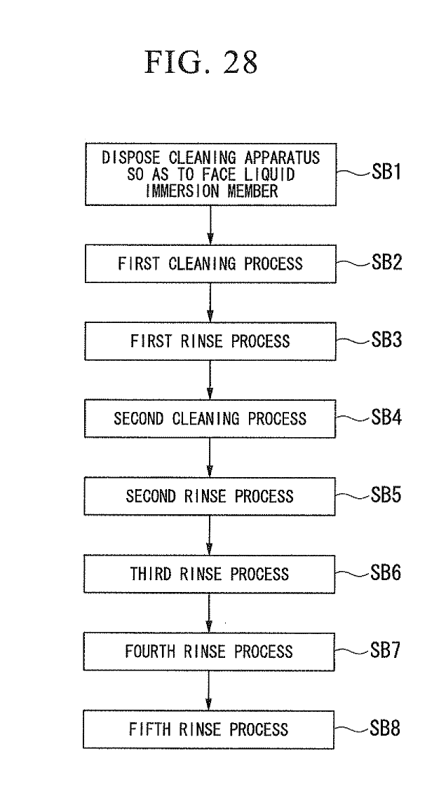

FIGS. 21 to 27 are schematic diagrams illustrating an example of the cleaning sequence according to the present embodiment, and FIG. 28 is a flow diagram illustrating an example of the cleaning sequence according to the present embodiment. The cleaning sequence according to the present embodiment includes a process of causing the liquid immersion member 7 and the cleaning apparatus 600 to face each other so that the liquid immersion member 7 is disposed in the opening 63 (step SB1), a first cleaning process of cleaning the liquid immersion member 7 by supplying the first cleaning liquid LC1 to the space SP3 so that the first cleaning liquid LC1 is supplied to the liquid immersion member 7 (step SB2), a first rinse process of supplying the rinse liquid LH to the space SP3 so that the rinse liquid LH is supplied to the liquid immersion member 7 (step SB3), a second cleaning process of cleaning the liquid immersion member 7 by supplying the second cleaning liquid LC2 to the space SP3 so that the second cleaning liquid LC2 is supplied to the liquid immersion member 7 (step SB4), a second rinse process of supplying the rinse liquid LH to the space SP3 so that the rinse liquid LH is supplied to the liquid immersion member 7 (step SB5), a third rinse process of further supplying the rinse liquid LH to the space SP3 so that the rinse liquid LH is supplied to the liquid immersion member 7 (step SB6), a fourth rinse process of further supplying the rinse liquid LH to the space SP3 so that the rinse liquid LH is supplied to the liquid immersion member 7 (step SB7), and a fifth rinse process of supplying the rinse liquid LH to the liquid immersion member 7 by causing the liquid immersion member 7 and the dummy substrate DP held in the substrate stage 2 to face each other (step SB8).

Furthermore, when the liquid immersion space LS is formed in at least one of the liquid immersion member 7 and the substrate stage 2 and the measurement stage 3 before the cleaning sequence is started, in order to start the cleaning sequence, the control apparatus 8 stops the supply of the exposure liquid LQ from the first supply port 21, and continuously recovers the exposure liquid LQ from the recovery port 20 for a predetermined time, to thereby recover the entirety of the exposure liquid LQ of the liquid immersion space LS so that the liquid immersion space LS is eliminated. Thereby, at least the exposure liquid LQ of the third interior channel 20R is eliminated. Furthermore, the exposure liquid LQ may or may not exist in at least one of the first interior channel 21R and the second interior channel 22R. After the liquid immersion space LS is eliminated, the control apparatus 8 retreats the substrate stage 2 and the measurement stage 3 from the position facing the liquid immersion member 7 so that the cleaning apparatus 600 can be disposed facing the liquid immersion member 7.

The cleaning apparatus 600 is loaded onto the position facing the liquid immersion member 7. The loading of the cleaning apparatus 600 may be performed by, for example, an operator, and may be performed using a predetermined transport device.

After the liquid immersion member 7 and the cleaning apparatus 600 are caused to face each other so that the liquid immersion member 7 is disposed in the opening 63 (step SB1), the first cleaning liquid LC1 is supplied to the supply port 64 as shown in FIG. 21. Thereby, the space SP3 is filled with the first cleaning liquid LC1, and the liquid immersion member 7 and the first cleaning liquid LC1 are in contact with each other.

The cleaning apparatus 600 performs the recovery of the first cleaning liquid LC1 from the recovery port 65 (suction port 67) concurrently with the supply of the first cleaning liquid LC1 from the supply port 64. The first cleaning liquid LC1 recovered from the suction port 67 is discharged from the first discharge port 31B. The first cleaning liquid LC1 discharged from the first discharge port 31B is supplied to the first receiving member 41B.

After the supply of the first cleaning liquid LC1 from the supply port 64 and the recovery of the first cleaning liquid LC1 from the recovery port 65 (suction port 67) are performed for a predetermined time, the cleaning apparatus 600 stops the supply of the first cleaning liquid LC1 from the supply port 64. Thereby, the first cleaning process (step SB2) is terminated.

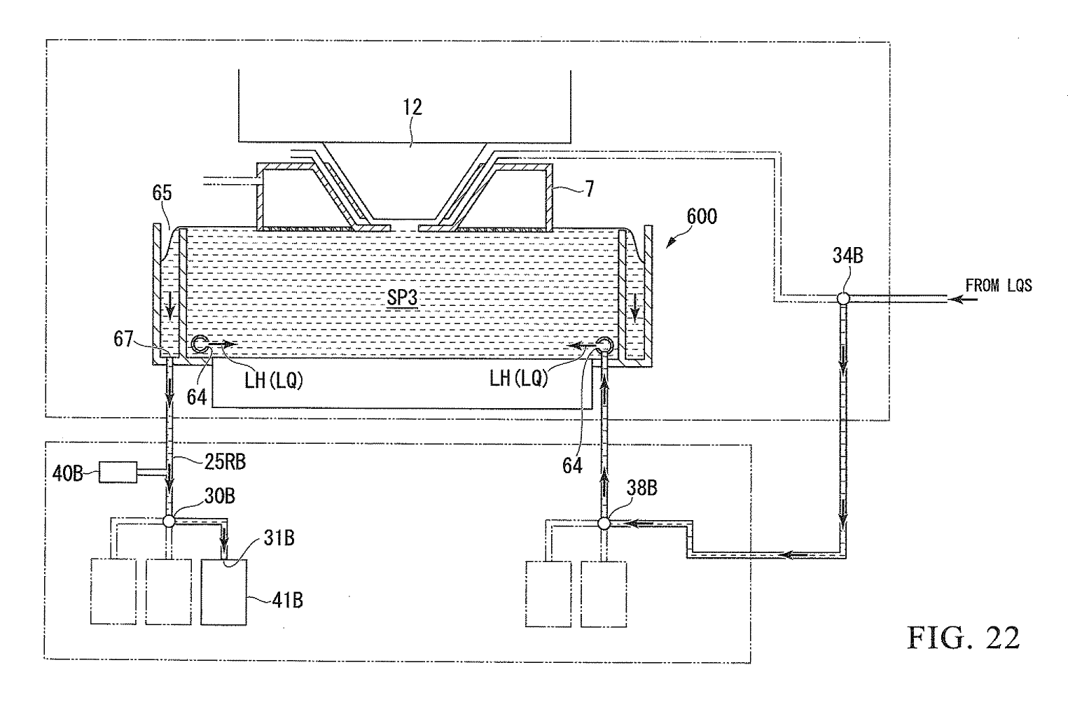

The cleaning apparatus 600 starts the first rinse process (step SB3). As shown in FIG. 22, the cleaning apparatus 600 starts the supply of the rinse liquid LH from the supply port 64.

In the present embodiment, the exposure liquid LQ is used as the rinse liquid LH. The channel is adjusted by the channel switching mechanism 3413 so that the rinse liquid LH (exposure liquid LQ) from the supply source LQS is supplied to the supply port 64. In the first rinse process, the cleaning apparatus 600 performs the recovery of the liquid (including at least one of the first cleaning liquid LC1 and the rinse liquid LH) from the recovery port 65 (suction port 67) concurrently with the supply of the rinse liquid LH (exposure liquid LQ) from the supply port 64.

In the present embodiment, the cleaning apparatus 600 recovers the entirety of the first cleaning liquid LC1 of the space SP3, and then starts the supply of the rinse liquid LH from the supply port 64. Furthermore, in the state where the first cleaning liquid LC1 is present in the space SP3, the supply of the rinse liquid LH from the supply port 64 may be started.

The rinse liquid LH supplied from the supply port 64 is in contact with the liquid immersion member 7, whereby it is possible to remove the first cleaning liquid LC1 remaining in the liquid immersion member 7.

The cleaning apparatus 600 performs the recovery of the liquid from the recovery port 65 (suction port 67) concurrently with the supply of the rinse liquid LH from the supply port 64.

In the present embodiment, the channel is adjusted so that the liquid (rinse liquid LH) recovered from the suction port 67 is discharged from the first discharge port 31B. The liquid discharged from the first discharge port 31B is supplied to the first receiving member 41B.

In the present embodiment, in the first rinse process, the characteristics of the liquid recovered from the suction port 67 are detected by the detection apparatus 40B. The detection apparatus 4013 detects the liquid which is recovered from the suction port 67 and flows through the channel 25RB. In the present embodiment, the detection apparatus 40B detects the conductivity of the liquid recovered from the suction port 67. The detection result of the detection apparatus 4013 is output to the control apparatus 8. In the present embodiment, the control apparatus 8 seeks the concentration of alkali (tetramethyl ammonium hydroxide) contained in the recovered liquid on the basis of the detection result of the detection apparatus 40B, and continues the first rinse process (the supply and the recovery of the rinse liquid LH) until the concentration becomes an acceptable value or less which is previously determined. For example, until the concentration of the alkali contained in the liquid recovered from the suction port 67 becomes 1% or less, the first rinse process is continued.

In the present embodiment, after it is confirmed on the basis of the detection result of the detection apparatus 40B that the concentration of the alkali contained in the liquid recovered from the suction port 67 becomes an acceptable value or less, the first rinse process (step SB3) is terminated.

After the first rinse process is terminated, the cleaning apparatus 600 starts the second cleaning process (step SB4). In order to clean the liquid immersion member 7 with the second cleaning liquid LC2, the cleaning apparatus 600 stops the supply of the rinse liquid LH from the supply port 64, and starts the supply of the second cleaning liquid LC2 from the supply port 64 to the space SP3.

Furthermore, the supply of the second cleaning liquid LC2 from the supply port 64 may be started in the state where the rinse liquid LH is present in the space SP3, and the supply of the second cleaning liquid LC2 from the supply port 64 may be started after the rinse liquid LH of the space SP3 is eliminated by recovering the rinse liquid LH from the recovery port 65 (suction port 67).

In addition, in the second cleaning process, the cleaning apparatus 600 performs the recovery of the second cleaning liquid LC2 from the recovery port 65 (suction port 67) concurrently with the supply of the second cleaning liquid LC2 from the supply port 64.

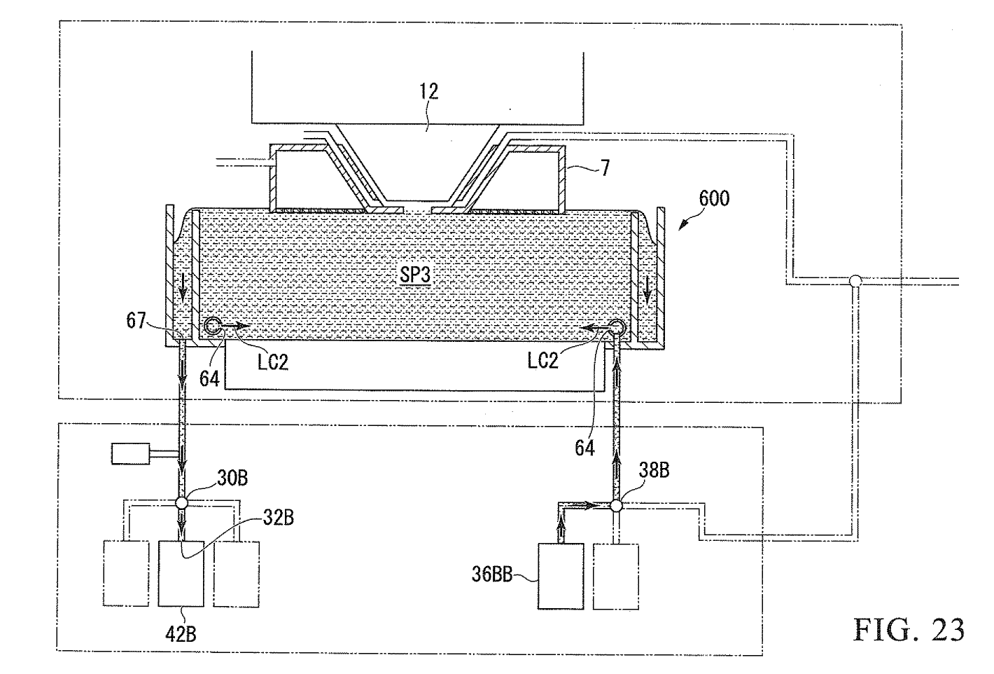

As shown in FIG. 23, in the second cleaning process, the second cleaning liquid LC2 is sent out from the second cleaning liquid supply device 36BB. Furthermore, the second cleaning liquid LC2 sent out from the second cleaning liquid supply device 36BB may be diluted, to thereby supply the diluted second cleaning liquid LC2 from the supply port 64.

At least a portion of the second cleaning liquid LC2 supplied from the supply port 64 to the space SP3 is in contact with the liquid immersion member 7. Thereby, the liquid immersion member 7 is cleaned with the second cleaning liquid LC2.

The recovery port 65 (suction port 67) recovers the second cleaning liquid LC2 supplied to at least a portion of the surface of the liquid immersion member 7. In the present embodiment, the channel is adjusted so that the second cleaning liquid LC2 recovered from the suction port 67 is discharged from the second discharge port 32B. The second cleaning liquid LC2 recovered from the suction port 67 is discharged from the second discharge port 32B. The second cleaning liquid LC2 discharged from the second discharge port 32B is supplied to the second receiving member 42B.

After the supply of the second cleaning liquid LC2 from the supply port 64 and the recovery of the second cleaning liquid LC2 from the recovery port 65 (suction port 67) are performed for a predetermined time, the cleaning apparatus 600 stops the supply of the second cleaning liquid LC2 from the supply port 64. Thereby, the second cleaning process (step SB4) is terminated.

Furthermore, in the second cleaning liquid LC2, the surface of the liquid immersion member 7 may be etched. The surface of the liquid immersion member 7 may be smoothed by the etching.

In the present embodiment, after the supply of the first cleaning liquid LC1 in the first cleaning process is stopped, and before the supply of the second cleaning liquid LC2 in the second cleaning process is started, in the first rinse process, the rinse liquid LH is supplied to the liquid immersion member 7 and the supplied rinse liquid LH is recovered. Therefore, in the second cleaning process, it is possible to reduce the concentration of the first cleaning liquid LC1 contained in the second cleaning liquid LC2 recovered from the recovery port 65 (suction port 67).

In addition, in the present embodiment, the first cleaning liquid LC1 recovered from the recovery port 65 (suction port 67) in the first cleaning process is discharged from the first discharge port 31B, and the second cleaning liquid LC2 recovered from the recovery port 65 (suction port 67) in the second cleaning process is discharged from the second discharge port 32B. The first rinse process is performed between the first cleaning process and the second cleaning process, whereby the discharge of the first cleaning liquid LC1 from the second discharge port 32B is suppressed in the second cleaning process. Since the first rinse process is performed so that the discharge of the first cleaning liquid LC1 from the second discharge port 32B is suppressed in the second cleaning process, it is possible to reduce the concentration of the first cleaning liquid LC1 contained in, for example, the second cleaning liquid LC2 discharged from the second discharge port 32B. In addition, it is possible to reduce the concentration of the first cleaning liquid LC1 contained in, for example, the second cleaning liquid LC2 of the second receiving member 42B.

Furthermore, as mentioned above, in the present embodiment, the first cleaning liquid LC1 sent out from the first cleaning liquid supply device 36AB and the second cleaning liquid LC2 sent out from the second cleaning liquid supply device 36BB are supplied to the liquid immersion member 7 through the supply channels of which at least a portion is the same. That is, in the present embodiment, each of the first cleaning liquid LC1 and the second cleaning liquid LC2 is supplied to the liquid immersion member 7 through at least the channel 23R. In addition, the supplies of each of the first cleaning liquid LC1 and the second cleaning liquid LC2 are performed through the supply port 64.

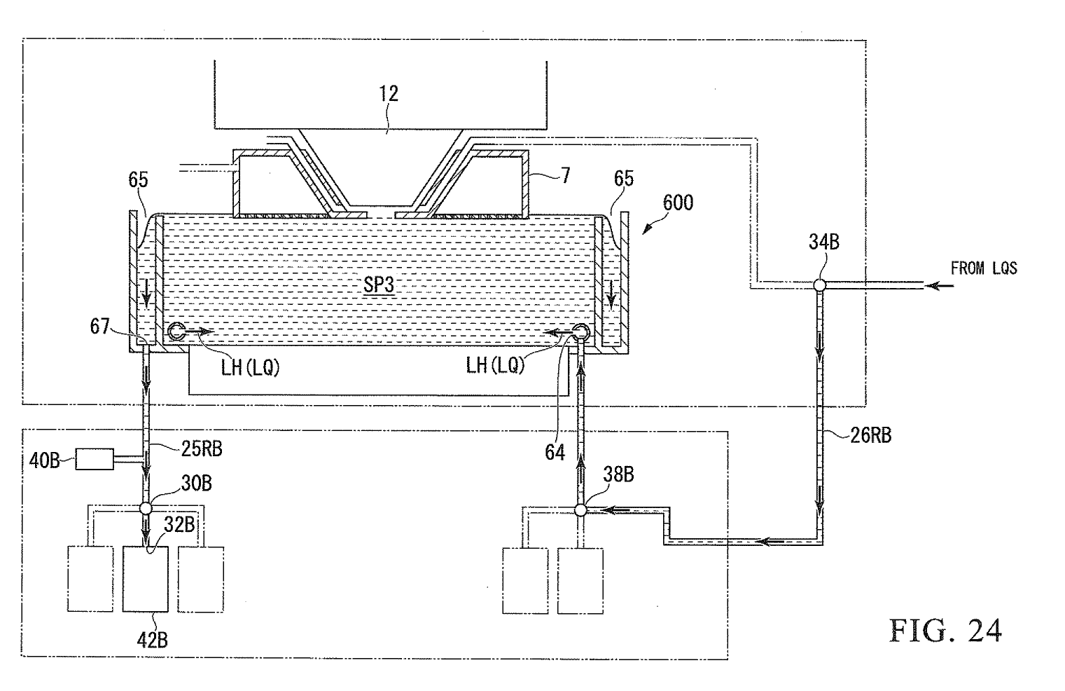

After the supply of the second cleaning liquid LC2 from the supply port 64 is stopped and the second cleaning process is terminated, the cleaning apparatus 600 starts the second rinse process (step SB5). As shown in FIG. 24, the cleaning apparatus 600 starts the supply of the rinse liquid LH from the supply port 64.

In the present embodiment, the cleaning apparatus 600 recovers the entirety of the second cleaning liquid LC2 of the space SP3, and then starts the supply of the rinse liquid LH from the supply port 64. Furthermore, in the state where the second cleaning liquid LC2 is present in the space SP3, the supply of the rinse liquid LH from the supply port 64 may be started.

Even in the second rinse process, the exposure liquid LQ is used as the rinse liquid LH. In the second rinse process, the cleaning apparatus 600 performs the recovery of the liquid (including at least one of the second cleaning liquid LC2 and the rinse liquid LH) from the recovery port 65 (suction port 67) concurrently with the supply of the rinse liquid LH (exposure liquid LQ) from the supply port 64.

After the liquid immersion member 7 is cleaned with the second cleaning liquid LC2, the rinse liquid LH is supplied to the liquid immersion member 7, whereby the second cleaning liquid LC2 remaining in the surface of the liquid immersion member 7 is removed. In the present embodiment, since the rinse liquid LH is pure water and the second cleaning liquid LC2 is a hydrogen peroxide solution, the rinse liquid LH can remove the second cleaning liquid LC2 remaining in the liquid immersion member 7.

The cleaning apparatus 600 performs the recovery of the liquid from the recovery port 65 (suction port 67) concurrently with the supply of the rinse liquid LH from the supply port 64. The liquid recovered from the suction port 67 includes the rinse liquid LH supplied from the supply port 64 and the second cleaning liquid LC2 remaining in the liquid immersion member 7. The supply of the rinse liquid LH from the supply port 64 and the recovery of the liquid from the recovery port 65 (suction port 67) are performed for a predetermined period of time, whereby the second cleaning liquid LC2 is removed from the liquid immersion member 7.

In the second rinse process, the rinse liquid LH (exposure liquid LQ) from the supply source LQS is supplied from the supply port 64.

The liquid recovered from the suction port 67 flows through the channel 25RB. In the present embodiment, the channel is adjusted so that the liquid recovered from the suction port 67 is discharged from the second discharge port 32B. The channel switching mechanism 30B adjusts the channel so that the rinse liquid LH recovered from the suction port 67 is discharged from the second discharge port 3213. During the supply and the recovery of the rinse liquid LH, the rinse liquid LH recovered from the suction port 67 is discharged from the second discharge port 32B. The liquid discharged from the second discharge port 32B is supplied to the second receiving member 42B.

In the present embodiment, the cleaning apparatus 600 performs the concurrent operation of the supply of the rinse liquid LH from the supply port 64 and the recovery of the rinse liquid LH from the suction port 67 so that the concentration of the second cleaning liquid LC2 contained in the rinse liquid LH recovered from the suction port 67 becomes a predetermined concentration or less which is previously determined.

In the present embodiment, in the second rinse process, the characteristics of the liquid recovered from the suction port 67 are detected by the detection apparatus 40B. The detection apparatus 40B detects the characteristics of the liquid which is recovered from the suction port 67 and flows through the channel 25RB. In the present embodiment, the detection apparatus 40B detects the conductivity of the rinse liquid LH recovered from the suction port 67. The detection result of the detection apparatus 40B is output to the control apparatus 8. In the present embodiment, the control apparatus 8 seeks the concentration of the second cleaning liquid LC2 contained in the rinse liquid LH recovered from the suction port 67 and also the concentration of the hydrogen peroxide contained in the rinse liquid LH, on the basis of the detection result of the detection apparatus 40B, and performs the concurrent operation of the supply of the rinse liquid LH from the supply port 64 and the recovery of the rinse liquid LH from the suction port 67 for a predetermined period of time, until the concentration becomes a predetermined concentration or less. In the present embodiment, at least until the concentration of the hydrogen peroxide contained in the recovered rinse liquid LH becomes an acceptable value or less which is previously determined, the second rinse process (the supply and the recovery of the rinse liquid LH) is continued. For example, until the concentration of the hydrogen peroxide contained in rinse liquid LH recovered from the suction port 67 becomes 1% or less, the second rinse process is continued. During the recovery of the rinse liquid LH from the suction port 67, the recovered rinse liquid LH is discharged from the second discharge port 32B.

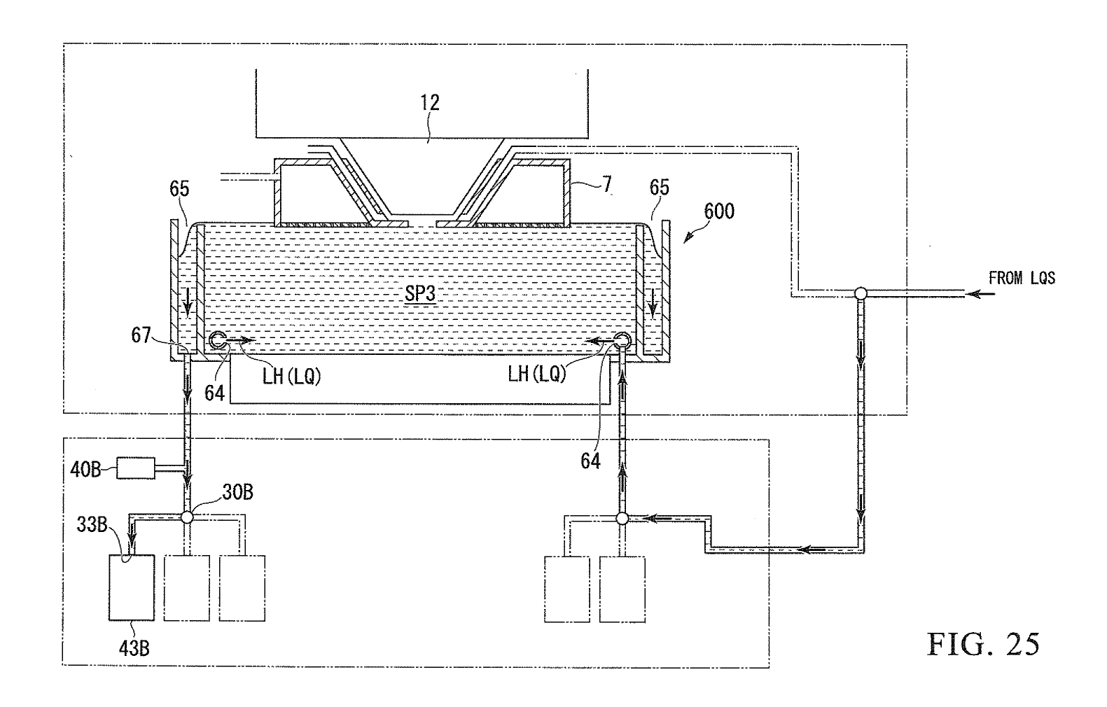

As mentioned above, in the present embodiment, the second rinse process includes a process of discharging the rinse liquid LH, recovered from the suction port 67, from the second discharge port 32B. In the present embodiment, after the second rinse process, the third rinse process is performed (step SB6). As shown in FIG. 25, in the present embodiment, the third rinse process includes a process of discharging the rinse liquid LH, recovered from the suction port 67, from the third discharge port 33B.

In the present embodiment, the second rinse process including the operation of supplying the rinse liquid LH from the supply port 64, the operation of recovering the rinse liquid LH from the suction port 67, and the operation of discharging the recovered rinse liquid LH from the second discharge port 32B is performed at least until the concentration of the second cleaning liquid LC2 contained in the rinse liquid LH reaches a predetermined concentration. That is, until the concentration of the second cleaning liquid LC2 contained in the recovered rinse liquid LH reaches a predetermined concentration, the process of discharging the rinse liquid LH from the second discharge port 32B is performed on the recovered rinse liquid LH.

After the concentration of the second cleaning liquid LC2 contained in the recovered rinse liquid LH becomes a predetermined concentration or less, the cleaning apparatus 600 controls the channel switching mechanism 30B while performing the concurrent operation of the supply of the rinse liquid LH from the supply port 64 and the recovery of the rinse liquid LH from the suction port 67, and adjusts the channel so that the rinse liquid LH recovered from the suction port 67 is discharged from the third discharge port 33B. That is, the cleaning apparatus 600 seeks the concentration of the second cleaning liquid LC2 contained in the recovered rinse liquid LH from the detection result of the detection apparatus 40B, and controls the channel switching mechanism 30B on the basis of the concentration thereof, to thereby perform switching from the discharge operation of the second discharge port 32B to the discharge operation of the third discharge port 33B.

In the present embodiment, the cleaning apparatus 600 discharges the recovered rinse liquid LH from the second discharge port 32B until the concentration of the second cleaning liquid LC2 contained in the recovered rinse liquid LH reaches a predetermined concentration, and discharges the recovered rinse liquid LH from the third discharge port 33B after the concentration of the second cleaning liquid LC2 becomes a predetermined concentration or less.

Even after the concentration of the second cleaning liquid LC2 contained in the recovered rinse liquid LH becomes a predetermined concentration or less, the cleaning apparatus 600 performs the concurrent operation of the supply of the rinse liquid LH from the supply port 64 and the recovery of the rinse liquid LH from the suction port 67. After the concentration of the second cleaning liquid LC2 contained in the recovered rinse liquid LH becomes a predetermined concentration, the process of discharging the rinse liquid LH from the third discharge port 33B is performed on the recovered rinse liquid LH.

In this manner, in the present embodiment, the second rinse process and the third rinse process are continuously performed. In the second rinse process, the rinse liquid LH is discharged from the second discharge port 32B during the recovery of the rinse liquid LH from the suction port 67, and the channel switching mechanism 30B is controlled in the recovery thereof. Subsequent to the discharge thereof from the second discharge port 32B, in the third rinse process, the rinse liquid LH is discharged from the third discharge port 33B. The concentration of the second cleaning liquid LC2 contained in the rinse liquid LH discharged from the third discharge port 33B is a predetermined concentration or less. During the recovery of the rinse liquid LH, the hydrogen peroxide contained in the discharged rinse liquid LH has a lower concentration at the time of the discharge thereof from the third discharge port 33B than that at the time of the discharge thereof from the third discharge port 32B. In addition, the concentration of the hydrogen peroxide contained in the rinse liquid LH discharged from the third discharge port 33B is lower than the concentration of the hydrogen peroxide contained in the second cleaning liquid LC2 supplied from the supply port 64 to the liquid immersion member 7.

In the present embodiment, the rinse liquid LH recovered from the suction port 67 in the first period of time in which the second rinse process after the second cleaning process is performed is discharged from the second discharge port 32B, and the rinse liquid LH recovered from the suction port 67 in the second period of time in which the third rinse process after the second rinse process is performed is discharged from the third discharge port 33B. The hydrogen peroxide contained in the recovered rinse liquid LH has a lower concentration at the time of the recovery thereof in the third rinse process (second period of time) than that at the time of the recovery thereof in the second rinse process (first period of time). Thereby, the discharge of the second cleaning liquid LC2 from the third discharge port 33B is suppressed in the third rinse process. Since the second rinse process is performed so that the discharge of the second cleaning liquid LC2 from the third discharge port 33B is suppressed in the third rinse process, it is possible to reduce the concentration of the second cleaning liquid LC2 (hydrogen peroxide) contained in the rinse liquid LH discharged from, for example, the third discharge port 33B. In addition, it is possible to reduce the concentration of the second cleaning liquid LC2 contained in the rinse liquid LH (exposure liquid LQ) of, for example, the third receiving member 43B. Thereby, it is possible to smoothly perform the process (waste liquid process) of the rinse liquid LH discharged from the third discharge port 33.

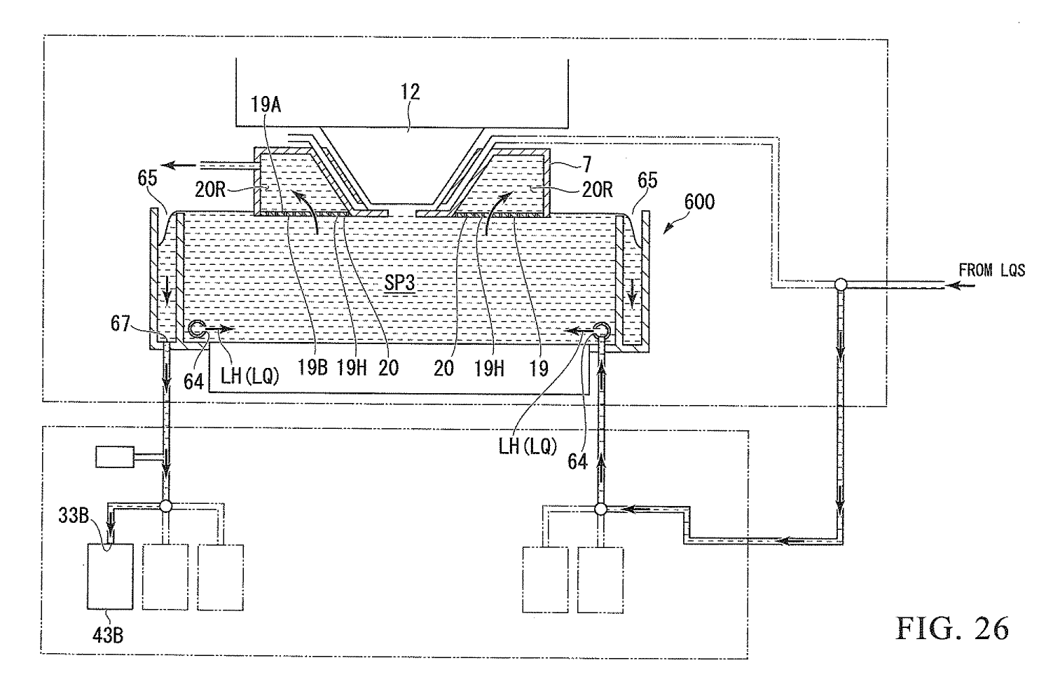

In the present embodiment, after the third rinse process, the fourth rinse process is performed (step SB7). As shown in FIG. 26, in the present embodiment, the fourth rinse process includes a process of recovering the rinse liquid LH of the space SP3 from the recovery port 20 of the liquid immersion member 7.

As shown in FIGS. 21 to 25, in the present embodiment, in the first cleaning process (step SB2), the first rinse process (step SB3), the second cleaning process (step SB4), the second rinse process (step SB5), and the third rinse process (step SB6), the supply of the liquid from the first and second supply ports 21 and 22 of the liquid immersion member 7 may not be performed, and the recovery of the liquid from the recovery port 20 also may not be performed.

In the present embodiment, the fourth rinse process includes an operation of supplying the rinse liquid LH from the supply port 64, an operation of recovering at least a portion of the rinse liquid LH, supplied from the supply port 64, from the recovery port 65 (suction port 67), an operation of discharging the rinse liquid LH, recovered from the suction port 67, from the third discharge port 33B, and an operation of recovering at least a portion of the rinse liquid LH, supplied from the supply port 64, from the recovery port 20 of the liquid immersion member 7. The fourth rinse process is performed after the concentration of the second cleaning liquid LC2 contained in the rinse liquid LH recovered from the suction port 67 and the concentration of the second cleaning liquid LC2 contained in the rinse liquid LH existing in the space SP3 become a predetermined concentration or less. The concentration of the second cleaning liquid LC2 contained in the rinse liquid LH recovered from the recovery port 20 is a predetermined concentration or less. Furthermore, the above-mentioned process may be performed after the concentration of the second cleaning liquid LC2 contained in the rinse liquid LH existing in the space SP3 (the concentration of the second cleaning liquid LC2 contained in the rinse liquid LH recovered from the recovery port 20) becomes less than the predetermined concentration.

In the present embodiment, the third rinse process and the fourth rinse process are continuously performed. In the third rinse process, the operation of supplying the rinse liquid LH from the supply port 64, the operation of recovering at least a portion of the rinse liquid LH, supplied from the supply port 64, from the recovery port 65 (suction port 67), and the operation of discharging the rinse liquid LH, recovered from the suction port 67, from the third discharge port 33B are performed, and the operation (that is, fourth rinse process) of recovering the rinse liquid LH from the recovery port 20 is started while continuing these operations. Furthermore, in the fourth rinse process, the recovery (suction) of the rinse liquid LH from the second supply port 22 may be performed.

The fourth rinse process is performed, whereby it is possible to rinse, for example, the inner surface of the hole 19H, the upper surface 19A and the like of the porous member 19 with the rinse liquid LH. In addition, it is possible to supply the rinse liquid LH to the inner surface of the third interior channel 20R.

After the fourth rinse process is performed for a predetermined period of time, the supply of the rinse liquid LH from the supply port 64 is stopped. The rinse liquid LH existing in the space SP3 is recovered from the recovery port 65 (suction port 67). In addition, in the present embodiment, the rinse liquid LH existing in the space SP3 is recovered even from the recovery port 20 of the liquid immersion member 7.

After the fourth rinse process is terminated and the rinse liquid LH of the space SP3 is recovered, the cleaning apparatus 600 is unloaded. The unloading of the cleaning apparatus 600 may be performed by, for example, an operator, and may be performed using a predetermined transport device.

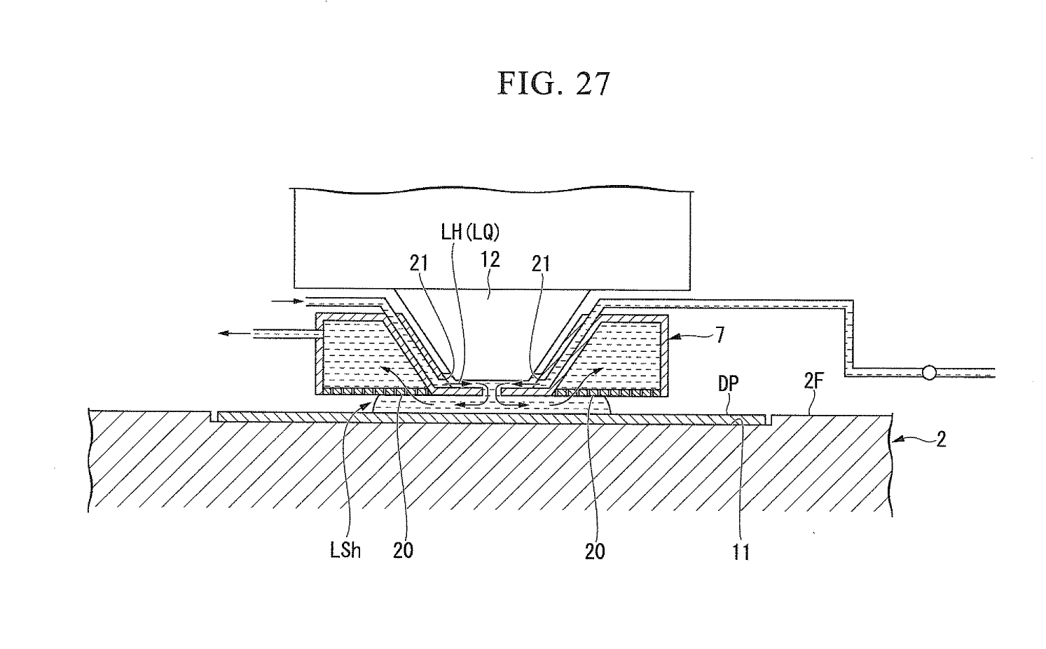

After the fourth rinse process is terminated and the cleaning apparatus 600 is unloaded, as shown in FIG. 27, the dummy substrate DP held in the substrate stage 2 is disposed so as to face the liquid immersion member 7. In the state where the liquid immersion member 7 and the dummy substrate DP face each other, the control apparatus 8 starts the fifth rinse process (step SB8). In the state where the dummy substrate DP is disposed facing the liquid immersion member 7, the fifth rinse process includes an operation of supplying the rinse liquid LH (exposure liquid LQ) from the first supply port 21 of the liquid immersion member 7 and an operation of recovering the rinse liquid LH from the recovery port 20 concurrently with the supply thereof. Thereby, the liquid immersion member 7 is rinsed.

Furthermore, in the state where the liquid immersion space LSh is formed between the last optical element 12 and the liquid immersion member 7 and the dummy substrate DP, the dummy substrate DP may or may not be moved within the XY plane by controlling the substrate stage 2.

Furthermore, the movement range of the dummy substrate DP (substrate stage 2) with respect to the liquid immersion member 7 may be controlled so that the liquid immersion space LSh is formed only on the dummy substrate DP and the rinse liquid LH of the liquid immersion space LSh is not in contact with the upper surface 2F of the outside of the dummy substrate DP, and the dummy substrate DP (substrate stage 2) may be moved so that the rinse liquid LH is in contact with the upper surface 2F.

Furthermore, the supply of the rinse liquid LH from the first supply port 21 and the recovery of the rinse liquid LH from the recovery port 20 may be performed in the state where the liquid immersion member 7 and the upper surface 2F of the substrate stage 2 face each other, and may be performed in the state where the liquid immersion member 7 and the upper surface 3F of the measurement stage 3 face each other.

In the present embodiment, the first process is performed on the rinse liquid LH discharged from the second discharge port 32B in the second rinse process, and the second process different from the first process is performed on the rinse liquid LH discharged from the third discharge port 33B in the third and fourth rinse processes. The concentration of the hydrogen peroxide contained in the rinse liquid LH discharged from the second discharge port 32B is high, and the concentration of the hydrogen peroxide contained in the rinse liquid LH discharged from the third discharge port 33B is low.

For example, the second cleaning liquid LC2 discharged from the second discharge port 32B is discarded. In addition, the rinse liquid LH discharged from the first discharge port 31B is also discarded.

On the other hand, the rinse liquid LH discharged from the third discharge port 33B may be reused as the exposure liquid LQ without being discarded, and may be used in order to adjust the temperature of the drive systems 4 and 5.

Furthermore, the rinse liquid LH discharged from the third discharge port 33B may be discarded. The number of processes until the rinse liquid LH discharged from the third discharge port 33B is discarded is smaller than the number of processes until the rinse liquid LH discharged from the second discharge port 32B is discarded.

In addition, in the present embodiment, the rinse liquid LH discharged from the second discharge port 32B is received in the second receiving member 42B, and the rinse liquid LH discharged from the third discharge port 33B is received in the third receiving member 43B. At the time of the discarding, the process for the liquid received in the third receiving member 43B is simplified.

In the present embodiment, since the discharge ports that discharge the recovered rinse liquid LH are separated from each other in the second rinse process and the third rinse process, it is possible to sufficiently reduce the concentration of the second cleaning liquid LC2 contained in the rinse liquid LH discharged from the third discharge port 33B in the third rinse process. Therefore, it is possible to smoothly perform the process of the rinse liquid LH.

After the fifth rinse process is terminated, the control apparatus 8 performs a process of unloading the dummy substrate DP from the substrate stage 2. The control apparatus 8 moves the substrate stage 2 to the substrate replacement position in order to unload the dummy substrate DP from the substrate stage 2 (substrate holding portion 11).

After the dummy substrate DP is unloaded from the substrate stage 2, the control apparatus 8 may perform the exposure sequence including the exposure process of the substrate P.

As described above, even in the present embodiment, it is possible to smoothly perform the process of the rinse liquid LH. Therefore, it is possible to suppress, for example, a decrease in the operation rate of the device manufacturing system SYS including the exposure apparatus EX, an increase in the process costs and the like.

Furthermore, as an example of a process in which the concentration of the second cleaning liquid LC2 contained in the recovered rinse liquid LH is set to a predetermined concentration or less, for example, after the second cleaning process is terminated (after the supply of the second cleaning liquid LC2 is stopped) and before the second rinse process is started (before the supply of the rinse liquid LH is started), a process may be performed in which the stop period where the supply of the rinse liquid LH to the liquid immersion member 7 is stopped is set. Thereby, for example, the second cleaning liquid LC2 remaining in the liquid immersion member 7 evaporates, and is removed from the liquid immersion member 7.

Furthermore, as a process in which the concentration of the second cleaning liquid LC2 contained in the recovered rinse liquid LH is set to a predetermined concentration or less, a process may be performed in which a catalyst capable of reducing hydrogen peroxide is added to, for example, the rinse liquid LH.

Furthermore, the cleaning apparatus 600 may perform the same sequence as the cleaning sequence which is described in the second embodiment mentioned above.

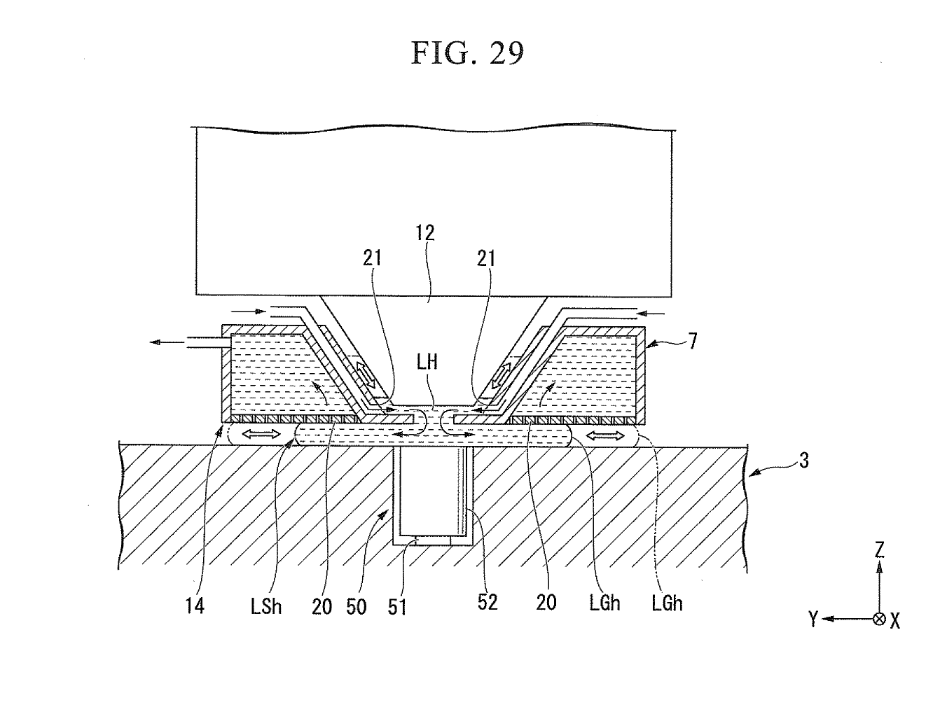

Furthermore, for example, in the fifth rinse process, the vibration may be given to the rinse liquid LH supplied to the liquid immersion member 7. For example, as shown in FIG. 29, the vibratory member 52 of the ultrasonic generator 50 disposed in the measurement stage 3 is disposed so as to face the liquid immersion member 7, and the supply of the rinse liquid LH from the first supply port 21 and the recovery of the rinse liquid LH from the recovery port 20 are performed, whereby the vibratory member 52 may be vibrated in the state where the liquid immersion space LSh is formed between the liquid immersion member 7 and the vibratory member 52 and the measurement stage 3 by the rinse liquid LH. Thereby, the rinse liquid LH which is in contact with the liquid immersion member 7 are vibrated.

In addition, in the fifth rinse process (step SB8), the size of the liquid immersion space LSh may be adjusted. In the present embodiment, the size of the liquid immersion space LSh means a size within the XY plane which is substantially parallel to the lower surface 14, between the lower surface 14 and the upper surface of the object facing the lower surface 14. For example, it is possible to enlarge the liquid immersion space LSh by increasing the supply amount of the rinse liquid LH per unit time from the first supply port 21, and it is possible to reduce the liquid immersion space LSh by decreasing the supply amount thereof. In addition, it is possible to enlarge the liquid immersion space LSh by decreasing the recovery amount of the rinse liquid LH per unit time from the recovery port 20, and it is possible to reduce the liquid immersion space LSh by increasing the recovery amount thereof. Of course, both of the supply amount of the rinse liquid LH and the recovery amount thereof may be adjusted. The position of the interface LGh (position in the radiation direction with respect to the light path of the exposure light EL) is changed between the lower surface 14 and the upper surface of the object by changing the size of the liquid immersion space LSh. Thereby, it is possible to enhance the rinse effect.

Furthermore, in third embodiment, the liquid (at least one of the first cleaning liquid LC1, the second cleaning liquid LC2, and the rinse liquid LH) may be vibrated which is existing between the liquid immersion member 7 and the cleaning apparatus 600.

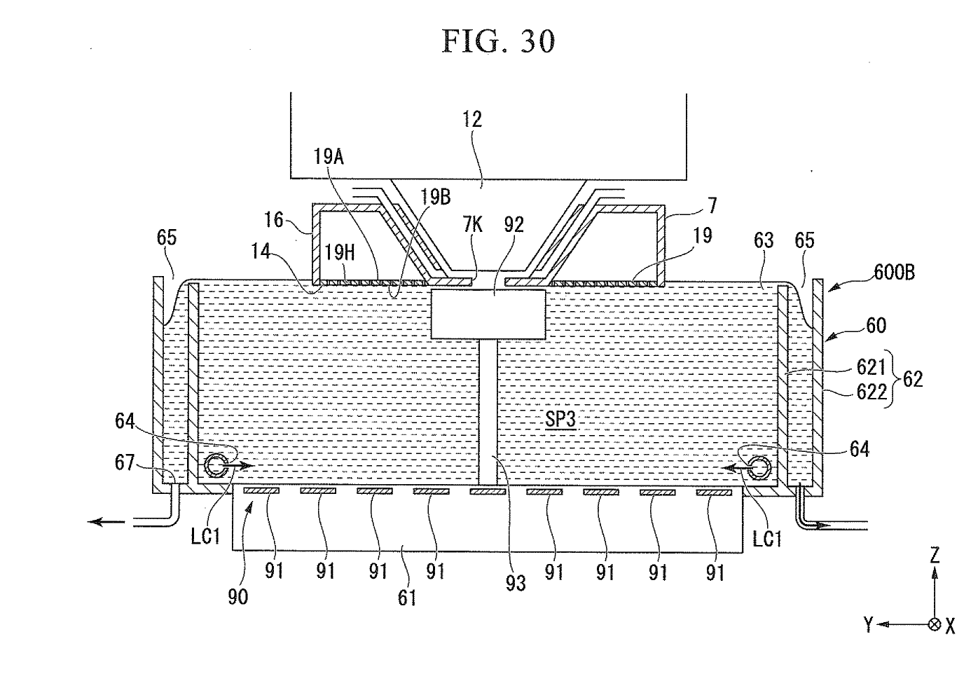

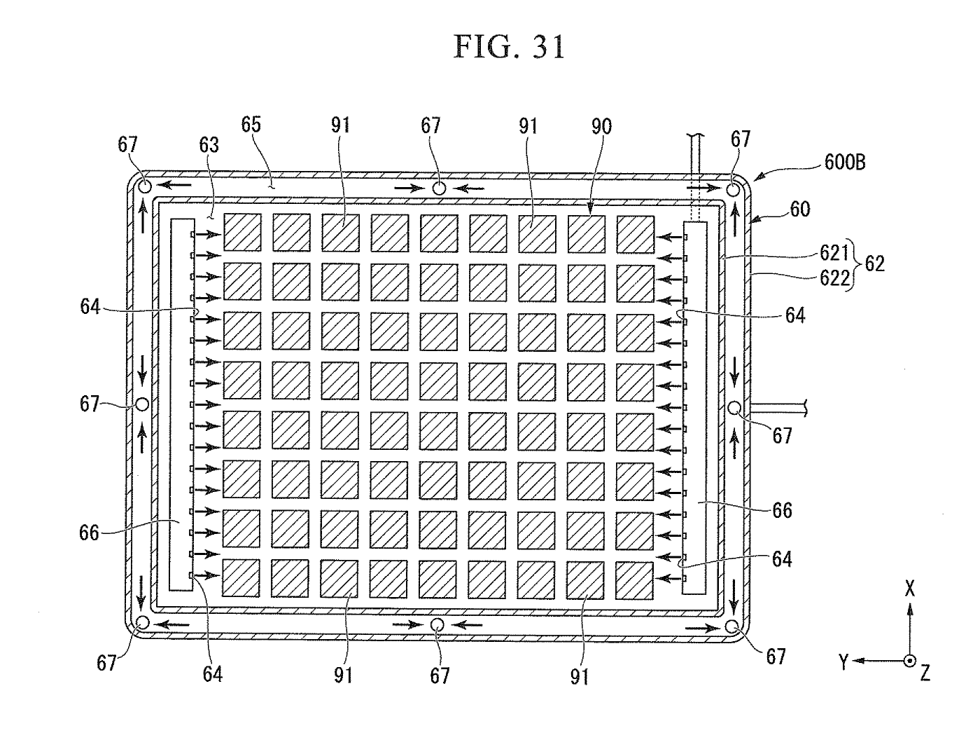

FIGS. 30 and 31 are diagrams illustrating an example of a cleaning apparatus 600B including an ultrasonic generator 90 which is capable of vibrating the liquid. FIG. 30 is a side cross-sectional view of the cleaning apparatus 600B, and FIG. 31 is a plan view when it is seen from the upper side.

In FIGS. 30 and 31, the ultrasonic generator 90 includes vibrators 91, disposed on the upper surface of the base member 61, that generate ultrasonic vibrations of a predetermined vibration frequency. A plurality of vibrators 91 is disposed on the upper surface of the base member 61. Each of a plurality of vibrators 91 is disposed so as to face the space SP3. The vibrators 91 include, for example, a piezoelectric element, and are driven on the basis of power supplied from a power-supply device.

As shown in FIG. 30, the cleaning apparatus 600B includes a cover member 92 that covers the opening 7K of the liquid immersion member 7. The cover member 92 has an upper surface capable of facing the lower surface 14 of the liquid immersion member 7. The upper surface of the cover member 92 is sufficiently larger than the opening 7K, and can cover the opening 7K. In addition, the upper surface of the cover member 92 is smaller than the lower surface 14. In the present embodiment, the upper surface of the cover member 92 has a size which is able to be disposed in the inside of the lower surface 19B of the porous member 19. In other words, the cover member 92 has a size capable of covering the opening 7K without covering the porous member 19 (without facing the porous member 19).

In the present embodiment, the cover member 92 is supported by a support member 93. The support member 93 supports the cover member 92 so that the cover member 92 covers the opening 7K in the liquid and does not cover the porous member 19.

Hereinafter, a description will be made of an example of a process in which the liquid immersion member 7 is cleaned with the first cleaning liquid LC1 supplied to the space SP3 of the cleaning apparatus 600B. In order to start the first cleaning process using the first cleaning liquid LC1, the cleaning apparatus 600B performs the supply of the first cleaning liquid LC1 from the supply port 64 and the recovery of the first cleaning liquid LC1 from the recovery port 65 (suction port 67) in the state where the opening 7K is covered with the cover member 92. The first cleaning liquid LC1 of the space SP3 is in contact with at least a portion of the lower surface 14 of the liquid immersion member 7.

The cleaning apparatus 600B brings the ultrasonic generator 90 into operation, and gives the ultrasonic vibration to the first cleaning liquid LC1 of the space SP3 which is in contact with the liquid immersion member 7. Thereby, the liquid immersion member 7 is cleaned.

The ultrasonic vibration is given to the first cleaning liquid LC1, whereby it is possible to enhance the cleaning effect. For example, it is possible to introduce at least a portion of the first cleaning liquid LC1 of the space SP3 into the hole 19H of the porous member 19. Thereby, the lower surface 19B of the porous member 19 and the inner surface of the hole 19H are cleaned with the first cleaning liquid LC1. In addition, the upper surface 19A is also cleaned with the first cleaning liquid LC1.

In the present embodiment, since the cover member 92 is provided, it is possible to prevent the first cleaning liquid LC1 of the space SP3 from passing through the opening 7K. Therefore, the first cleaning liquid LC1 is prevented from being in contact with the last optical element 12, or from infiltrating between the lateral side of the last optical element 12 and the inside surface of the liquid immersion member 7 (main body portion 16). For example, even when there is a possibility that the ultrasonic vibration generated from the ultrasonic generator 90 may generate a mist of the first cleaning liquid LC1, the opening 7K is covered with the cover member 92, and thus it is possible to prevent the mist of the first cleaning liquid LC1 from passing through the opening 7K.

Furthermore, here, the case has been described, by way of example, in which the first cleaning liquid LC1 are vibrated in the first cleaning process (step SB2). However, of course, the second cleaning liquid LC2 may be vibrated in the second cleaning process (step SB4), and the rinse liquid LH may be vibrated in at least a portion of the first rinse process (step SB3), the second rinse process (step SB5), the third rinse process (step SB6), and the fourth rinse process (step SB7).

Furthermore, for example, in each of the steps SB2 to SB7, the conditions of the liquid being vibrated (at least one of the first cleaning liquid LC1, the second cleaning liquid LC2, and the rinse liquid LH) may be changed. For example, the rinse liquid LH may be vibrated at the vibration of the first vibration frequency in the second rinse process, the rinse liquid LH may be vibrated at the vibration of the second the vibration frequency different from the first the vibration frequency in the third rinse process, and the rinse liquid LH may be vibrated at the vibration of the third the vibration frequency different from the first and second vibration frequencies in the fourth rinse process. In addition, the vibration conditions of the rinse liquid LH may be changed, for example, in the middle of the period of time in which the second rinse process is performed. Of course, the vibration conditions may be changed in the middle of the period of time in which the third rinse process is performed, and the vibration conditions may be changed in the middle of the period of time in which the fourth rinse process is performed.

Furthermore, in the present embodiment, although the liquid is not supplied through the liquid immersion member 7 in the first cleaning process, the first rinse process, the second cleaning process, the second rinse process, the third rinse process, and the fourth rinse process, the liquid may be supplied through the liquid immersion member 7.

For example, in the first cleaning process, the first cleaning liquid LC1 may be supplied from the second supply port 22 to the space SP3. In addition, the supply of the first cleaning liquid LC1 from the supply port 64 may be performed concurrently with the supply of the first cleaning liquid LC1 from the second supply port 22 to the space SP3, or may be stopped. Similarly, for example, in the second cleaning process, the second cleaning liquid LC2 may be supplied from the second supply port 22 to the space SP3. In addition, the supply of the second cleaning liquid LC2 from the supply port 64 may be performed concurrently with the supply of the second cleaning liquid LC2 from the second supply port 22 to the space SP3, or may be stopped.

In addition, in at least a portion of the first, second, third, and fourth rinse processes, the rinse liquid LH may be supplied from the first supply port 21 to the space SP3. In addition, the supply of the rinse liquid LH from the supply port 64 may be performed concurrently with the supply of the rinse liquid LH from the first supply port 21 to the space SP3, or may be stopped.

Furthermore, in the present embodiment, although the liquid is not recovered through the liquid immersion member 7 in the first cleaning process, the first rinse process, the second cleaning process, the second rinse process, and the third rinse process, the liquid may be recovered through the liquid immersion member 7.

For example, in the first cleaning process, the first cleaning liquid LC1 of the space SP3 may be recovered from the recovery port 20. In addition, the first cleaning liquid LC1 of the space SP3 may or may not be recovered from the recovery port 65 (suction port 67) concurrently with the operation of recovering the first cleaning liquid LC1 of the space SP3 from the recovery port 20. Similarly, for example, in the second cleaning process, the second cleaning liquid LC2 of the space SP3 may be recovered from the recovery port 20. In addition, the second cleaning liquid LC2 of the space SP3 may or may not be recovered from the recovery port 65 (suction port 67) concurrently with the operation of recovering the second cleaning liquid LC of the space SP3 from the recovery port 20.

In addition, in at least a portion of the first, second, and third rinse processes, the rinse liquid LH of the space SP3 may be recovered from the recovery port 20. In addition, the rinse liquid LH of the space SP3 may or may not be recovered from the recovery port 65 (suction port 67) concurrently with the operation of recovering the rinse liquid LH of the space SP3 from the recovery port 20.

Furthermore, in at least a portion of the first, second and third rinse processes, the rinse liquid LH and the liquid immersion member 7 may not be in contact with each other. For example, even when the rinse liquid LH and the liquid immersion member 7 are not in contact with each other, it is possible to remove the liquid remaining in, for example, the first sidewall portion 621 by performing the supply and the recovery of the rinse liquid LH to the space SP3.

Furthermore, the liquid used as the first cleaning liquid LC1 is not limited to an alkaline solution, but may be a neutral and acidic solution. In addition, the liquid used as the second cleaning liquid LC2 is not limited to an acidic solution, but may be a neutral and alkaline solution. In addition, after the acidic liquid is used as the first cleaning liquid LC2, the alkaline liquid may be used as the second cleaning liquid.

Furthermore, in the above-mentioned embodiment, although the conductivity of the liquid is detected by the detection apparatus (40, 40B) in order to detect the concentration, the characteristics of the liquid detected by the detection apparatus in order to detect the concentration may not be the conductivity of the liquid. For example, the pH value of the liquid may be detected in order to detect the concentration. In this case, the detection apparatus may include a pH meter.

In addition, in the above-mentioned embodiment, although the characteristics of the liquid recovered by the detection apparatus (40, 40B) in order to detect the concentration are detected, the above-mentioned concentration may be estimated from the amount of the recovered liquid, or the elapsed time after the recovery operation is started. For example, in the first rinse process (step SA3) of the first embodiment, it may be determined, from the recovery amount of the rinse liquid LH from the recovery port 20 or the time after the recovery operation is started, that the concentration of the alkali of the rinse liquid LH flowing through the third channel 25R becomes a predetermined value or less. In this case, the detection apparatus may be omitted, and a flow meter may be disposed in the third channel 25R.

Furthermore, in the above-mentioned embodiment, in the cleaning sequence, it is preferable that before the exposure sequence including the exposure process of the substrate P is performed, foreign substances are eliminated in the liquid immersion spaces (LT1, LT2, LSh and the like) formed between the liquid immersion member 7 and the object (such as the dummy substrate DP), or the ratio of the foreign substances contained in the liquid immersion space becomes a certain predetermined value or less. For example, the ratio of the foreign substances contained in the liquid immersion space may be calculated from the recovered rinse liquid LH. For example, in the rinse process, the ratio of the foreign substances contained in the recovered rinse liquid LH is detected, and the rinse process may be stopped after it is confirmed that the ratio becomes a predetermined value. In addition, the rinse process may be performed on the basis of the rinse process time, previously calculated, until the ratio becomes a predetermined value or less. In addition, for example, in the middle of the cleaning sequence, the liquid immersion spaces (LT1, LT2, LSh and the like) are formed between the liquid immersion member 7 and the object (for example, dummy substrate), and the ratio of the foreign substances contained in the liquid immersion spaces (LT1, LT2, LSh and the like) may be calculated from the number of foreign substances attached per certain unit area on the object.

Furthermore, in the above-mentioned first to third embodiments, although the light path on the emission side (image plane side) of the last optical element 12 of the projection optical system PL is filled with the exposure liquid LQ, it is possible to adopt the projection optical system PL in which the light path on the incident side (object plane side) of the last optical element 12 is also filled with the exposure liquid LQ, for example, as disclosed in International Publication No. 2004/019128.

Furthermore, in each of the present embodiments mentioned above, although water is used as the exposure liquid LQ, a liquid other than water may be used. It is preferable that the exposure liquid LQ is transmissive to the exposure light EL, has a high refractive index with respect to the exposure light EL, and is stable with respect to a film such as a photosensitive material (photoresist) of which the projection optical system PL or the surface of the substrate P is formed. For example, hydrofluoroether (HFE), perfluorinated polyether (PFPE), fomblin oil and the like can also be used as the first liquid LQ1. In addition, various fluids, for example, a supercritical fluid, can also be used as the first liquid LQ1.

Furthermore, as the substrate P of each of the present embodiments mentioned above, not only a semiconductor wafer for a semiconductor device, but also a glass substrate for a display device, a ceramic wafer for a thin-film magnetic head, or an original plate (synthetic silica, silicon wafer) of a mask or a reticle used in the exposure apparatus and the like are applied.

The exposure apparatus EX can also be applied to a step-and-repeat type projection exposure apparatus (stepper) in which the sequential step movement is performed on the substrate P by collectively exposing the patterns of the mask M in the state where the mask M and the substrate P are stopped, in addition to a step-and-scan type scanning exposure apparatus (scanning stepper) that scans and exposes the pattern of the mask M by synchronously moving the mask M and the substrate P.

Further, in the step-and-repeat type exposure, after a reduced image of a first pattern is transferred onto the substrate P using the projection optical system in the state where the first pattern and the substrate P are substantially stopped, a reduced image of a second pattern may be partially overlapped with the first pattern using the projection optical system to perform collective exposure onto the substrate P in the state where the second pattern and the substrate P are substantially stopped (stitch-type collective exposure apparatus). In addition, the stitch-type exposure apparatus can also be applied to a step-and-stitch type exposure apparatus which partially overlaps at least two patterns with each other on the substrate P to transfer them, and sequentially moves the substrate P.

In addition, for example, as disclosed in the Specification of U.S. Pat. No. 6,611,316, the present invention can also be applied to an exposure apparatus which synthesizes patterns of two masks on the substrate through the projection optical system, and almost simultaneously double-exposes one shot region on the substrate by one-time scanning exposure. In addition, the present invention can also be applied to a proximity-type exposure apparatus, a mirror projection aligner and the like.

Furthermore, the exposure apparatus EX may be an exposure apparatus which does not include the measurement stage 3.

Furthermore, the exposure apparatus EX may be a twin stage type exposure apparatus which includes a plurality of substrate stages without a measurement stage, as disclosed in the Specification of U.S. Pat. No. 6,341,007, the Specification of U.S. Pat. No. 6,208,407, the Specification of U.S. Pat. No. 6,262,796 and the like. In that case, the cleaning sequence may be performed by causing an arbitrary substrate stage, among a plurality of substrate stages, to face the liquid immersion member 7.

In addition, the present invention can also be applied to an exposure apparatus which includes a plurality of substrate stages and measurement stages.

The type of exposure apparatus EX is also not limited to a semiconductor device fabrication exposure apparatus that exposes the pattern of a semiconductor device on the substrate P, but can be widely adapted to exposure apparatuses that are used for fabricating, for example, liquid crystal devices or displays, and exposure apparatuses that are used for manufacturing thin film magnetic heads, image capturing devices (CCDs), micromachines, MEMS, DNA chips, reticles or masks, and the like.

Furthermore, in each of the embodiments discussed above, the position of each of the stages is measured using an interferometer system that includes laser interferometers, but the present invention is not limited thereto; for example, an encoder system that detects a scale (diffraction grating) provided to each of the stages may be used.

Furthermore, in the embodiments discussed above, an optically transmissive mask wherein a prescribed shielding pattern (or phase pattern or dimming pattern) is formed on an optically transmissive substrate is used; however, instead of such a mask, a variable shaped mask (also called an electronic mask, an active mask, or an image generator), wherein a transmissive pattern, a reflective pattern, or a light emitting pattern is formed based on electronic data of the pattern to be exposed, as disclosed in, for example, the Specification of U.S. Pat. No. 6,778,257, may be used. In addition, instead of a variable shaped mask that comprises a non-emissive type image display device, a pattern forming apparatus that includes a self-luminous type image display device may be provided.

In each of the embodiments mentioned above, although the exposure apparatus that includes the projection optical system PL has been described by way of example, but the present invention can be applied to an exposure apparatus and an exposing method that do not use the projection optical system PL. For example, the immersion space can be formed between an optical member such as a lens and the substrate, and the substrate can be radiated with the exposure light through that optical member.

In addition, the present invention can also be applied to an exposure apparatus (lithographic system) that, by forming interference fringes on the substrate P, exposes the substrate P with a line-and-space pattern, as disclosed in, for example, PCT International Publication No. WO2001/035168.

The exposure apparatus EX according to the embodiments mentioned above is manufactured by assembling various subsystems, including each of the components, so that predetermined mechanical, electrical, and optical accuracies are maintained. To ensure these various accuracies, adjustments are performed before and after this assembly, including an adjustment to achieve optical accuracy for the various optical systems, an adjustment to achieve the mechanical accuracy for the various mechanical systems, and an adjustment to achieve the electrical accuracy for the various electrical systems. The process of assembling the exposure apparatus from the various subsystems includes, for example, the connection of mechanical components, the wiring and connection of electrical circuits, and the piping and connection of the pneumatic circuits among the various subsystems. Naturally, prior to performing the process of assembling the exposure apparatus from these various subsystems, there are also processes of assembling each individual subsystem. When the process of assembling the exposure apparatus from the various subsystems is complete, a comprehensive adjustment is performed to ensure the various accuracies of the exposure apparatus as a whole. Furthermore, it is preferable to manufacture the exposure apparatus in a clean room in which, for example, the temperature and the cleanliness level are controlled.

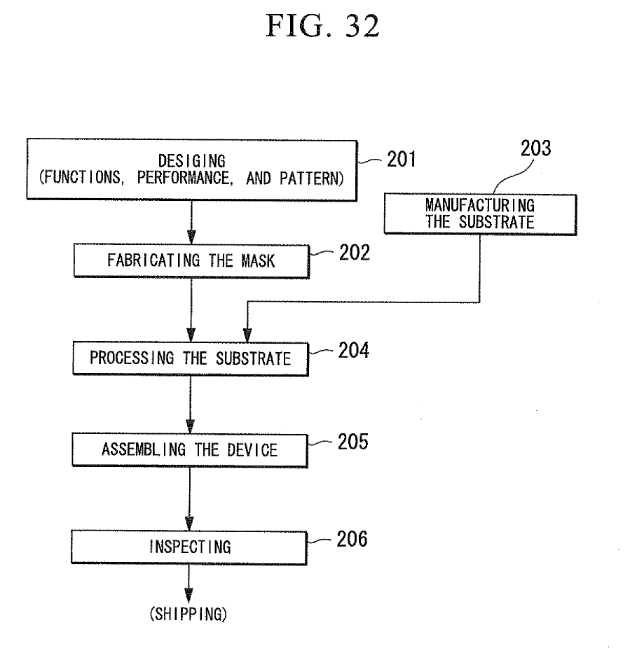

As shown in FIG. 32, a microdevice, such as a semiconductor device, is manufactured by a step 201 of designing the functions and performance of the microdevice, a step 202 of manufacturing the mask (reticle) based on this designing step, a step 203 of manufacturing the substrate P, which is the base material of the device, a substrate processing step 204 of a substrate process (exposure process) that includes, in accordance with the embodiments mentioned above, exposing the substrate P with the exposure light EL that emits from the pattern of the mask M and developing the exposed substrate P, a device assembling step 205 (which includes fabrication processes such as dicing, bonding, and packaging processes), an inspecting step 206, and the like. The substrate processing step includes a process of cleaning the liquid immersion member 7 and the like in accordance with the above-mentioned embodiments, and the substrate P is exposed by the exposure light EL using the cleaned liquid immersion member 7 and the like.

Furthermore, the features of each of the embodiments mentioned above can be combined as appropriate. In addition, there may be cases in which some of the components are not used. In addition, each disclosure of every Japanese published patent application and U.S. patent related to the exposure apparatus recited in each of the embodiments, modified examples, and the like discussed above is hereby incorporated by reference in its entirety to the extent permitted by national laws and regulations.

1. A cleaning method of a liquid contact member, which is in contact with an exposure liquid, in an exposure apparatus that exposes a substrate with an exposure light through the exposure liquid, comprising:
cleaning the liquid contact member by supplying a first liquid for cleaning to the liquid contact member;
recovering the first liquid supplied to the liquid contact member;
supplying a second liquid different from the first liquid to the liquid contact member after the liquid contact member is cleaned with the first liquid;
recovering the second liquid supplied to the liquid contact member; and
performing a process in which a concentration of the first liquid comprised in the recovered second liquid is set to a predetermined concentration or less.

2. The cleaning method according to claim 1, further comprising: performing a first process on the recovered second liquid until the concentration of the first liquid reaches the predetermined concentration, and performing a second process different from the first process after the concentration of the first liquid becomes the predetermined concentration or less by the first process.

3. The cleaning method according to claim 1, wherein the supply and the recovery of the second liquid are concurrently performed, and the process in which the concentration is set to the predetermined concentration or less is performed concurrently with the supply and the recovery of the second liquid.

4. The cleaning method according to claim 3, wherein a concurrent operation of the supply and the recovery of the second liquid is continuously performed even after the process in which the concentration is set to the predetermined concentration or less.

5. The cleaning method according to according to claim 1, wherein the supply and the recovery of the second liquid are concurrently performed, and
the process in which the concentration is set to the predetermined concentration or less comprises performing the concurrent operation of the supply and the recovery of the second liquid for a predetermined period of time.

6. The cleaning method according to claim 1, further comprising discharging the second liquid from a first discharge port during the recovery of the second liquid, and discharging the second liquid from a second discharge port different from the first discharge port subsequently to the discharge from the first discharge port,
wherein the concentration of the first liquid comprised in the second liquid discharged from the second discharge port is the predetermined concentration or less.

7. The cleaning method according to claim 6, wherein the concentration of the first liquid comprised in the recovered second liquid is detected, and switching from the discharge operation of the first discharge port to the discharge operation of the second discharge port is performed on the basis of the detection result.

8. The cleaning method according to claim 6, wherein the recovered second liquid is discharged from the first discharge port until the concentration of the first liquid reaches the predetermined concentration, and is discharged from the second discharge port after the concentration of the first liquid becomes the predetermined concentration or less.

9. The cleaning method according to claim 1, wherein the process in which the concentration is set to the predetermined concentration or less comprises setting a stop period in which the liquid supply to the liquid contact member is stopped, after the supply of the first liquid is stopped and before the supply of the second liquid is started.

10. The cleaning method according to claim 9, wherein the stop period is set to be longer than a time taken until the first liquid starts to evaporate.

11. The cleaning method according to claim 9, wherein the supply of the second liquid is started after the stop period, and the stop period is continued until the concentration of the first liquid in the second liquid recovered immediately after the start of the supply becomes the predetermined concentration or less.

12. A cleaning method of a liquid contact member, which is in contact with an exposure liquid, in an exposure apparatus that exposes a substrate with an exposure light through the exposure liquid, comprising:
cleaning the liquid contact member by supplying a first liquid for cleaning to the liquid contact member;
supplying and recovering a second liquid different from the first liquid to and from the liquid contact member after the liquid contact member is cleaned with the first liquid; and
discharging the second liquid from a first discharge port during the recovery of the second liquid, and discharging the second liquid from a second discharge port different from the first discharge port subsequently to the discharge from the first discharge port.

13. The cleaning method according to claim 6, wherein the first liquid comprises a predetermined substance, and
during the recovery of the second liquid, the concentration of the predetermined substance comprised in the discharged second liquid is lower at the time of the discharge thereof from the second discharge port than that at the time of the discharge thereof from the first discharge port.

14. The cleaning method according to claim 6, wherein the first liquid comprises a predetermined substance, and
the concentration of the predetermined substance comprised in the second liquid discharged from the second discharge port is lower than the concentration of the predetermined substance comprised in the first liquid supplied to the liquid contact member.

15. The cleaning method according to claim 6, further comprising receiving the second liquid discharged from the first discharge port in a first receiving member, and
receiving the second liquid discharged from the second discharge port in a second receiving member different from the first receiving member.

16. The cleaning method according to claim 6, further comprising performing a first process on the second liquid discharged from the first discharge port, and
performing a second process different from the first process on the second liquid discharged from the second discharge port.

17. The cleaning method according to claim 6 further comprising recovering the supplied first liquid and discharging the recovered first liquid from the first discharge port.

18. The cleaning method according to claim 1, wherein the supplied second liquid is vibrated, and the vibration conditions of the second liquid are changed in the middle of the supply operation.

19. A cleaning method of a liquid contact member, which is in contact with an exposure liquid, in an exposure apparatus that exposes a substrate with an exposure light through the exposure liquid, comprising:
cleaning the liquid contact member by supplying a first liquid for cleaning to the liquid contact member;
supplying and recovering a second liquid different from the first liquid to and from the liquid contact member after the liquid contact member is cleaned with the first liquid;
performing a first process on the second liquid recovered in a first period of time of the operation of recovering the second liquid; and
performing a second process different from the first process on the second liquid recovered in a second period of time of the operation of recovering the second liquid after the first period of time.

20. The cleaning method according to claim 19, wherein the first period of time is shorter than the second period of time.

21. The cleaning method according to claim 19, wherein the first liquid comprises a predetermined substance, and
during the operation of recovering the second liquid, the concentration of the predetermined substance comprised in the recovered second liquid is lower at the time of the recovery thereof in the second period of time than that at time of the recovery thereof in the first period of time.

22. The cleaning method according to claim 19, wherein in at least the first period of time of the first and second periods of time, the second liquid supplied to the liquid contact member is vibrated.

23. The cleaning method according to claim 22, wherein in the second period of time, the second liquid supplied to the liquid contact member is vibrated in the conditions different from those of the first period of time.

24. The cleaning method claim 22, wherein in the second period of time, the second liquid supplied to the liquid contact member is vibrated, and the vibration conditions are changed in the middle of the second period of time.

25. The cleaning method according to claim 2, further comprising recovering the supplied first liquid and processing the recovered first liquid,
wherein the first process is the same as the process of the first liquid.

26. The cleaning method according to claim 2, further comprising recovering the supplied first liquid and processing the recovered first liquid,
wherein the second process is different from the process of the first liquid.

27. The cleaning method according to claim 2, wherein the second process has a number of steps smaller than that of the first process.

28. The cleaning method according to claim 27, wherein at least one of the first and second processes comprises a step of discarding the discharged second liquid.

29. The cleaning method according to claim 2, wherein each of the first and second processes comprises discarding the discharged second liquid, and
in the first process and the second process, the steps until the discharged second liquid is discarded are different from each other, and the second process has a number of steps smaller than that of the first process.

30. The cleaning method according to claim 1, wherein during the cleaning operation of the liquid contact member, the recovery of the first liquid is performed concurrently with the supply thereof.

31. The cleaning method of according to claim 1, wherein the supply and the recovery of the second liquid are concurrently performed.

32. The cleaning method according to claim 1, further comprising vibrating the first liquid supplied to the liquid contact member.

33. The cleaning method according to claim 1, wherein at least a portion of the first liquid is supplied to the liquid contact member through a supply channel different from a supply channel of the exposure liquid and/or the second liquid.

34. The cleaning method according to claim 33, further comprising discharging the first liquid remaining in the supply channel after the supply of the first liquid is stopped.

35. The cleaning method according to claim 34, wherein the remaining first liquid is discharged by depressurizing or pressurizing the supply channel.

36. The cleaning method according to claim 33, further comprising discharging the exposure liquid and/or the second liquid remaining in the supply channel after the supply of the exposure liquid and/or the second liquid is stopped.

37. The cleaning method according to claim 1, wherein the first liquid is supplied to the liquid contact member through a supply port different from that of the exposure liquid and/or the second liquid.

38. The cleaning method according to claim 1, wherein an emission surface of the exposure light is provided around an optical member which is in contact with the exposure liquid, and the supply and the recovery of the exposure liquid are performed through a liquid immersion member for holding the exposure liquid within a local region smaller than the substrate,
each of the first and second liquids is supplied in a state where an object is disposed facing the liquid immersion member, and
the liquid contact member comprises at least one of the liquid immersion member and the object.

39. The cleaning method according to claim 38, wherein the supply of at least one of the first and second liquids is performed from one side of the liquid immersion member and the object, and the recovery thereof is performed from the other side of the liquid immersion member and the object.

40. The cleaning method according to claim 38, wherein both of the supply and the recovery of at least one of the first and second liquids are performed from the one side of the liquid immersion member and the object.

41. The cleaning method according to claim 38, wherein the supply of the first liquid is performed through the liquid immersion member.

42. The cleaning method according to claim 38, wherein the supply of the second liquid is performed through the liquid immersion member.

43. The cleaning method according to claim 1, wherein the supply of the second liquid is performed through the same supply port as that of the exposure liquid.

44. The cleaning method according to claim 1, wherein the first liquid is an acidic liquid.

45. The cleaning method according to claim 44, wherein the acidic liquid comprises a hydrogen peroxide.

46. The cleaning method according to claim 1, wherein the first liquid is an aqueous solution, and the second liquid is a water.

47. The cleaning method according to claim 1, wherein the first liquid is an alkaline liquid, and
the method further comprising supplying an acidic liquid for cleaning the liquid contact member after the operation of recovering the second liquid.

48. The cleaning method according to claim 1, further comprising supplying a third liquid different from the first and second liquids to the liquid contact member in order to clean the liquid contact member, and recovering the supplied third liquid.

49. The cleaning method according to claim 48, further comprising starting the supply of the first liquid to the liquid contact member, after the liquid contact member is cleaned with the third liquid, and
performing a process of setting the concentration of the third liquid comprised in the recovered first liquid to a predetermined concentration or less.

50. The cleaning method according to claim 49, wherein the process in which the concentration is set to the predetermined concentration or less comprises supplying a fourth liquid different from the first and third liquids to the liquid contact member, and recovering the supplied fourth liquid.

51. The cleaning method according to claim 48, comprising:
supplying and recovering a fourth liquid different from the first and third liquids to and from the liquid contact member, after the liquid contact member is cleaned with the third liquid, and
discharging the fourth liquid from a third discharge port during the recovery of the fourth liquid, and discharging the fourth liquid from a fourth discharge port different from the third discharge port subsequently to the discharge from the third discharge port.

52. The cleaning method according to claim 48, comprising:
supplying and recovering a fourth liquid different from the first and third liquids to and from the liquid contact member, after the liquid contact member is cleaned with the third liquid,
performing a third process on liquid recovered in a third period of time of the operation of recovering the fourth liquid, and
performing a fourth process different from the third process on the recovered fourth liquid, in a fourth period of time of the operation of recovering the fourth liquid after the third period of time.

53. The cleaning method according to claim 50, wherein a concurrent operation of the supply and the recovery of the fourth liquid is performed until the supply of the first liquid to the liquid contact member is started.

54. The cleaning method according to claim 48, wherein at least a portion of the third liquid is supplied to the liquid contact member through the same supply channel as that of the first liquid.

55. The cleaning method according to claim 48, wherein the supply of the third liquid is performed through the same supply port as that of the first liquid.

56. The cleaning method according to claim 50, wherein at least a portion of the fourth liquid is supplied to the liquid contact member through the same supply channel as the supply channel of the exposure liquid and/or the second liquid.

57. The cleaning method according to claim 50, wherein the supply of the fourth liquid is performed through the same supply port as that of the exposure liquid and/or the second liquid.

58. The cleaning method according to claim 48, wherein the third liquid is an alkaline liquid.

59. The cleaning method according to claim 58, wherein the alkaline liquid comprises a tetramethyl ammonium hydroxide.

60. The cleaning method according to claim 50, wherein the third liquid is an aqueous solution, and the fourth liquid is a water.

61. The cleaning method according to claim 50, wherein the third liquid and the fourth liquid comprise the same type of liquid.

62. The cleaning method according to claim 1, wherein the first liquid and the second liquid comprise the same type of liquid.

63. The cleaning method according to claim 61, wherein the same type of liquid is a water.

64. The cleaning method according to claim 48, wherein the third liquid is able to remove a foreign substances existing in the liquid contact member.

65. The cleaning method according to claim 64, wherein the first liquid is able to remove the third liquid remaining in the liquid contact member.

66. A cleaning method of a liquid contact member, which is in contact with an exposure liquid, in an exposure apparatus that exposes a substrate with an exposure light through the exposure liquid, comprising:
cleaning the liquid contact member by supplying a first liquid for cleaning to the liquid contact member;
recovering the first cleaning liquid supplied to the liquid contact member and discharges it from a first discharge port;
cleaning the liquid contact member by supplying a second cleaning liquid different from the first cleaning liquid to the liquid contact member, after the liquid contact member is cleaned with the first cleaning liquid;
recovering the second cleaning liquid supplied to the liquid contact member and discharge it from a second discharge port; and
supplying a rinse liquid different from the first and second cleaning liquids to the liquid contact member and recovering the supplied rinse liquid, after the supply of the first cleaning liquid is stopped and before the supply of the second cleaning liquid is started, so that the discharge of the first cleaning liquid from the second discharge port is suppressed.

67. The cleaning method according to claim 66, wherein a concurrent operation of the supply and the recovery of the rinse liquid is performed until the supply of the second cleaning liquid is started.

68. The cleaning method according to claim 66, wherein during the supply and the recovery of the rinse liquid, the recovered rinse liquid is discharged from the first discharge port.

69. The cleaning method according to claim 66, wherein the first cleaning liquid comprises an alkaline liquid.

70. The cleaning method according to claim 69, wherein the alkaline liquid comprises a tetramethyl ammonium hydroxide.

71. The cleaning method according to claim 66, wherein the second cleaning liquid comprises an acidic liquid.

72. The cleaning method according to claim 71, wherein the acidic liquid comprises a hydrogen peroxide.

73. The cleaning method according to claim 69, wherein at least one of the alkaline and the acidic liquid is an aqueous solution.

74. The cleaning method according to claim 66, wherein the rinse liquid is a water.

75. The cleaning method according to claim 66, wherein the same type of liquid is comprised in the first cleaning liquid and the rinse liquid.

76. The cleaning method according to claim 75, wherein the same type of liquid is a water.

77. The cleaning method according to claim 66, wherein the first discharge port and the second discharge port are different from each other.

78. The cleaning method according to claim 1, wherein a surface of the liquid contact member is covered with an amorphous carbon.

79. The cleaning method according to claim 78, wherein the amorphous carbon is a tetrahedral amorphous carbon.

80. A device manufacturing method comprising:
cleaning the liquid contact member using the cleaning method according to claim 1;
exposing a substrate through the exposure liquid; and
developing the exposed substrate.

81. An exposure apparatus that exposes a substrate with an exposure light through an exposure liquid, comprising:
a liquid contact member which is in contact with the exposure liquid;
a first supply port that supplies a first liquid for cleaning to the liquid contact member;
a first recovery port that recovers the first liquid supplied to the liquid contact member;
a second supply port that supplies a second liquid different from the first liquid to the liquid contact member, after the supply of the first liquid; and
a second recovery port that recovers the second liquid supplied to the liquid contact member,
wherein a process is performed in which the concentration of the first liquid comprised in the second liquid recovered from the second recovery port is set to a predetermined concentration or less.

82. An exposure apparatus that exposes a substrate with an exposure light through an exposure liquid, comprising:
a liquid contact member which is in contact with the exposure liquid;
a first supply port that supplies a first liquid for cleaning to the liquid contact member;
a second supply port that supplies a second liquid different from the first liquid to the liquid contact member, after the supply of the first liquid; and
a recovery port that recovers the second liquid during the supply of the second liquid from the second supply port,
wherein the second liquid is discharged from a first discharge port during the recovery of the second liquid, and the second liquid is discharged from a second discharge port different from the first discharge port subsequently to the discharge from the first discharge port.

83. An exposure apparatus that exposes a substrate with an exposure light through an exposure liquid, comprising:
a liquid contact member which is in contact with the exposure liquid;
a first supply port that supplies a first liquid for cleaning to the liquid contact member;
a second supply port that supplies a second liquid different from the first liquid to the liquid contact member after the supply of the first liquid; and
a recovery port that recovers the second liquid during the supply of the second liquid from the second supply port,
wherein a first process is performed on the second liquid recovered in a first period of time of the operation of recovering the second liquid, and
a second process different from the first process is performed on the second liquid recovered in a second period of time of the operation of recovering the second liquid after the first period of time.

84. An exposure apparatus that exposes a substrate with an exposure light through an exposure liquid, comprising:
a liquid contact member which is in contact with the exposure liquid;
a first supply port that supplies a first cleaning liquid to the liquid contact member;
a first recovery port that recovers the first cleaning liquid supplied to the liquid contact member;
a second supply port that supplies a second cleaning liquid different from the first cleaning liquid to the liquid contact member, after the supply of the first cleaning liquid;
a second recovery port that recovers the second cleaning liquid supplied to the liquid contact member;
a third supply port that supplies a rinse liquid different from the first and second cleaning liquids to the liquid contact member, after the supply of the first cleaning liquid is stopped and before the supply of the second cleaning liquid is started, so that the discharge of the first cleaning liquid from a discharge port from which the second cleaning liquid recovered from the second recovery port is discharged is suppressed; and
a third recovery port that recovers the rinse liquid supplied to the liquid contact member.

85. A device manufacturing method comprising:
exposing a substrate using the exposure apparatus according to claim 81; and
developing the exposed substrate.

86. A device manufacturing system comprising an exposure apparatus that exposes a substrate with an exposure light through an exposure liquid, comprising:
a first supply port that supplies a first liquid for cleaning to a liquid contact member within the exposure apparatus which is in contact with the exposure liquid;
a first recovery port that recovers the first liquid supplied to the liquid contact member;
a second supply port that supplies a second liquid different from the first liquid to the liquid contact member, after the supply of the first liquid;
a second recovery port that recovers the second liquid supplied to the liquid contact member; and
a processing apparatus that performs a process in which the concentration of the first liquid comprised in the second liquid recovered from the second recovery port is set to a predetermined concentration or less.

87. The device manufacturing system according to claim 86, wherein the processing apparatus performs a first process on the recovered second liquid until the concentration of the first liquid reaches the predetermined concentration, and performs a second process different from the first process after the concentration of the first liquid becomes the predetermined concentration or less by the first process.

88. The device manufacturing system according to claim 86, wherein the supply and the recovery of the second liquid are concurrently performed, and
the process in which the concentration is set to the predetermined concentration or less is performed concurrently with the supply and the recovery of the second liquid.

89. The device manufacturing system according to claim 86, wherein the supply and the recovery of the second liquid are concurrently performed, and
the process in which the concentration is set to the predetermined concentration or less comprises performing the concurrent operation of the supply and the recovery of the second liquid for a predetermined period of time.

90. The device manufacturing system according to claim 86, wherein the process in which the concentration is set to the predetermined concentration or less comprises setting a stop period in which the liquid supply to the liquid contact member is stopped, after the supply of the first liquid is stopped and before the supply of the second liquid is started.

91. The device manufacturing system according to claim 86, comprising:
a first discharge port which is capable of discharging the recovered second liquid; and
a second discharge port, different from the first discharge port, which is capable of discharging the recovered second liquid,
wherein the second liquid is discharged from the first discharge port during the recovery of the second liquid, and the second liquid is discharged from a second discharge port subsequently to the discharge from the first discharge port.

92. A device manufacturing system comprising an exposure apparatus that exposes a substrate with an exposure light through an exposure liquid, comprising:
a first supply port that supplies a first liquid for cleaning to a liquid contact member within the exposure apparatus which is in contact with the exposure liquid;
a second supply port that supplies a second liquid different from the first liquid to the liquid contact member, after the supply of the first liquid;
a recovery port that recovers the second liquid during the supply of the second liquid from the second supply port;
a first discharge port which is capable of discharging the second liquid recovered from the recovery port; and
a second discharge port, different from the first discharge port, which is capable of discharging the second liquid recovered from the recovery port,
wherein the second liquid is discharged from the first discharge port during the recovery of the second liquid, and the second liquid is discharged from a second discharge port subsequently to the discharge from the first discharge port.

93. The device manufacturing system according to claim 86, comprising a vibration imparting apparatus that imparts a vibration to the supplied second liquid,
wherein a vibration conditions of the second liquid are changed in the middle of the supply operation.

94. The device manufacturing system according to claim 86, comprising:
a first processing apparatus that performs a first process on the second liquid recovered in a first period of time of the operation of recovering the second liquid; and
a second processing apparatus that performs a second process different from the first process on the second liquid recovered in a second period of time of the operation of recovering the second liquid after the first period of time.

95. A device manufacturing system including an exposure apparatus that exposes a substrate with an exposure light through an exposure liquid, comprising:
a first supply port that supplies a first liquid for cleaning to a liquid contact member within the exposure apparatus which is in contact with the exposure liquid;
a second supply port that supplies a second liquid different from the first liquid to the liquid contact member, after the supply of the first liquid;
a recovery port that recovers the second liquid during the supply of the second liquid from the second supply port;
a first processing apparatus that performs a first process on the second liquid recovered in a first period of time of the operation of recovering the second liquid; and
a second processing apparatus that performs a second process different from the first process on the second liquid recovered in a second period of time of the operation of recovering the second liquid after the first period of time.

96. The device manufacturing system according to claim 94, wherein the first period of time is shorter than the second period of time.

97. The device manufacturing system according to claim 86, wherein during the cleaning operation of the liquid contact member, the recovery of the first liquid is performed concurrently with the supply thereof.

98. The device manufacturing system according to claim 86, wherein the supply and the recovery of the second liquid are concurrently performed.

99. The device manufacturing system according to claim 86, wherein an emission surface of the exposure light is provided around an optical member which is in contact with the exposure liquid, and the supply and the recovery of the exposure liquid are performed through a liquid immersion member for holding the exposure liquid within a local region smaller than the substrate,
each of the first and second liquids is supplied in a state where an object is disposed facing the liquid immersion member, and
the liquid contact member comprises at least one of the liquid immersion member and the object.

100. A device manufacturing system comprising an exposure apparatus that exposes a substrate with an exposure light through an exposure liquid, comprising:
a first supply port that supplies a first cleaning liquid to a liquid contact member within the exposure apparatus which is in contact with the exposure liquid;
a first recovery port that recovers the first cleaning liquid supplied to the liquid contact member;
a second supply port that supplies a second cleaning liquid different from the first cleaning liquid to the liquid contact member, after the supply of the first cleaning liquid;
a second recovery port that recovers the second cleaning liquid supplied to the liquid contact member;
a third supply port that supplies a rinse liquid different from the first and second cleaning liquids to the liquid contact member, after the supply of the first cleaning liquid is stopped and before the supply of the second cleaning liquid is started, so that the discharge of the first cleaning liquid from a discharge port from which the second cleaning liquid recovered from the second recovery port is discharged is suppressed; and
a third recovery port that recovers the rinse liquid supplied to the liquid contact member.

101. The device manufacturing system according to claim 100, wherein a concurrent operation of the supply and the recovery of the rinse liquid is performed until the supply of the second cleaning liquid is started.

102. A cleaning method of a liquid contact member, which is in contact with an exposure liquid, in an exposure apparatus that exposes a substrate with an exposure light through the exposure liquid, comprising:
cleaning the liquid contact member by supplying a first liquid for cleaning to the liquid contact member;
recovering the first liquid supplied to the liquid contact member;
supplying a second liquid different from the first liquid to the liquid contact member after the liquid contact member is cleaned with the first liquid;
recovering the second liquid supplied to the liquid contact member; and
receiving the recovered second liquid in a first receiving member until the concentration of the first liquid becomes a predetermined concentration or less.

103. The cleaning method according to claim 102, wherein sending out of the recovered second liquid to the first receiving member is continued until the concentration of the first liquid comprised in the second liquid received in the first receiving member becomes the predetermined concentration or less.

104. The cleaning method according to claim 102, wherein the sending out of the recovered second liquid to the first receiving member is continued even after the concentration of the first liquid comprised in the second liquid received in the first receiving member reaches the predetermined concentration.

105. The cleaning method according to claim 102, wherein the sending out of the recovered second liquid to the first receiving member is stopped before the concentration of the first liquid comprised in the second liquid received in the first receiving member reaches the predetermined concentration.

106. The cleaning method according to claim 105, wherein after the stopping of the sending out of the recovered second liquid to the first receiving member, the sending out of the recovered second liquid to the first receiving member is continued until the concentration of the first liquid comprised in the second liquid received in the first receiving member becomes the predetermined concentration or less.

107. The cleaning method according to claim 105, wherein the recovered second liquid is sent out to the first receiving member through a recovery channel, and
the sending out of the recovered second liquid to the first receiving member is stopped after the concentration of the first liquid comprised in the recovered second liquid within the recovery channel reaches a predetermined value or less.

108. The cleaning method according to claim 107, wherein the predetermined value is lower than the predetermined concentration.

109. The cleaning method according to claim 105, wherein the recovery of the second liquid is continued even after the sending out of the recovered second liquid to the first receiving member is stopped.

110. The cleaning method according to claim 105, wherein after the stopping of the sending out of the recovered second liquid to the first receiving member, the recovered second liquid is received in a second receiving member different from the first receiving member.

111. The cleaning method according to claim 105, wherein after the stopping of the sending out of the recovered second liquid to the first receiving member, the recovered second liquid is discarded.

112. The cleaning method according to claim 105, wherein the sending out of the recovered second liquid to the first receiving member is stopped by stopping the supply and the recovery of the second liquid.

113. The cleaning method according to claim 102, wherein during the supply and the recovery of the second liquid, the sending out of the recovered second liquid to the first receiving member is performed.

114. The cleaning method according to claim 102, wherein the second liquid is received in the first receiving member before the recovered second liquid is received.

115. The cleaning method according to claim 102, wherein a predetermined liquid different from the first liquid is sent out to the first receiving member so that the concentration of the first liquid contained in the second liquid received in the first receiving member is set to the predetermined concentration or less.

116. The cleaning method according to claim 115, wherein the predetermined liquid has the same ingredients as that of the second liquid.

117. The cleaning method according to claim 115, wherein the predetermined liquid is the second liquid.

118. The cleaning method according to claim 115, wherein the predetermined liquid is sent out to the first receiving member without going through the liquid contact member.

119. The cleaning method according to claim 115, wherein the sending out of the predetermined liquid to the first receiving member is performed in a state where the sending out of the recovered second liquid to the first receiving member is stopped.

120. The cleaning method according to claim 115, wherein the sending out of the predetermined liquid to the first receiving member is continued until the concentration of the first liquid comprised in the second liquid received in the first receiving member becomes the predetermined concentration or less.

121. The cleaning method according to claim 115, wherein the predetermined liquid is received in the first receiving member before the recovered second liquid is received.

122. The cleaning method according to claim 102, wherein the recovered second liquid is sent out to the first receiving member through a recovery channel, and
the concentration of the first liquid comprised in the recovered second liquid within the recovery channel is lower than the predetermined concentration after the concentration of the first liquid comprised in the second liquid received in the first receiving member reaches the predetermined concentration.

123. The cleaning method according to claim 102, wherein the process performed on the second liquid comprises a first process performed on the second liquid comprising the first liquid of more than the predetermined concentration, and a second process different from the first process which is performed on the second liquid comprising the first liquid of the predetermined concentration or less, and
the second process is performed on the second liquid received in the first receiving member after the concentration of the first liquid comprised in the second liquid received in the first receiving member becomes the predetermined concentration or less.

124. The cleaning method according to claim 123, further comprising recovering the supplied first liquid, and processing the recovered first liquid,
wherein the first process is the same as the process of the first liquid.

125. The cleaning method according to claim 123, further comprising recovering the supplied first liquid, and processing the recovered first liquid,
wherein the second process is different from the process of the first liquid.

126. The cleaning method according to claim 123, wherein the second process has a number of steps smaller than that of the first process.

127. The cleaning method according to claim 126, wherein the second process comprises discarding the second liquid received in the first receiving member.

128. The cleaning method according to claim 102, wherein at least a portion of the first liquid is supplied to the liquid contact member through a supply channel different from a supply channel of the exposure liquid and/or the second liquid.

129. The cleaning method according to claim 128, further comprising removing the first liquid remaining in the supply channel after the supply of the first liquid is stopped.

130. The cleaning method according to claim 128, wherein the first liquid remaining in the supply channel is removed by depressurizing or pressurizing the supply channel.

131. The cleaning method according to claim 128, wherein the exposure liquid and/or the second liquid remaining in the supply channel is removed after the supply of the exposure liquid and/or the second liquid is stopped.

132. The cleaning method according to claim 102, wherein the first liquid is supplied to the liquid contact member through a supply port different from that of the exposure liquid and/or the second liquid.

133. The cleaning method according to claim 102, wherein an emission surface of the exposure light is provided around an optical member which is in contact with the exposure liquid, and the supply and the recovery of the exposure liquid are performed through a liquid immersion member for holding the exposure liquid within a local region smaller than the substrate,
each of the first and second liquids is supplied in a state where an object is disposed facing the liquid immersion member, and
the liquid contact member comprises at least one of the liquid immersion member and the object.

134. The cleaning method according to claim 133, wherein the supply of at least one of the first and second liquids is performed from one side of the liquid immersion member and the object, and the recovery thereof is performed from the other side of the liquid immersion member and the object.

135. The cleaning method according to claim 133, wherein both of the supply and the recovery of at least one of the first and second liquids are performed from the one side of the liquid immersion member and the object.

136. The cleaning method according to claim 133, wherein the supply of the first liquid is performed through the liquid immersion member.

137. The cleaning method according to claim 133, wherein the supply of the second liquid is performed through the liquid immersion member.

138. The cleaning method according to claim 102, wherein the supply of the second liquid is performed through the same supply port as that of the exposure liquid.

139. The cleaning method according to claim 102, wherein the first liquid is an acidic liquid.

140. The cleaning method according to claim 139, wherein the acidic liquid comprises a hydrogen peroxide.

141. The cleaning method according to claim 102, wherein the first liquid is an aqueous solution, and the second liquid is a water.

142. The cleaning method according to claim 102, wherein the first liquid is an alkaline liquid, and the second liquid is an acidic liquid.

143. The cleaning method according to claim 102, further comprising supplying a third liquid different from the first and second liquids to the liquid contact member in order to clean the liquid contact member, and recovering the supplied third liquid.

144. The cleaning method according to claim 143, comprising:
supplying a fourth liquid different from the third liquid to the liquid contact member, after the liquid contact member is cleaned with the third liquid;
recovering the fourth liquid supplied to the liquid contact member; and
receiving the recovered fourth liquid in a third receiving member until the concentration of the third liquid becomes a predetermined concentration or less.

145. The cleaning method according to claim 144, wherein the first receiving member and the third receiving member are different from each other.

146. The cleaning method according to claim 143, wherein the third liquid is an alkaline liquid.

147. The cleaning method according to claim 146, wherein the alkaline liquid comprises a tetramethyl ammonium hydroxide.

148. The cleaning method according to claim 143, wherein the third liquid is an aqueous solution, and the fourth liquid is a water.

149. The cleaning method according to claim 102, wherein the same type of liquid is comprised in the first liquid and the second liquid.

150. The cleaning method according to claim 143, wherein the same type of liquid is comprised in the third liquid and the fourth liquid.

151. The cleaning method according to claim 149, wherein the same type of liquid is a water.

152. The cleaning method according to claim 102, wherein a surface of the liquid contact member is covered with an amorphous carbon.

153. The cleaning method according to claim 152, wherein the amorphous carbon is a tetrahedral amorphous carbon.

154. A device manufacturing method comprising:
cleaning the liquid contact member using the cleaning method according to claim 102;
exposing a substrate through the exposure liquid; and
developing the exposed substrate.

155. An exposure apparatus that exposes a substrate with an exposure light through an exposure liquid, comprising:
a liquid contact member which is in contact with the exposure liquid;
a first supply port that supplies a first liquid for cleaning to the liquid contact member;
a first recovery port that recovers the first liquid supplied to the liquid contact member;
a second supply port that supplies a second liquid different from the first liquid to the liquid contact member, after the supply of the first liquid; and
a second recovery port that recovers the second liquid supplied to the liquid contact member,
wherein the second liquid recovered from the second recovery port is received in a first receiving member until the concentration of the first liquid becomes a predetermined concentration or less.

156. A device manufacturing method comprising:
exposing a substrate using the exposure apparatus according to claim 155; and
developing the exposed substrate.

157. A device manufacturing system comprising an exposure apparatus that exposes a substrate with an exposure light through an exposure liquid, comprising:
a first supply port that supplies a first liquid for cleaning to a liquid contact member within the exposure apparatus which is in contact with the exposure liquid;
a first recovery port that recovers the first liquid supplied to the liquid contact member;
a second supply port that supplies a second liquid different from the first liquid to the liquid contact member, after the supply of the first liquid;
a second recovery port that recovers the second liquid supplied to the liquid contact member;
a first receiving member that receives the second liquid recovered from the second recovery port; and
a control apparatus that receives the second liquid in the first receiving member until the concentration of the first liquid comprised in the second liquid in the first receiving member becomes a predetermined concentration or less.

158. The device manufacturing system according to claim 157, wherein the recovered second liquid continues to be sent out to the first receiving member until the concentration of the first liquid comprised in the second liquid received in the first receiving member becomes the predetermined concentration or less.

159. The device manufacturing system according to claim 157, wherein the recovered second liquid continues to be sent out to the first receiving member, even after the concentration of the first liquid comprised in the second liquid received in the first receiving member reaches the predetermined concentration.

160. The device manufacturing system according to claim 157, wherein during the supply and the recovery of the second liquid, the recovered second liquid is sent out to the first receiving member.
